(19) United States
(12) Patent Application Publication
(10) Pub. No.: US 2017/0060008 A1
(43) Pub. Date: Mar. 2, 2017

(54) IMAGE FORMING METHOD, PROCESS CARTRIDGE AND ELECTROPHOTOGRAPHIC APPARATUS

(71) Applicant: CANON KABUSHIKI KAISHA, Tokyo (JP)

(72) Inventors: Atsushi Okuda, Yokohama-shi (JP); Yuki Yamamoto, Tokyo (JP); Kazunori Noguchi, Suntou-gun (JP); Yuka Ishiduka, Suntou-gun (JP); Takashi Kenmoku, Mishima-shi (JP); Shohei Shibahara, Suntou-gun (JP); Taiji Katsura, Suntou-gun (JP); Yasuhiro Hashimoto, Mishima-shi (JP)

(21) Appl. No.: 15/241,752

(22) Filed: Aug. 19, 2016

(30) Foreign Application Priority Data
Aug. 27, 2015 (JP) 2015-168257
Aug. 27, 2015 (JP) 2015-168263
Aug. 5, 2016 (JP) 2016-155061

(51) Int. Cl. G03G 15/00

(52) U.S. Cl. CPC G03G 5/14773; G03G 5/14756; G03G 5/14752; G03G 9/0825; G03G 21/18

(57) ABSTRACT

It is intended to provide an image forming method, a process cartridge and an electrophotographic apparatus which have favorable cleaning properties and can suppress reduction in image quality caused by the contamination of a charging member. A surface layer of an electrophotographic photosensitive member satisfies the condition (i) or (ii), and toner contains a resin having an isosorbide unit: (i) containing a fluorine resin particle and at lease one resin selected from the group consisting of a polyarylate resin and a polycarbonate resin, and (ii) containing at least one resin selected from the group consisting of a polyarylate resin and a polycarbonate resin each having a polysiloxane structure.

### BACKGROUND OF THE INVENTION

### Field of the Invention

The present invention relates to an image forming method, a process cartridge and an electrophotographic apparatus. Specifically, the present invention relates to an image forming method using a specific electrophotographic photosensitive member and specific toner, and a process cartridge and an electrophotographic apparatus including a specific electrophotographic photosensitive member and specific toner.

### Description of the Related Art

A general electrophotographic process, which is an image forming method, is known to involve forming an electric latent image on an image carrier (electrophotographic photosensitive member; hereinafter, also referred to as a “photosensitive member”), supplying toner to the latent image for visualization, transferring the toner image to a transfer medium such as a paper sheet, and then fixing the toner image on the transfer medium by heat or pressure to obtain a recorded image (duplicate, print, etc.).

After the transfer step, toner remaining on the electrophotographic photosensitive member is cleaned off. An approach moat widely used as a cleaning method is blade cleaning. The blade cleaning is a method which involves pressing a blade-shaped member having elasticity, such as a rubber, against the surface of the electrophotographic photosensitive member to scrape off the toner.

For the blade cleaning, it is important to prevent, as much as possible, poor cleaning in which toner slips through the contact nip part between the blade and the electrophotographic photosensitive member. Upon poor cleaning, the contamination of a charging member occurs such that the toner that has slipped therethrough adheres to the charging member. In a region having such a contaminated charging member, the charge process of the photosensitive is not normally carried out, impairing image quality. Once the toner slips therethrough, toner easily passes In succession through the slipping-mediated gap between the blade and the electrophotographic photosensitive member so that the contamination of a charging member gets worse. Therefore, unless the poor cleaning is prevented, it is necessary to dispose a mechanism to remove toner that has adhered to the charging member. This may complicate the system or may be responsible for increase in the size or cost of a process cartridge or an electrophotographic apparatus.

The poor cleaning may occur partly because the blade is more likely to have an unstable stick-slip motion because the amount of an inclusion (stagnant layer) resulting from toner, etc., remaining in the contact nip between the blade and the photosensitive member is too small to apply uniform friction to the blade.

In order to stabilize the stick-slip motion of the blade, an attempt has been made to stabilize the stick-slip motion by discharging toner to the blade nip during a non-image-forming period and thereby increasing the amount of the inclusion (stagnant layer). This method, however, requires an extra duration of the non-image-forming period and presents problems such as reduction in the productivity of output to paper sheets.

Furthermore, the poor cleaning often occurs easily even at the early stage of application of a brand-new process cartridge or electrophotographic apparatus. This may be partly because the amount of an inclusion (stagnant layer) resulting from toner, etc., remaining in or near the contact nip part between the blade and the photosensitive member is small at the early stage of application of a brand new process cartridge or electrophotographic apparatus. The blade is more likely to have an unstable stick-slip motion because the amount of the inclusion in or near the contact nip part is too small to apply uniform friction to the blade. This facilitates slipping of toner.

In order to stabilize the stick-slip motion of the blade from the early stage of application of a brand-new process cartridge or electrophotographic apparatus, an attempt has been made to apply a particle of toner, carbon fluoride, cerium oxide, titanium oxide, silica, Tospearl(R), or the like as a lubricant to the edge part of the cleaning blade during the production of a process cartridge or an electrophotographic apparatus. This approach based on the application of a lubricant to the blade, however, leads to the complication of the production process. Therefore, there has been a demand for a unit for preventing the poor cleaning without the application of a lubricant.

As another approach for preventing the poor cleaning, for example, an attempt has been made to elevate a linear pressure at which the edge part of the blade is pressed against the surface of the photosensitive to prevent the slipping of toner. This approach based on the mere elevation in linear pressure, however, might cause problems such as promoted chipping of a blade edge part, generation of abnormal noise attributed to the chatter vibration of the blade, and promoted abrasion of the photosensitive member.

Japanese Patent Application Laid-Open No. 2007-279702 proposes an approach of preventing the poor cleaning by using a non spherical, amorphous and large-particle size silica particle as an external additive for toner. Unfortunately, use of such an inorganic external additive having a large particle size might impair the low-temperature friability of toner. This might increase power consumption in the fixing step.

In recent years, improvement in the productivity of image output has been demanded, and wait time has been shortened. This has reduced the number of toner discharge runs previously performed for the contact nip part between the blade and the photosensitive member. Particularly, under low-coverage printing conditions or the like, there is the possibility that the stagnant layer is insufficiently formed during image formation, easily leading to the poor cleaning. Among others, high-coverage printing after repeated use under low-coverage printing conditions results more easily in the poor cleaning. Thus, a unit for stabilizing the stick slip motion of the blade with toner discharge reduced during a non-image-forming period has been demanded for preventing the poor cleaning and obtaining favorable image quality.

With advances in electrophotographic process, a prerotation time from the start-up of a brand new process cartridge or electrophotographic apparatus to a stand-by state that permits printing is increasingly shortened. This hinders securing of the time during which the maldistribution of toner is sufficiently leveled off near the contact nip part between the blade and the photosensitive member, even if toner is discharged from a developing part during prerotation. If the maldistribution of toner is insufficiently leveled off near the contact nip, there is the possibility that image formation takes place before the stagnant layer is adequately formed, so that the blade has an unstable stick-slip motion, easily leading to the poor cleaning. Thus, a unit for stabilizing the stick-slip motion of the blade even if the stagnant layer is insufficiently formed, at the early stage of application of a brand-new process cartridge or electrophotographic apparatus, and then uniformly forming the stagnant layer in a short time has been demanded for preventing the poor cleaning and obtaining favorable image quality.

The present invention in directed to providing an image forming method, a process cartridge and an electrophotographic apparatus which have solved the problems described above. Specifically, the present invention is directed to providing an image forming method, a process cartridge and an electrophotographic apparatus which reduce the number of toner discharge runs, have favorable cleaning properties, and can suppress reduction in image quality caused by the contamination of a charging member. Further, the present invention is directed to providing an image forming method, a process cartridge and an electrophotographic apparatus which can prevent poor cleaning even at the early stage of application of a brand new process cartridge or electrophotographic apparatus, and can produce favorable image quality.

### SUMMARY OP THE INVENTION

According to one aspect of the present invention, there is provided an image forming method comprising: charging an electrophotographic photosensitive member by contact with the electrophotographic photosensitive member; developing the electrophotographic photosensitive member with toner to form a toner image; transferring the toner image on the electrophotographic photosensitive member to a transfer medium; and cleaning off the toner on the electrophotographic photosensitive member by contact of a blade with the electrophotographic photosensitive member, wherein
a surface layer of the electrophotographic photosensitive member satisfies the following condition (i) or (ii):
(i) containing a fluorine resin particle and at least one resin selected from the group consisting of a polyarylate resin and a polycarbonate resin, and
(ii) containing at least one resin selected from the group consisting of polyarylate resin A and polycarbonate resin B each having a polysiloxane structure represented by the formula (1);

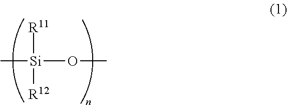

wherein R¹¹ and R¹² are each independently selected from the group consisting of an alkyl group, a fluoroalkyl group and a phenyl group, and n represents an integer of 10 or larger and 200 or smaller, and
the toner has a toner particle containing, on the surface, resin C having an isosorbide unit represented by the formula (14):

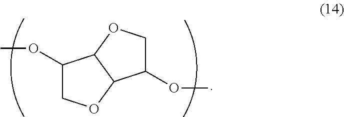

According to another aspect of the present invention, there is provided a process cartridge which is detachably attached to the main body of an electrophotographic apparatus,
the process cartridge having: an electrophotographic photosensitive member; a charging unit for charging the electrophotographic photosensitive member by contact with the electrophotographic photosensitive member; a developing unit for developing the electrophotographic photosensitive member with toner to form a toner image; and a cleaning unit for cleaning off the toner on the electrophotographic photosensitive member by contact of a blade with the electrophotographic photosensitive member, wherein
a surface layer of the electrophotographic photosensitive member satisfies the following condition (i) or (ii):
(i) containing a fluorine resin particle and at least one resin selected from the group consisting of a polyarylate resin and a polycarbonate resin, and
(ii) containing at leant one resin selected from the group consisting of polyarylate resin A and polycarbonate resin B each having a polysiloxane structure represented by the formula (1), and
the toner has a toner particle containing, on the surface, resin C having an isosorbide unit represented by the formula (14).

According to further aspect of the present invention, there is provided an electrophotographic apparatus having: an electrophotographic photosensitive member; a charging unit for charging the electrophotographic photosensitive member by contact with the electrophotographic photosensitive member) a developing unit for developing the electrophotographic photosensitive member with toner to form a toner image; a transfer unit for transferring the toner image on the electrophotographic photosensitive member to a transfer medium; and a cleaning unit for cleaning off the toner on the electrophotographic photosensitive member by contact of a blade with the electrophotographic photosensitive member, wherein
a surface layer of the electrophotographic photosensitive member satisfies the following condition (i) or (ii):
(i) containing a fluorine resin particle and at least one resin selected from the group consisting of a polyarylate resin and a polycarbonate resin, and
(ii) containing at least one resin selected from the group consisting of polyarylate resin A and polycarbonate resin B each having a polysiloxane structure represented by the formula (1), and
the toner has a toner particle containing, on the surface, rosin C having an isosorbide unit represented by the formula (14).

According to the present invention, the number of toner discharge runs can be reduced, and favorable cleaning properties can be obtained. In addition, favorable cleaning properties can be obtained even at the early stage of application of a brand-new process cartridge or electrophotographic apparatus. This can provide an image forming method, a process cartridge and an electrophotographic apparatus which can suppress reduction in image quality caused by the contamination of a charging member.

Further features of the present invention will become apparent from the following description of exemplary embodiments with reference to the attached drawings.

### BRIEF DESCRIPTION OF THE DRAWINGS

FIG. 1 is a diagram illustrating one example of a schematic configuration of an image forming apparatus for use in the image forming method of the present invention.

FIG. 2 is a diagram illustrating the relationship between solubility parameter and adhesion energy.

### DESCRIPTION OF THE EMBODIMENTS

Preferred embodiments of the present invention will now be described in detail, in accordance with the accompanying drawings.

The image forming method of the present invention includes: charging an electrophotographic photosensitive member by contact with the electrophotographic photosensitive member; developing the electrophotographic photosensitive member with toner to form a toner image; transferring the toner image on the electrophotographic photosensitive member to a transfer medium; and cleaning off the toner on the electrophotographic photosensitive member by contact of a blade with the electrophotographic photosensitive member.

The electrophotographic photosensitive member has the following feature: a surface layer of the electrophotographic photosensitive member satisfies the following condition (i) or (ii):
(i) containing a fluorine resin particle and at least one resin selected from the group consisting of a polyarylate resin and a polycarbonate resin, and
(ii) containing at lease one resin selected from the group consisting of polyarylate resin A and polycarbonate resin B each having a polysiloxane, structure represented by the formula (1):

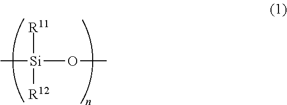

wherein R¹¹ and R¹² are each independently selected from the group consisting of an alkyl group, a fluoroalkyl group and a phenyl group, and n represents an integer of 10 or larger and 200 or smaller.

The toner has a toner particle containing, on the surface, resin C having an isosorbide unit represented by the formula (14):

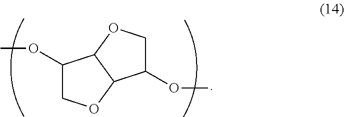

<Toner>

The toner used in the present invention will be described in more detail. The toner particle carried by the toner of the present invention has a resin. The resin of the toner particle contains resin c containing an isosorbide unit represented by the formula (14) as a constituent (hereinafter, also referred to as “resin C”).

The resin C having an isosorbide unit as mentioned in the present invention can be a polyester resin having isosorbide as an alcohol component. When the resin C is a polyester resin, the resin C can be prepared by, for example, a method which involves dehydration-condensing a dibasic acid or an anhydride thereof, isosorbide represented by the formula (17) given below and a dihydric alcohol at a composition ratio that allows a carboxyl group to remain at a reaction temperature of 180 to 260° C. in a nitrogen atmosphere. If necessary, a trifunctional or higher polyfunctional polybasic acid or an anhydride thereof, a monobasic acid, a trifunctional or higher polyfunctional alcohol, a monohydride alcohol or the like may be used.

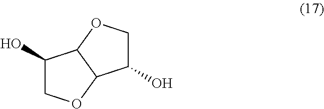

Examples of the dihydric alcohol include: alkylene oxide adduces of bisphenol A, such as polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4 -hydroxyphenyl)propane, polyoxypropylene (2.0)-polyoxyethylene (2.0)-2,2-bis(4-hydroxyphenyl)propane and polyoxypropylene (6)-2,2-bis(4-hydroxyphenyl)propane; and aliphatic diols such an ethylene glycol, diethylene glycol, triethylene glycol, 1,2-propylene glycol, 1,3 propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol.

Examples of the trihydric or higher polyhydric alcohol include sorbitol, 1,2,3,6-hexanetetrol, 1,4-sorbitan, pentaerythritol, dipentaerythritol, tripentaerythritol, 1,2,4 butanetriol, 1,2,5-pentanetriol, glycerol, 2-methylpropanetriol, 2-methyl-1,2,4-butanetriol, trimethylolethane, trimethylolpropane and 1,3,5-trihydroxymethylbenzene.

On the other hand, examples of the acid components such as the dibasic acid include the following: aromatic polyvalent carboxylic acids such as phthalic acid, isophthalic acid, terephthalic acid, trimellitic acid and pyromellitic acid; aliphatic polyvalent carboxylic acids such as fumaric acid, maleic acid, adipic acid and succinic acid; aliphatic polyvalent carboxylic acids of succinic acid substituted by an alkyl group having 1 to 20 carbon atoms or an alkenyl group having 2 to 20 carbon atoms, such as dodecenylsuccinic acid and octenylsuccinic acid; and anhydrides of these acids and alkyl (having 1 to 8 carbon atoms) esters of these acids. Among others, particularly, a polyester resin obtained by polycondensing a bisphenol derivative as an alcohol component and a divalent or higher polyvalent carboxylic acid or an anhydride thereof or a lower alkyl ester thereof as an acid component can be used.

In the present invention, the resin C preferably contains 0.10 mol % or more of the isosorblde unit represented by the formula (14) as a constituent, from the viewpoint that favorable cleaning properties can be effectively exerted. The resin C more preferably contains 30.00 mol % or less of the isosorbide unit represented by the formula (14), from the viewpoint of the stability of the charge quantity of the toner. In short, the resin C more preferably contains 0.10 mol % or more and 30.00 mol % or less of the isosorbide unit represented by the formula (14), further preferably 0.50 mol % or more and 20.0 mol % or leas of the isosorbide unit represented by the formula (14).

The composition of the resin C can be confirmed by, for example, normalization to the peak area ratio of a hydrogen atom (hydrogen atom constituting the resin) by the ¹H-NMR measurement of the resin as a general approach.

In the present invention, the acid value of the resin C is preferably 0.5 mg KOH/g or higher and 25.0 mg KOH/g or lower from the viewpoint that the charge quantity of the toner can be favorably maintained. The acid value of the resin C is more preferably 1.5 mg KOH/g or higher and 20.0 mg KOH/g or lower. The acid value (mg KOH/g) of the resin C can be controlled by a monomer composition ratio or the like during polymerization.

In the present invention, the resin C may be used in combination with a conventional styrene acrylic rosin, styrenic resin, acrylic resin, or polyester resin known in the art as an additional resin. In the case of using the resin C in combination with an additional resin, the content of the resin C with respect to all resins having a number-average molecular weight (Mn) of 1500 or larger in the toner can be 1.0 mass % or more and 35.0 mass % or less. The content of the resin C can be 1.0 mass % or more from the viewpoint that favorable cleaning properties are effectively obtained. The content of the resin C can be 35.0 mass % or lens from the viewpoint that the moisture absorption characteristics of the toner can be suppressed.

In the toner of the present invention, the content of the resin C is indicated, as mentioned above, by a ratio (mass %) to all resins having a number-average molecular weight (Mn) of 1500 or larger in the toner. In short, the content of the resin C according to the present invention is represented by the following expression:

Content of the resin C (mass %)−100×{Resin C (mass)/All resins (mass) having a number-average molecular weight (Mn) of 1500 or larger in the toner} (Expression)

Likewise, in the case of using the resin C in combination with an additional resin, the content of the resin other than the resin C is indicated by a ratio (mass %) to all resins having a number-average molecular weight (Mn) of 1500 or larger in the toner.

In the present invention, the resin C is more preferably used in combination with a styrene acrylic resin. The content of the styrene acrylic resin with respect to all resins having a number-average molecular weight of 1500 or larger In the toner is particularly preferably 50.0 mass % or more and 99.0 mass % or less because the toner can exhibit favorable chargeabllity. The content of the styrene acrylic resin is more preferably 60 mass % or more and 80 mass % or less.

Specifically, the configuration described above can optimize the charge quantity of the toner and can further sharpen the charge quantity distribution of the toner. As a result, in the case of using the toner of the present invention in a single-component development technique or the like, an image having a favorable image density with reduced fogging can be provided. This is considered to optimize the resistance value of the toner in the coexistence of the low-resistance resin C and the high-resistance styrene acrylic resin in optimum amounts, and consequently sharpen the charge quantity distribution of the toner.

The styrene acrylic resin that can be used in combination with the resin C of the present invention is a copolymer of a styrene monomer and an acrylic monomer. Examples of the acrylic monomer include: acrylic acid and methacrylic acid; and acrylic acid ester monomers and methacrylic acid ester monomers such as methyl acrylate, methyl methacrylate, ethyl acrylate, ethyl methacrylate, propyl acrylate, propyl methacrylate, butyl acrylate, butyl methacrylate, octyl acrylate, octyl methacrylate, dodecyl acrylate, dodecyl methacrylate, stearyl acrylate, stearyl methacrylate, behenyl acrylate, behenyl methacrylate, 2-ethylhexyl acrylate, 2-ethylhexyl methacrylate, dimethyl aminoethyl acrylate, dimethylaminoethyl methacrylate, diethylaminoethyl acrylate and diethylaminoethyl methacrylate.

The styrene monomer and the acrylic monomer may be used in combination with an aromatic vinyl monomer other than the styrene monomer. Examples of the aromatic vinyl monomer Include styrene derivatives such as o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene.

In the present invention, a cross-linking agent may be used for enhancing the mechanical strength of the toner while controlling the molecular weight of the styrene acrylic resin.

Examples of the cross-linking agent include: divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylone glycol diacrylate, triethylene glycol diacrylate, tetraethylene glycol diacrylate, diacrylate of polyethylene glycol #200, #400 or #600, dipropylene glycol diacrylate, polypropylene glycol diacrylate, polyester-type diacrylate (MANDA, manufactured by Nippon Kayaku Co., Ltd.) and these compounds containing dimethacrylate instead of the diacrylate, as difunctional cross linking agents.

On the other hand, examples of polyfunctional cross-linking agents include pentaerythritol triacrylate, trimethylolethane triacrylate, trimethylolpropane triacrylate, tetramethylolmethane tetraacrylate, oligo ester acrylate and methacrylate thereof, 2,2-bis (4-methacryloxypolyethoxyphenyl)propane, diallyl phthalate, triallyl cyanurate, triallyl isocyanurate and triallyl trimellitate.

In the present invention, the peak molecular weight: (Mp) of the styrene acrylic resin is preferably 5000 or larger and 30000 or smaller, more preferably 8000 or larger and 27000 or smaller. If the peak molecular weight (Mp) of the styrene acrylic resin is smaller than 5000, the resin C coexisting with the 3styrene acrylic resin tends to have a large molecular motion of its molecular chain and have high moisture absorption properties in a high-moisture environment. In this case, the charge quantity of the toner tends to be decreased. If the peak molecular weight (Mp) exceeds 30000, the compatibility between the styrene acrylic resin and the resin C tends to be reduced. This facilitates forming a large domain of the resin C in the toner, easily leading to a broad charge quantity distribution of the toner.

The peak molecular weight (Mp) of the resin can be measured using an existing apparatus of gel permeation chromatography (GPC) or the like.

The toner of the present invention may contain a colorant. A colorant known in the art can be used.

Examples of black colorants include carbon black, magnetic substances, and colorants toned to each color using yellow, magenta and cyan colorants shown below.

Examples of the yellow colorant include compounds typified by condensed azo compounds, isoindolinone compounds, anthraquinone compounds, azo-metal complexes, methine compounds and allylamide compounds. Specific examples thereof can include C.I. Pigment Yellow 12, 13, 14, 15, 17, 62, 73, 74, 83, 93, 94, 95, 97, 109, 110, 111, 120, 128, 129, 138, 147, 150, 151, 154, 155, 168, 180, 185 and 214.

Examples of the magenta colorant include condensed azo compounds, diketopyrrolopyrrole compounds, anthraquinone compounds, quinacridon compounds, basic dye lake compounds, naphthol compounds, benzimidazolone compounds, thioindigo compounds and perylene compounds. Specific examples thereof can include C.I. Pigment Red 2, 3, 5, 6, 7, 23, 48:2, 48:3, 48:4, 57:1, 81:1, 122, 146, 150, 166, 169, 177, 184, 185, 202, 206, 220, 221, 238, 254 and 269, and C.I. Pigment Violet 19.

Examples of the cyan colorant include copper phthalocyanine compounds and derivatives thereof, anthraquinone compounds and basic dye lake compounds. Specific examples thereof can include C.I. Pigment Blue 1, 7, 15, 15:1, 15:2, 15:3, 15:4, 60, 62 and 66.

These colorants can be used either alone or as a mixture in a solid solution state. The colorant is selected from the viewpoint of hue angle, saturation, brightness, light resistance, OHP transparency and dispersibility into the toner. The amount of the colorant added can be 1 part by mass or larger and 20 parts by mass or smaller with respect to 100 parts by mass of the resin.

The toner of the present invention may be a magnetic toner containing a magnetic material. In this case, the magnetic material can also serve as a colorant.

Examples of the magnetic material can include: iron oxides ouch as magnetite, hematite and ferrite; and metals such as iron, cobalt and nickel, and alloys of these metals with metals such as aluminum, cobalt, copper, lead, magnesium, tin, zinc, antimony, beryllium, bismuth, cadmium, calcium, manganese, selenium, titanium, tungsten and vanadium, and mixtures thereof.

The magnetic material can be surface-modified. In the case of preparing the magnetic toner by a suspension polymerization method, the magnetic material can be hydrophobized with a surface modifier which is a substance that does not inhibit the polymerization. Examples of such a surface modifier can include silane coupling agents and titanium coupling agents.

The number-average particle size of the magnetic material Is preferably 2 μm or smaller, more preferably 0.1 μm or larger and 0.5 μm or mailer. The content of the magnetic material in the toner is preferably 20 parts by mass or larger and 200 parts by mass or smaller, more preferably 40 parts by mass or larger and 150 parts by mass or smaller, with respect to 100 parts by mass of the resin.

The toner of the present invention may contain a wax. Examples of the wax include the following: petroleum waxes and derivatives thereof, such as paraffin wax, microcrystalline wax and petrolatum; montan waxes and derivatives thereof; hydrocarbon waxes and derivatives thereof based on the Fischer-Tropsch process; polyolefin waxes and derivatives thereof, such as polyethylene wax and polypropylene wax; and natural waxes and derivatives thereof, such as carnauba wax and candelilla wax. Examples of the derivatives include oxides, block copolymers with vinyl monomers and graft-modified products. Further examples of the wax include: higher aliphatic alcohols; fatty acids such as stearic acid and palmitic acid; acid amide waxes; ester waxes; hydrogenated castor oil and derivatives thereof; plant-derived waxes; and animal-derived waxes. Among these waxes, particularly, ester waxes and hydrocarbon waxes are preferred from the viewpoint of excellent mold release properties. A wax containing 50 mass % or more and 95 mass % or less of compounds having the same total numbers of carbon atoms is more preferred from the viewpoint of high wax purity and developability.

The content of the wax is preferably 1 part by mass or larger and 40 parts by mass or smaller with respect to 100 parts by mass of the resin. The content of the wax is more preferably 3 parts by mass or larger and 25 parts by mass or smaller. When the content of the wax is 1 part by mass or larger and 40 parts by mass or smaller, the wax can have moderate bleeding properties during the heating and pressurization of the toner, thereby improving seizure resistance at a high temperature. Furthermore, the wax is less exposed on the surface of the toner even if the toner is placed under stress during development or during transfer. Thus, each individual toner particle can gain uniform changeability.

The toner of the present invention can be in a form having an inorganic fine particle externally added to the toner particle for the purpose of improving flowability, etc.

The inorganic fine particle that is externally added to the toner particle can contain at least a fine silica particle. The number-average particle sire of the fine silica particle in terms of a primary particle can be 4 nm or larger and 80 nm or smaller. When the number-average particle size of the fine silica particle in terms of a primary particle falls within the range described above, the toner exhibits improved flowability and also has favorable storage stability.

The number-average particle size of the inorganic fine particle in terms of a primary particle is determined as an arithmetic average of the particle sizes of 100 inorganic fine particles (primary particles) measured in the field of view by observation under a scanning electron microscope.

As the inorganic fine particle, the fine silica particle can be used in combination with a fine particle of titanium oxide, alumina or a double oxide thereof. The inorganic fine particle that is used in combination therewith can be titanium oxide.

The fine silica particle includes fine particles of both of dry silica produced by the vapor-phase oxidation of silicon halide or dry silica called fumed silica and wet silica produced from liquid glass. The silica is more preferably dry silica that contains fewer silanol groups on the surface and in the inside thereof and has fewer production residues of Na₂O and SO₃²⁻. The dry silica can also be obtained, for example, as a composite fine particle of the silica and an additional metal oxide by using an additional metal halogen compound (e.g., aluminum chloride and titanium chloride) with a silicon halogen compound in the production process. The silica also encompasses such a particle.

The inorganic fine particle is also added for achieving the uniform fractional charging properties of the toner. Since the inorganic fine particle can be hydrophobized for the functionalization of the toner, such as adjustment of its fractional charge quantity, improvement in environmental stability and improvement in characteristics in a high-moisture environment, such a hydrophobized inorganic fine particle can be used. If the inorganic fine particle externally added to the toner particle absorbs moisture, the resulting toner is more likely to have a reduced frictional charge quantity and exhibit reduced developability or transferability.

Examples of the treatment agent for the hydrophobization of the inorganic fine particle include the following:
unmodified silicone varnish, various modified silicone varnishes, unmodified silicone oil, various modified silicone oils, silane compounds, silane coupling agents, other organosilicon compounds and organotitanium compounds. These treatment agents may be used alone or in combination.

Among others, an inorganic fine particle treated with a silicone oil is preferred. A hydrophobized inorganic fine particle obtained by treating the inorganic fine particle with a silicone oil at the same time with hydrophobizing the particle; with a coupling agent or after hydrophobizing the particle with a coupling agent is more preferred from the viewpoint that the frictional charge quantity of the toner particle can be kept high even in a high moisture environment while selective developability can be reduced.

The amount of the inorganic fine particle added is usually 0.01 parts by mass or larger and 10 parts by mass or smaller, preferably 0.05 parts by mass or larger and 5 parts by mass or smaller, with respect to 100 parts by mass of the toner particle.

The method for producing the toner of the present invention is not particularly limited, and a conventional method known in the art can be used, such as a suspension polymerization method, a dissolution suspension method, an emulsion aggregation method or a pulverization method. Among these methods, the suspension polymerization method can easily control the state of being the resin C near the surface of the toner by use of the balance of polarity between water and toner materials. Therefore, the suspension polymerization method is a more preferred form for achieving the favorable chargeability of the toner.

Hereinafter, the method for producing the toner particle using the suspension polymerization method will be described.

First, a polymerizable monomer composition containing the resin C and polymerizable monomers that form an optional resin other than the resin C, and an optional additional component such as a colorant is granulated in an aqueous medium to polymerize the polymerizable monomers contained in the polymerizable monomer composition. The particle obtained by the polymerization can be prepared into a toner particle through filtration, washing and drying steps.

A dispersant can be added to the polymerizable monomer composition in order to granulate liquid droplets of the polymerizable monomer composition by uniform dispersion in the aqueous medium.

In the case of using a styrene acrylic resin, the method for adjusting the content of the styrene acrylic resin in the toner in the suspension polymerization method may employ a styrene monomer and an acrylic monomer as the polymerizable monomers or may make the adjustment by the addition of the styrene acrylic resin in advance for performing suspension polymerization.

A polymerization initiator for use in the suspension polymerization method may be added at the same time with adding other additives into the polymerizable monomers or may be mixed immediately before granulating the polymerizable monomer composition in the aqueous medium. Also, the polymerization initiator dissolved in the polymerizable monomers or a solvent may be added immediately after granulation and before the start of polymerization reaction.

Examples of the polymerization initiator include the following:
azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile and azobisisobutyronitrile; and peroxide polymerization initiators such as benzoyl peroxide, methyl ethyl ketone peroxide, diisopropyl peroxycarbonate, cumene hydroperoxide, 2,4-dichlorobenzoyl peroxide, lauroyl peroxide and tert-butyl peroxypivalate.

The amount of the polymerization initiator used varies depending on the target degree of polymerization and can generally be 3 parts by mass or larger and 20 parts by mass or smaller with respect to 100 parts by mass of the polymerizable monomers. Although the type of the polymerization initiator differs slightly according to the purpose, the polymerization initiator(s) is selected with reference to 10-hour half-life temperature and used alone or as a mixture.

An inorganic or organic dispersant known in the art can be used as the dispersant for dispersing the polymerizable monomer composition into the aqueous medium.

Examples of the inorganic dispersant include the following:
tricalcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica and alumina.

On the other hand, examples of the organic dispersant include the following:
polyvinyl alcohol, gelatin, methylcellulose, methylhydroxypropylcellulose, ethylcellulose, carboxymethylcellulose sodium salt and starch.

Alternatively, a commercially available nonionic, anionic or cationic surfactant may be used as the dispersant for dispersing the polymerizable monomer composition into the aqueous medium. Examples of such a surfactant include the following:
sodium dodecyl sulfate, sodium tetradecyl sulfate, sodium pentadecyl sulfate, sodium octyl sulfate, sodium oleate, sodium laurate, potassium stearate and calcium oleate.

Among these dispersants for dispersing the polymerizable monomer composition into the aqueous medium, an inorganic poorly water-soluble dispersant is preferred, and a poorly water-soluble inorganic dispersant that is further soluble in acid is more preferably used.

The amount of the dispersant used can be 0.2 parts by mass or larger and 2.0 parts by mass or smaller with respect to 100 parts by mass of the polymerizable monomers. The aqueous medium can be prepared using 300 parts by mass or larger and 3,000 parts by mass or smaller of water with respect to 100 parts by mass of the polymerizable monomer composition.

In the present invention, in the case of preparing the aqueous medium containing the poorly water-soluble inorganic dispersant dispersed therein as mentioned above, a commercially available dispersant may be used directly and dispersed therein. Alternatively, the poorly water-soluble inorganic dispersant may be formed in the aqueous medium with high-speed stirring and prepared in order to obtain dispersant particles having fine uniform particle sizes. In the case of using, for example, tricalcium phosphate, as the dispersant, a fine particle of tricalcium phosphate can be formed by mixing an aqueous sodium phosphate solution with an aqueous calcium chloride solution with high-speed stirring.

<Electrophotographic Photosensitive Member>

he electrophotographic photosensitive member used in the present invention will be described in more detail.

A cylindrical electrophotographic photosensitive member prepared by forming photosensitive layers (charge generation layer and charge transport layer) on a cylindrical support is widely used as a general electrophotographic photosensitive member. Alternatively, the electrophotographic photosensitive member may have a shape such as a belt shape or a sheet shape.

The support can have conductivity (conductive support), and a support made of a metal such as aluminum, aluminum alloy or stainless can be used. In the case of an aluminum or aluminum alloy support, an extrusion drawing (ED) tube, an extrusion ironing (EI) tube, or a support obtained by the cutting, electrochemical buffing (electrolysis using an electrode having an electrolytic effect and an electrolytic solution, and polishing using a grindstone having a polishing effect), or wet or dry honing of such a tube can also be used. Alternatively, a metal support or a resin support coated with aluminum, aluminum alloy or indium oxide-tin oxide alloy by vacuum deposition may be used. The surface of the support may be subjected to cutting treatment, roughening treatment, alumite treatment or the like.

A support having a resin or the like impregnated with a conductive particle such as carbon black, a tin oxide particle, a titanium oxide particle or a silver particle, or a plastic having a conductive resin can also be used.

A conductive layer may be disposed between the support and an undercoat layer or a charge generation layer mentioned later for the purpose of suppressing interference patterns caused by scattering of laser light or the like, or masking a flaw in the support. This layer is formed using a coating solution for a conductive layer containing a conductive particle dispersed in a resin. Examples of the conductive particle include carbon black, acetylene black, powders of metals such as aluminum, nickel, iron, nichrome, copper, zinc and silver, and powders of metal oxides such as conductive tin oxide and ITO.

Examples of the resin for use in the conductive layer include polyarylate resins, polycarbonate resins, polyvinyl butyral resins, acrylic resins, silicone resins, epoxy resins, melamine rosins, urethan resins, phenol resins mid alkyd resins.

Examples of the solvent for the coating solution for a conductive layer include ether solvents, alcohol solvents, ketone solvents and aromatic hydrocarbon solvents.

The film thickness of the conductive layer is preferably 0.2 μm or larger and 40 μm or smaller, more preferably 1 μm or Larger and 35 μm or smaller, further preferably 5 μm or larger and 30 μm or smaller.

In the electrophotographic photosensitive member used in the present invention, an undercoat layer nay be disposed between the support or the conductive layer and a charge generation layer.

The undercoat layer can be formed by applying a coating solution for an undercoat layer containing a resin onto the support or the conductive layer and drying or curing this coating film.

Examples of the resin for use in the undercoat layer include polyacrylic acids, methylcellulose, ethylcellulose, polyamide resins, polyimide resins, polyamide-imide resins, polyamide acid resins, melamine resins, epoxy resins, polyurethane resins and polyolefin resins.

The film thickness of the undercoat layer is preferably 0.05 μm or larger and 7 μm or smaller, more preferably 0.1 μm or larger and 2 μm or smaller.

The undercoat layer may also contain a semiconductive particle, an electron-transporting substance or an electron-accepting substance.

A charge generation layer is disposed on the support, the conductive layer or the undercoat layer.

Examples of the charge-generating substance for use in the charge generation layer include azo pigments, phthalocyanine pigments. Indigo pigments and perylene pigments. Only one of these charge-generating substances may be used, or two or more thereof may be used. Among these substances, particularly, metallophthalocyanine such as oxotitanium phthalocyanine, hydroxygallium phthalocyanine or chlorogallium phthalocyanine is preferred because of high sensitivity.

Examples of the resin for use in the charge generation layer include polycarbonate resins, polyarylate resins, butyral resins, polyvinyl acetal resins, acrylic resins, vinyl acetate resins and urea resins. Among these resins, particularly, butyral resins are preferred. One or two or more of these resins can be used alone, as a mixture or as a copolymer.

The charge generation layer can be formed by applying a coating solution for a charge generation layer (obtained by dispersing the charge-generating substance together with the resin and a solvent) and drying the obtained coating film. Alternatively, the charge generation layer may be a vapor-deposited film of the charge generating substance.

Examples of the dispersion method include methods using a homogenizer, ultrasonic wave, a ball mill, a sand mill, an attritor, or a roll mill.

The ratio between the charge-generating substance and the resin is preferably in the range of 1:10 to 10:1 (mass ratio), particularly preferably in the range of 1:1 to 3:1 (mass ratio).

Examples of the solvent for use in the coating solution for a charge generation layer include alcohol solvents, sulfoxide solvents, ketone solvents, ether solvents, ester solvents and aromatic hydrocarbon solvents.

The film thickness of the charge generation layer is preferably 0.01 μm or larger and 5 μm or smaller, more preferably 0.1 μm or larger and 2 μm or smaller.

The charge generation layer can also be supplemented, if necessary, with various additives such as a sensitizer, an antioxidant, an ultraviolet absorber, and a plasticizer. The charge generation layer may also contain an electron-transporting substance or an electron-accepting substance in order to allow the charge to flow smoothly in the charge generation layer.

A charge transport layer is disposed on the charge generation layer. When the charge transport layer forms the outermost surface, the charge transport layer serves as a surface layer. In the case of using a laminate of charge transport layers, the charge transport layer positioned in the outermost surface servos as a surface layer. A protective layer may be disposed on the charge transport layer. In this case, the protective layer serves as a surface layer.

In the present invention, the surface layer contains at least one resin selected from the group consisting of polyarylate resin A having a polysiloxane structure represented by the formula (1) and polycarbonate resin B having a polysiloxane structure represented by the formula (1).

In the present invention, alternatively, the surface layer contains a fluorine resin particle and at least one resin selected from the group consisting of a polyarylate resin and a polycarbonate resin.

The surface layer thus configured has favorable cleaning properties. The present inventors have considered than the reasons for the favorable cleaning properties are mainly the following three reasons.

The first reason is probably that the toner having an isosorbide unit rarely adheres to the surface layer of the electrophotographic photosensitive member having a fluorine resin particle or a polysiloxane structure. The present inventors have searched for a factor that influences adhesive force between resins and consequently found that the adhesion energy between resins correlates with the solubility parameters (SP values) of the resins. FIG. 2 is a graph of measurement of the adhesion energy between various resins and urethan rubber in which the SP value of each resin is plotted on the abscissa with the adhesion energy between the resin and the urethan rubber on the ordinate. As seen from this graph, the larger difference between the SP values of the resin and the urethan rubber leads to smaller adhesion energy. In the present invention, the surface layer of the electrophotographic photosensitive member has a fluorine resin particle or a polysiloxane structure having a low SP value while the surface of the toner has an isosorbide unit having a high SP value. As a result, their SP values differ from each other, an compared with an electrophotographic photosensitive member or toner lacking such an SP value, so that the adhesive force between solids is probably weakened.

Provided that the toner rarely adheres to the surface layer of the electrophotographic photosensitive member, the toner is easily spread throughout the neighborhood of the contact nip part between a cleaning blade and the photosensitive without being fixed to the surface of the photosensitive in the contact nip part (which means that initially maldistributed toner is easily leveled off in the longitudinal direction of the cleaning blade). This facilitates forming a uniform stagnant layer. Furthermore, the toner moves more smoothly on the surface of the photosensitive member. Therefore, near the contact nip part, toner-rotating force brought about by the surface of the photosensitive to be rubbed and the cleaning blade is rarely transferred to the toner (which means that force in the rotational direction rarely acts on the toner). It is believed that the suppressed rotation of the toner near the contact nip part may rarely generate the turning force of the toner that pushes up the cleaning blade, so that the toner can be prevented from slipping through the contact nip.

The second reason is probably that the isosorbide unit contained in the toner exhibits hydrophilicity to generate moderate interaction between the toner particles. It is believed that this moderate interaction between the toner particles facilitates exerting the function of blocking transfer residue toner or external additives being conveyed, even if the amount of the toner present near the contact nip part between the blade and the photosensitive is small.

The third reason is probably that the presence of the fluorine resin particle or the polysiloxane structure in the surface layer of the electrophotographic photosensitive member can stabilize the stick-slip notion of the blade by the low frictional effect of the fluorine resin particle or the polysiloxane. This probably performs rapid formation of a stagnant layer without causing the chatter vibration of the blade, even if the amount of the toner prevent near the contact nip part is small.

By the synergistic effect of these mechanisms, it is believed that the image forming method, the process cartridge and the electrophotographic apparatus of the present Invention have favorable cleaning properties and can suppress reduction in image quality caused by the contamination of a charging member.

Next, the configuration will be described in detail in which the surface layer contains at least one resin selected from the group consisting of polyarylate resin A having a polysiloxane structure represented by the formula (1) (hereinafter, also referred to as “polyarylate resin A”) and polycarbonate resin B having a polysiloxane structure represented by the formula (1) (hereinafter, also referred to as “polycarbonate resin B”).

The content of the polysiloxane structure represented by the formula (1) in each of the polyarylate resin A and the polycarbonate resin B can be 5.0 mass % or more and 60 mass % or less. The content is preferably 5.0 mass % or more from the viewpoint that favorable cleaning properties are obtained. Also, the content is preferably 60 mass % or less from the viewpoint that the effect of improving cleaning properties are more stably obtained. The content is more preferably 10 mass % or more and 50 mass % or less. The content of the structure represented by the formula (1) contained in each of the polyarylate resin A and the polycarbonate resin B can be confirmed by, for example, normalization to the peak area ratio of a hydrogen atom (hydrogen atom constituting the resin) by the ¹H-NMR measurement of the resin as a general approach.

The degree of abundance of a silicon-containing compound in the outermost surface of the electrophotographic photosensitive member can be determined by measuring the abundance ratio of a silicon element to constituent elements in the outermost surface. In the present invention, the abundance ratio of a silicon element to constituent elements in the outermost surface of the surface layer of the electrophotographic photosensitive member obtained using electron spectroscopy for chemical analysis (ESCA) is preferably 3.0 atom % or more. When the abundance ratio of a silicon element is 3.0 atom % or more, more favorable cleaning properties are obtained. The abundance ratio of a silicon element is more preferably 5.0 atom % or more. Also, the abundance ratio of a silicon element is preferably 30 atom % or less from the viewpoint that favorable cleaning properties are more stably obtained.

In the present invention, the abundance ratio of a silicon element to constituent elements in the outermost surface of the surface layer of the electrophotographic photosensitive member was measured by electron spectroscopy for chemical analysis (ESCA) as follows:

### Apparatus Used:

Quantum 2000 Scanning ESCA Microprobe manufactured by PHI (Physical Electronics Industries, INC.)

### Measurement Conditions:

Excitation X ray: A1 Kα
Photoelectron take-off angle: 45°
X ray: 100 μm 25 W 15 kV
Raster: 300 μm×200 μm
Electron neutralizer gun: 20 μA, 1 V
Ion neutralizer gun: 7 mA, 10 V
Pass Energy: 58.70 eV
Step Size 0.125 eV
Sweep: F (10 times), C (10 times), O (10 times), Si (30 times), N (3C times)

From the peak intensity of each element measured under these conditions, surface atom concentration (atom %) is calculated using a relative sensitivity factor provided by PHI to determine the abundance ratio of a silicon element to constituent elements in the outermost surface of the surface layer.

In the present invention, the polysiloxane structure in each of the polyarylate resin A and the polycarbonate resin B can be a polysiloxane structure represented by the formula (15) given below, because the effects of the present invention are more easily obtained. This is probably because the polyarylate resin A and the polycarbonate resin B each having the polysiloxane structure represented by the formula (15) are easily localized in the outermost surface of the surface layer so that the abundance of the polysiloxane in the outermost surface is increased.

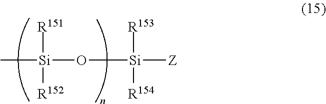

In the formula (15), R¹⁵¹ to R¹⁵⁴ are each independently selected from the group consisting of an alkyl group, a fluoroalkyl group and a phenyl group. In the formula (15), each of R¹⁵¹ to R¹⁵⁴ can be selected from the group consisting of a methyl group and a phenyl group.

In the formula (15), Z is selected from the group consisting of a hydrogen atom, a halogen atom, a substituted or unsubstituted alkyl group and a substituted or unsubstituted aryl group.

In the formula (15), n represents an integer of 10 or larger and 200 or smaller.

In the present invention, the polyarylate resin A or the polycarbonate resin B can be a polyarylate resin having a polysiloxane structure represented by the formula (2) given below in at least a portion of the end or a polycarbonate resin having a polysiloxane structure represented by the formula (2) given below in at least a portion of the end. In the polyarylate resin having a polysiloxane structure represented by the formula (2) in at least a portion of the end, examples of a structural unit constituting the principal chain whose end is bonded to the polysiloxane structure represented by the formula (2) include structural units represented by the formula (9) or (10) mentioned later. In the polycarbonate resin having the polysiloxane structure represented by the formula (2) in at least a portion of the end, examples of a structural unit constituting the principal chain whose end is bonded to the polysiloxane structure represented by the formula (2) include structural units represented by the formula (11) or (12) mentioned later.

The polyarylate resin A or the polycarbonate resin B is preferably a polyarylate resin having at least one of structural units represented by the formulas (3) to (5) given below, or a polycarbonate resin having at least one of structural units represented by the formulas (6) to (8) given below. The polyarylate resin A or the polycarbonate resin B is more preferably a polyarylate resin having a polysiloxane structure represented by the formula (2) in at least a portion of the end, a polycarbonate resin having a polysiloxane structure represented by the formula (2) in at least a portion of the end, a polyarylate resin having a structural unit represented by the formula (9) or a polycarbonate resin having a structural unit represented by the formula (8), from the viewpoint that the effects of the present invention are more effectively obtained. This is probably because the polyarylate resin A and the polycarbonate resin B each having a polysiloxane structure represented by the formula (2) in at least a portion of the end, a structural unit represented by the formula (5) or a structural unit represented by the formula (8) are easily localized in the outermost surface of the surface layer, and additionally, the polysiloxane structure in the resin localized in the outermost surface is easily oriented toward the outermost surface; thus the abundance of the polysiloxane in the outermost surface is further increased.

Only one of these polyarylate resins A or polycarbonate resins B may be used, or two or more types thereof may be used in combination.

Hereinafter, the structures represented by the formulas (2) to (8) will be described in detail.

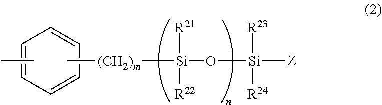

The formula (2) represents a monovalent group. In the formula (2) R²¹ to R²⁴ are each independently selected from the group consisting of an alkyl group, a fluoroalkyl group and a phenyl group. Among these groups, an alkyl group and a phenyl group are preferred, and a methyl group and a phenyl group are more preferred.

In the formula (2), Z is selected from the group consisting of an alkyl group having 1 to 4 carbon atoms and a phenyl group.

In the formula (2), n represents the number of repeats of the structure in parentheses and is an integer of 10 or larger and 200 or smaller from the viewpoint that favorable cleaning properties and electric characteristics can both be established.

In the formula (2), m represents the number of repeats of the structure in parentheses and is an integer of 1 or larger and 3 or smaller.

Specific examples of the structure represented by the formula (2) are shown below, though this structure is not limited thereto.

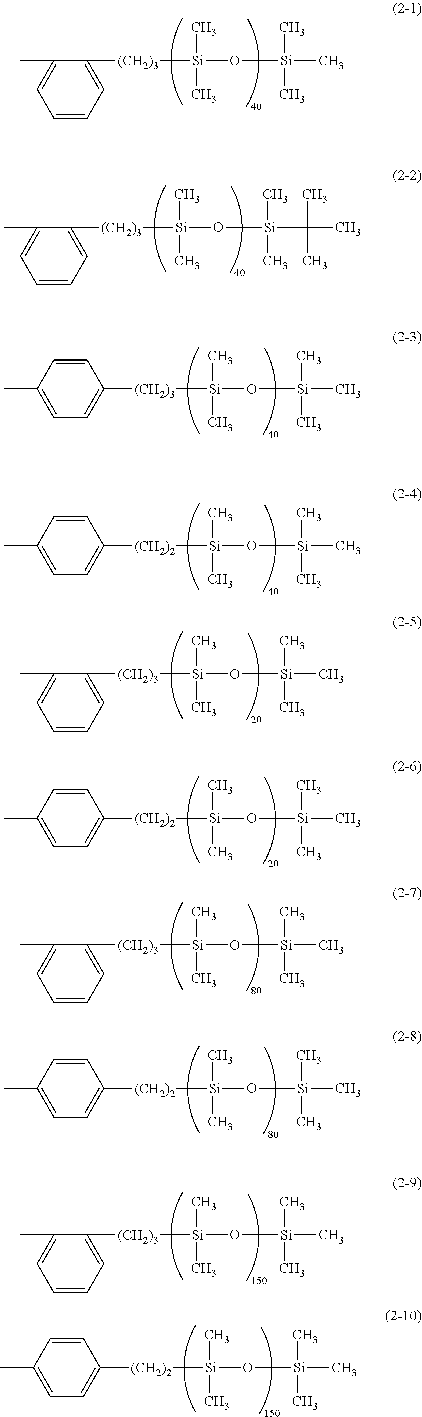

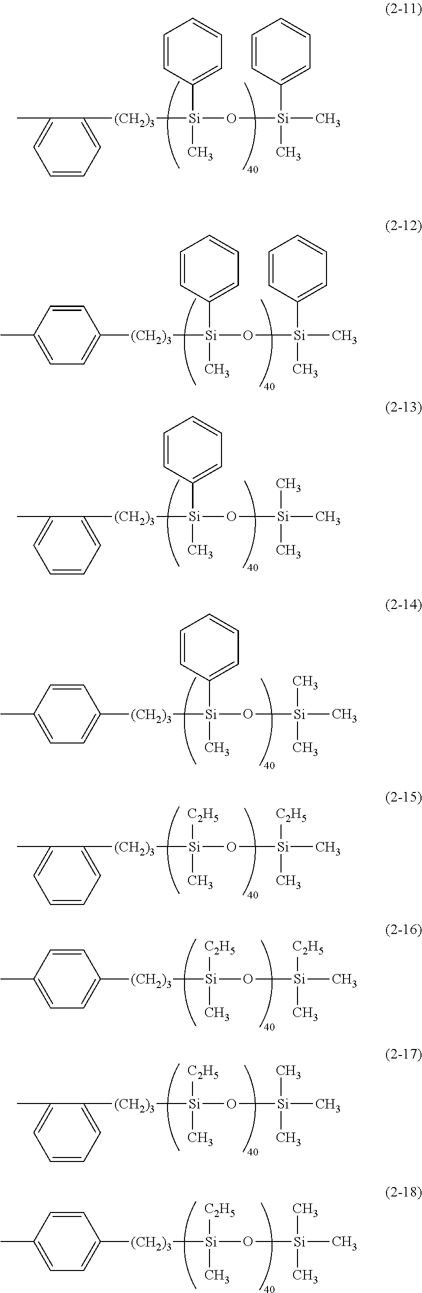

Among these structures, the structure represented by the formula (2-1), (2-2), (2-5), (2-7), (2-11) or (2-13) is preferred. Only one of these structures may be used, or two or more thereof may be used in combination.

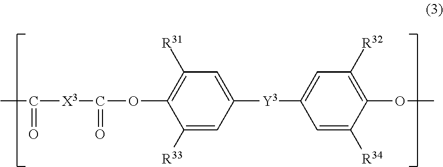

In the formula (3), R³¹ to R³⁴ are each independently selected from the group consisting of a hydrogen atom, an alkyl group, a fluoroalkyl group and a substituent represented by the formula (3-A) given below, and at least one of R³¹ to R³⁴ is a substituent represented by the formula (3-A),

In the formula (3), X³ is selected from the group consisting of a m-phenylene group, a p-phenylene group and a divalent group in which two p-phenylene groups are bended via an oxygen atom.

In the formula (3), Y³ is selected from the group consisting of a single bond, a methylene group, an ethylidene group, a propylidene group and a phenylethylidene group.

Specific examples of the structural unit represented by the formula (3) are shown below, though this structural unit is not limited thereto. In the formulas (3-1) to (3-14), A represents the formula (3-A).

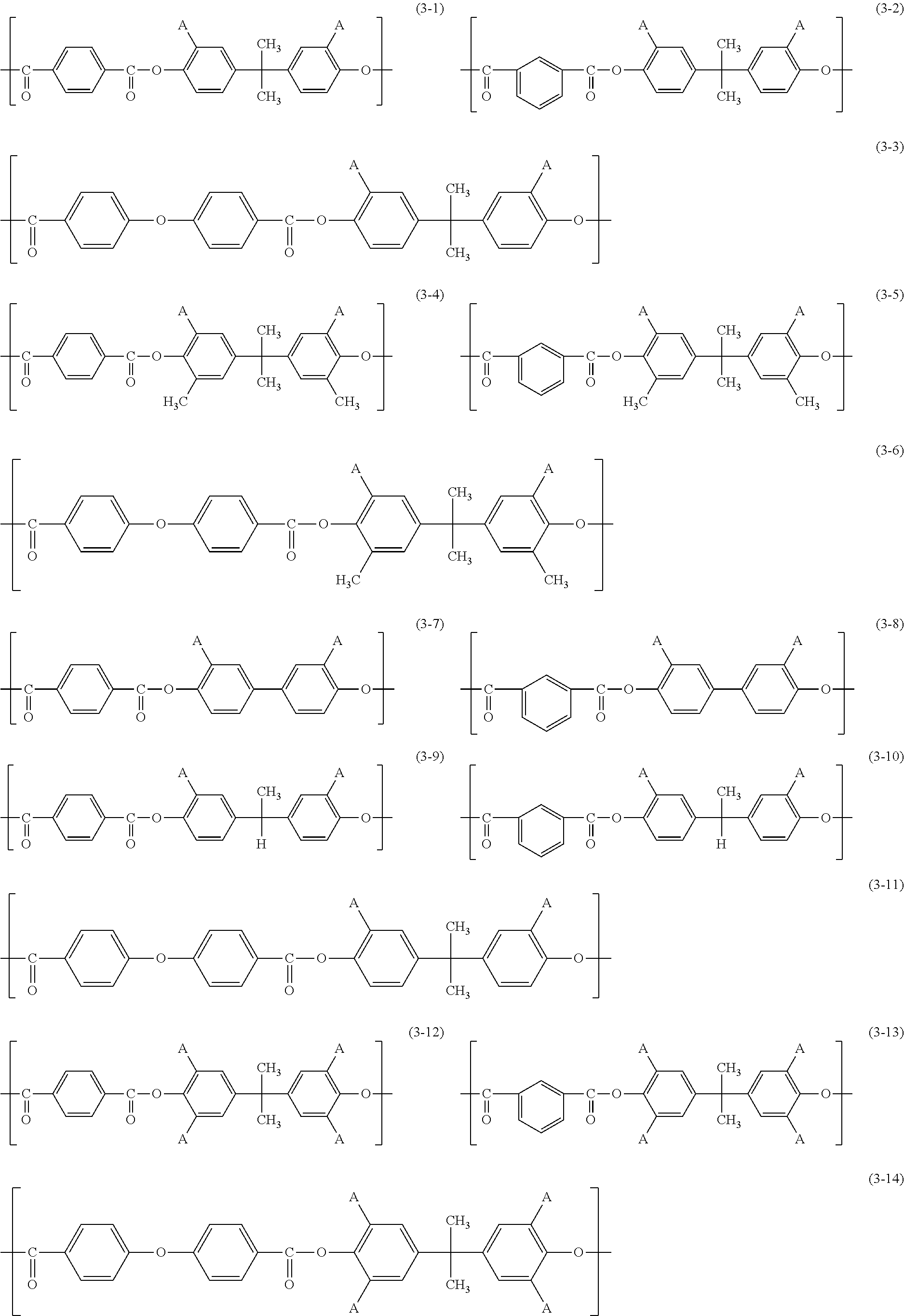

Among these structural units, a structural unit represented by the formula (3-1), (3-2), (3-3), (3-4), (3-5), (3-6), (3-7) or (3-11) is preferred. Only one of these structural units may be used, or two or more thereof may be used in combination.

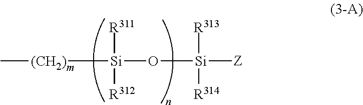

In the formula (3-A), R³¹¹ to R³¹⁴ are each independently selected from the group consisting of an alkyl group, a fluoroalkyl group and a phenyl group. Among these groups, an alkyl group and a phenyl group are preferred, and a methyl group is more preferred.

In the formula (3-A), Z is selected from the group consisting of an alkyl group having 1 to 4 carbon atoms and a phenyl group.

In the formula (3-A), n represents the number of repeats of the structure In parentheses. The average value of n is 10 or larger and 200 or smaller from the viewpoint that favorable cleaning properties and electric characteristics can both be established. Each individual value of n which represents the number of repeats of the structure in parentheses can fall within the range of ±10% of the value indicated by the average value of n, from the viewpoint that the effects of the present invention are stably obtained.

In the formula (3-A), in represents the number of repeats of the structure in parentheses. The average value of m is 0 or larger and 5 or smaller.

Specific examples of the group represented by the formula (3-A) are shown below, though this group is not limited thereto.

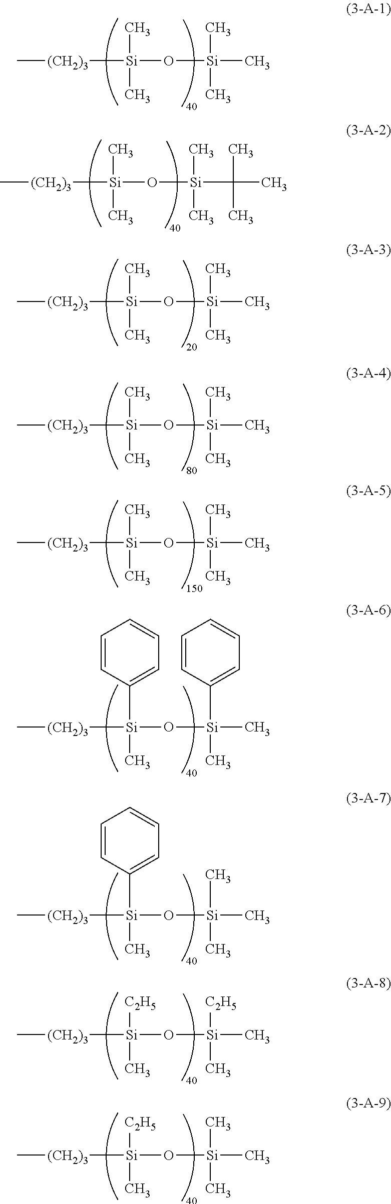

Among these structural units, a structural unit represented by the formula (3-A-1), (3-A-2), (3-A-4) or (3-A-7) is preferred. Only one of these structural units may be used, or two or more thereof may be used in combination.

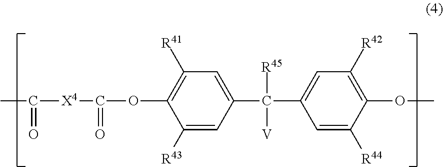

In the formula (4), R⁴¹ to R⁴⁴ are each independently selected from the croup consisting of a hydrogen atom, an alkyl group and a fluoroalkyl group. Among these groups, a hydrogen atom and a methyl group are preferred.

In the formula (4), R⁴⁵ is selected from the group consisting of a hydrogen atom, an alkyl group, a fluoroalkyl group and a phenyl group. Among these groups, a hydrogen atom, a methyl group and a phenyl group are preferred.

In the formula (4), X⁴ is selected from the group consisting of a m-phenylene group, a p-phenylene group and a divalent group in which two p-phenylene groups are bended via an oxygen atom.

In the formula (4), V represents at leant one of structures represented by the formulas (4-A) and (4-B) given below.

Specific examples of the structural unit represented by the formula (4) are shown below, though this structural unit is not limited thereto. In the formulas (4-1) to (4-12), V represents the formula (4-A) or (4-B).

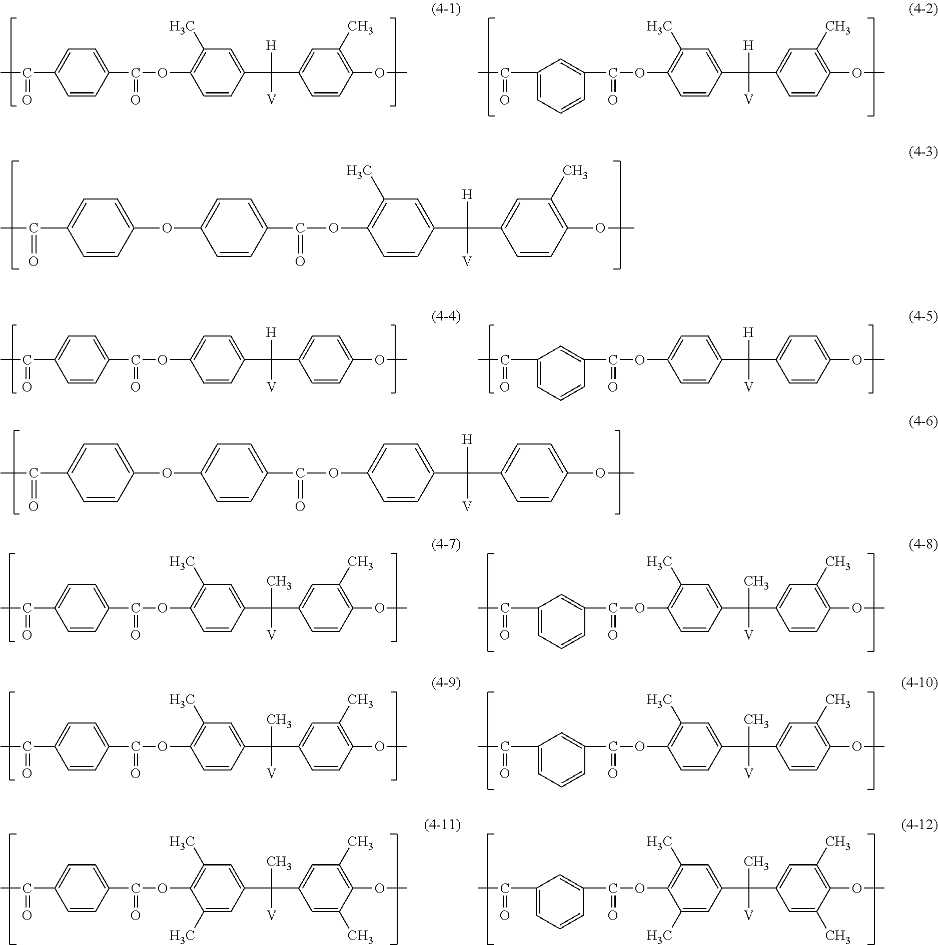

Among these structural units, a structural unit represented by the formula (4-1), (4-2), (4-3), (4-4), (4-5) or (4-6) is preferred. Only one of these structural units may be used, or two or more thereof may be used in combination.

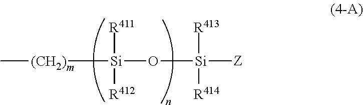

In the formula (4-A), R⁴¹¹ to R⁴¹⁴ are each independently selected from the group consisting of an alkyl group, a fluoroalkyl group and a phenyl group. Among these groups, a methyl group is preferred.

In the formula (4-A), Z is selected from the group consisting of an alkyl group having 1 to 4 carbon atoms and a phenyl group.

In the formula (4-A), n represents the number of repeats of the structure in parentheses. The average value of n is 10 or larger and 200 or smaller from the viewpoint that favorable cleaning properties and electric characteristics can both be established. The average value of n can be 10 or larger and 100 or smaller. Each individual value of n which represents the number of repeats of the structure in parentheses can fall within the range of ±10% of the value indicated by the average value of n, from the viewpoint that the effects of the present invention are stably obtained.

In the formula (4-A), m represents the number of repeats of the structure in parentheses. The average value of m is 3 or larger and 20 or smaller from the viewpoint that favorable cleaning properties are obtained. The difference between the largest value and the smallest value of m which represents the number of repeats of the structure In parentheses can be 0 or larger and 3 or smaller from the viewpoint that the effects of the present invention are stably obtained.

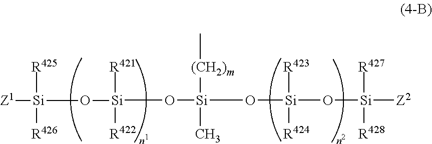

In the formula (4-B), R⁴²¹ to R⁴²⁸ are each independently selected from the group consisting of an alkyl group, a fluoroalkyl group and a phenyl group. Among these groups, a methyl group is preferred.

In the formula (4-B), Z¹ and Z² are each independently selected from the group consisting of an alkyl group having 1 to 4 carbon atoms and a phenyl group.

In the formula (4-B), n¹ and n² each represent the number of repeats of the structure in parentheses. The average value of n¹ and the average value of n² are each independently 10 or larger and 200 or smaller, and the total value of the average value of n¹ and the average value of n² is 20 or larger and 250 or smaller, from the viewpoint that favorable cleaning properties and electric characteristics can both be established. The average value of n¹ and the average value of n² can each independently be 10 or larger and 100 or smaller. Individual values of n¹ and n² which each represent the number of repeats of the structure in parentheses can fall within the range of ±10% of the values indicated by the average value of n¹ and the average value of n², respectively, from the viewpoint that the effects of the prevent: invention are stably obtained.

In the formula (4-B), m represents the number of repeats of the structure in parentheses. The average value of n is 3 or larger and 20 or smaller from the viewpoint that favorable cleaning properties are obtained. The difference between the largest value and the smallest value of m which represents the number of repeats of the structure in parentheses can be 0 or larger and 3 or smaller from the viewpoint that the effects of the present invention are stably obtained.

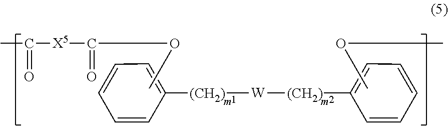

In the formula (5), X⁵ is selected from the group consisting of a m-phenylene group, a p-phenylene group and a divalent group in which two p-phenylene groups are bended via an oxygen atom.

In the formula (5), m¹ and m² each represent the number of repeats of the structure in parentheses. The average value of m¹ and the average value of m² are each independently 1 or larger and 3 or smaller.

In the formula (5), W represents a structure represented by the formula (5-A) given below.

Specific examples of the structural unit represented by the formula (5) are shown below, though this structural unit is not limited thereto. In the formulas (5-1) to (5-6), W represents the formula (5-A).

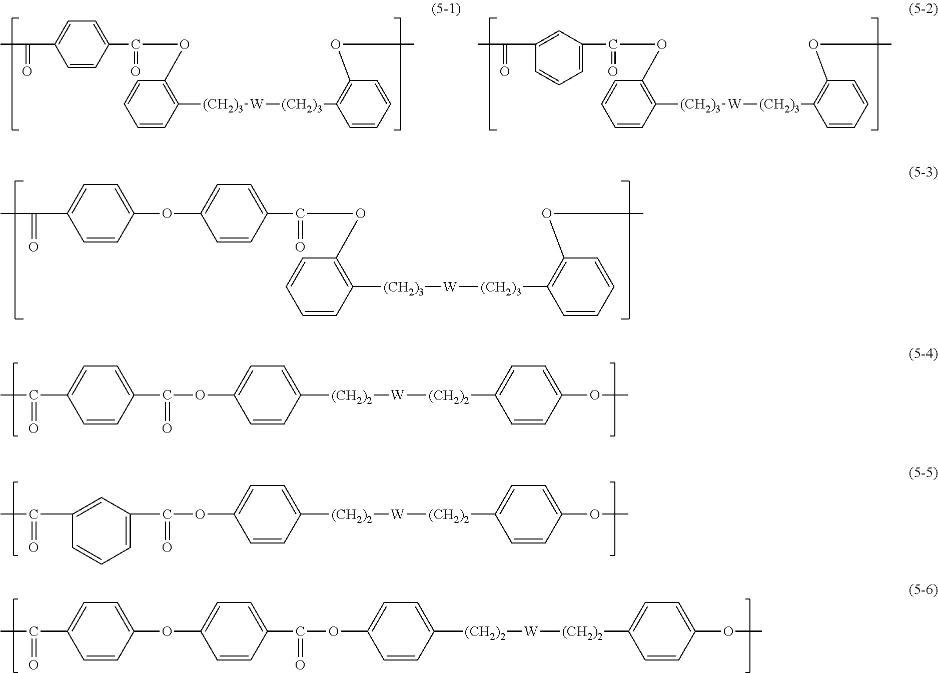

Among these structural units, a structural unit represented by the formula (5-1), (5-2) or (5-3) is preferred. Only one of these structural units may be used, or two or more thereof may be used in combination.

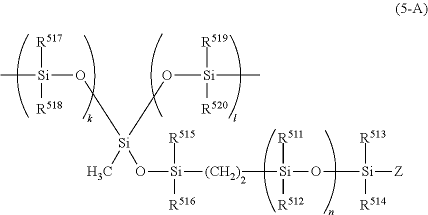

In the formula (5-A), R⁵¹¹ to R⁵²⁰ are each independently selected from the group consisting of an alkyl group, a fluoroalkyl group and a phenyl group. Among these groups, a methyl group is preferred.

In the formula (5-A), Z is selected from the group consisting of an alkyl group having 1 to 4 carbon atoms and a phenyl group.

In the formula (5-A), n represents the number of repeats of the structure in parentheses. The average value of n is 10 or larger and 200 or smaller from the viewpoint that favorable cleaning properties and electric characteristics can both be established. The average value of n can be 10 or larger and 150 or smaller. Bach individual value of n which represents the number of repeats of the structure in parentheses can fall within the range of ±10% of the value indicated by the average value of n, from the viewpoint that the effects of the present invention are stably obtained.

In the formula (5-A), k and l each represent the number of repeats of the structure in parentheses. The average value of k and the average value of 1 are each independently 1 or larger and 10 or smaller. The differences between the largest values and the smallest values of k and l which each represent the number of repeats of the structure in parentheses can each independently be 0 or larger and 3 or smaller.

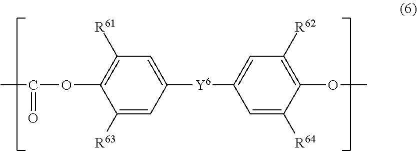

In the formula (6), R⁶¹ to R⁶⁴ are each independently selected from the group consisting of a hydrogen atom, an alkyl group, a fluoroalkyl group, a phenyl group and a substituent represented by the formula (6-A) given below, and at least one of R⁶¹ to R⁶⁴ is a substituent represented by the formula (6-A).

In the formula (6), Y⁶ is selected front the group consisting of a single bond, a methylene group, an ethylidene group, a propylidene group, a phenylethylidene group, a cyclohexylidene group and an oxygen atom.

Specific examples of the structural unit represented by the formula (6) are shown below, though this structural unit is not limited thereto. In the formulas (6-1) to (6-9), A represents the formula (6-A).

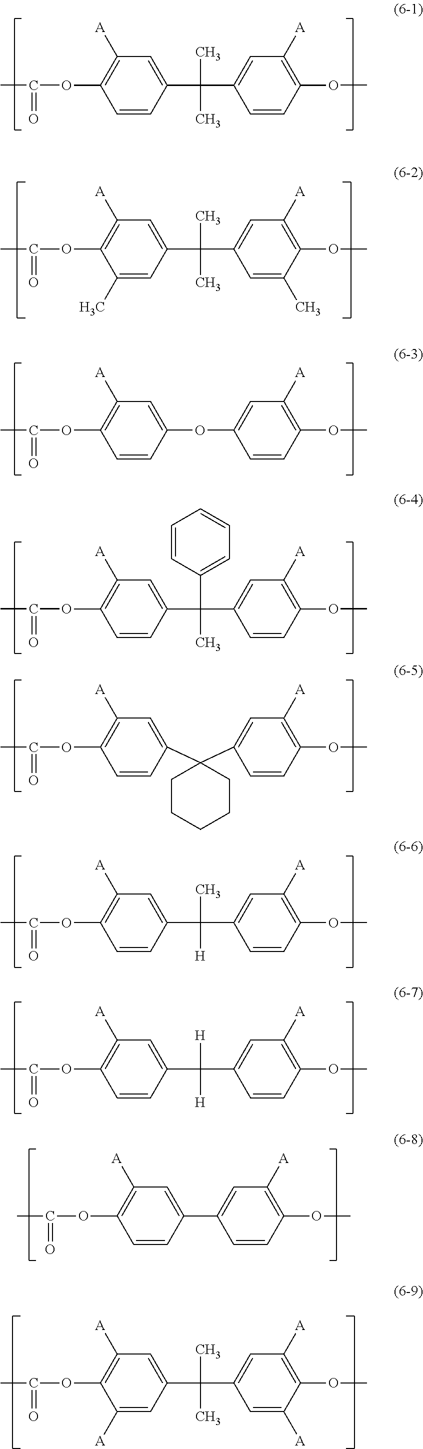

Among these structural units, a structural unit represented by the formula (6-1), (6-3), (6-5), (6-6) or (6-8) is preferred. Only one of these structural units may be used, or two or more thereof may be used in combination.

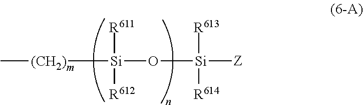

In the formula (6-A), R⁶¹¹ to R⁶¹⁴ are each independently selected from the group consisting of an alkyl group, a fluoroalkyl group and a phenyl group. Among these groups, an alkyl group and a phenyl group are preferred, and a methyl group is more preferred.

In the formula (6-A), Z is selected from the group consisting of an alkyl group having 1 to 4 carbon atoms and a phenyl group.

In the formula (6-A), n represents the number of repeats of the structure in parentheses. The average value of n is 10 or larger and 200 or smaller from the viewpoint that favorable cleaning properties and electric characteristics can both be established. Each individual value of n which represents the number of repeats of the structure in parentheses can fall within the range of ±10% of the value indicated by the average value of n, from the viewpoint that the effects of the present invention are stably obtained.

In the formula (6-A), m represents the number of repeats of the structure in parentheses. The average value of m is 0 or larger and 5 or smaller.

Specific examples of the structure represented by the formula (6-A) are the same as those for the formulas (3-A-1) to (3-A-9), though this structure is not limited thereto. Only one of these structures may be used, or two or more thereof may be used in combination.

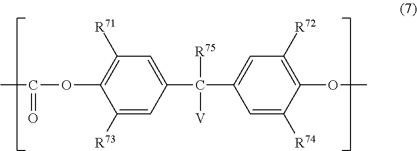

In the formula (7), R⁷¹ to R⁷⁴ are each independently selected from the group consisting of a hydrogen atom, an alkyl group, a fluoroalkyl group and a phenyl group. Among these groups, a hydrogen atom, an alkyl group having 1 to 4 carbon acorns and a phenyl group are preferred.

In the formula (7), R⁷⁵ is selected from the group consisting of a hydrogen atom, an alkyl group, a fluoroalkyl group and a phenyl group. Among these groups, a hydrogen atom and a methyl group are preferred.

In the formula (7), V represents at least one of structures represented by the formulas (7-A) and (7-B) given below.

Specific examples of the structural unit represented by the formula (7) are shown below, though this structural unit is not limited thereto. In the formulas (7-1) to (7-4), V represents the formula (7-A) or (7-B).

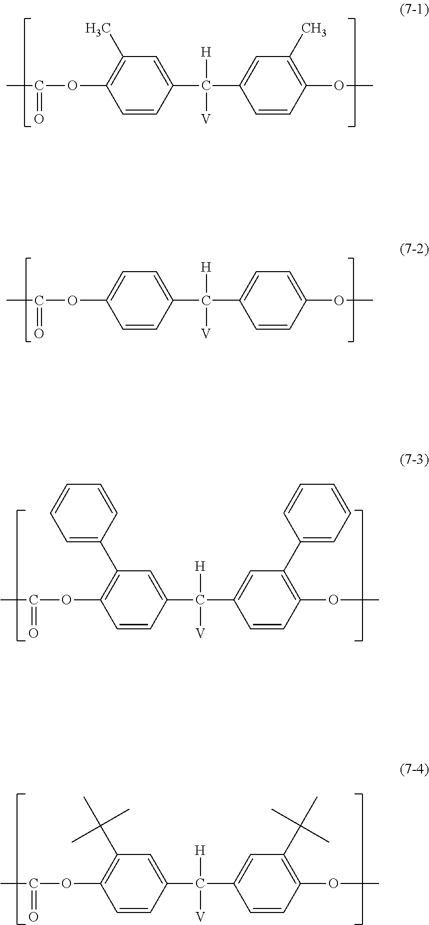

Among these structural units, a structural unit represented by the formula (7-1) or (7-2) is preferred. Only one of these structural units may be used, or two or more thereof may be used in combination.

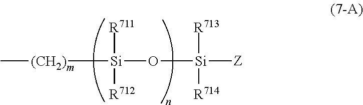

In the formula (7-A), R⁷¹¹ to R⁷¹⁴ are each independently selected from the group consisting of an alkyl group, a fluoxoalkyl group and a phenyl group. Among these groups, a methyl group is preferred.

In the formula (7-A), Z in selected from the group consisting of an alkyl group having 1 to 4 carbon atoms and a phenyl group.

In the formula (7-A), n represents the number of repeats of the structure in parentheses. The average value of n is 10 or larger and 200 or smaller from the viewpoint that favorable cleaning properties and electric characteristics can both be established. The average value of n can be 10 or larger and 100 or smaller. Each individual value of B which represents the number of repeats of the structure in parentheses can fall within the range of ±10% of the value indicated by the average value of n, from the viewpoint that the effects of the present invention are stably obtained.

In the formula (7-A), m represents the number of repeats of the structure in parentheses. The average value of m is 3 or larger and 20 or smaller from the viewpoint that favorable cleaning properties are obtained. The difference between the largest value and the smallest value of m which represents the number of repeats of the structure in parentheses can be 0 or larger and 3 or smaller from the viewpoint that the effects of the present invention are stably obtained.

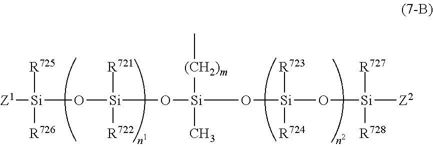

In the formula (7-B), R⁷²¹ to R⁷²⁸ are each independently selected from the group consisting of an alkyl group, a fluoroalkyl group and a phenyl group. Among these groups, a methyl group is preferred.

In the formula (7-B), Z¹ and Z² are each Independently selected from the group consisting of an alkyl group having 1 to 4 carbon atoms and a phenyl group.

In the formula (7-B), n¹ and n² each represent the number of repeats of the structure in parentheses. The average value of n¹ and the average value of n² are each independently 10 or larger and 200 or smaller, and the total value of the average value of n¹ and the average value of n² is 20 or larger and 250 or smaller, from the viewpoint that favorable cleaning properties and electric characteristics can both be established. The average value of n¹ and the average value of n² can each independently be 10 or larger and 100 or smaller. Individual values of n¹ and n² which each represent the number of repeats of the structure in parentheses can tall within the range of ±10% of the valuer) indicated by the average value of n¹ and the average value of n², respectively, from the viewpoint that the effects of the present invention are stably obtained.

In the formula (7-B), represents the number of repeats of the structure in parentheses. The average value of m is 3 or larger and 20 or smaller from the viewpoint that favorable cleaning properties are obtained. The difference between the largest value and the smallest value of m which represents the number of repeats of the structure in parentheses can be 0 or larger and 3 or smaller from the viewpoint that the effects of the present invention are stably obtained.

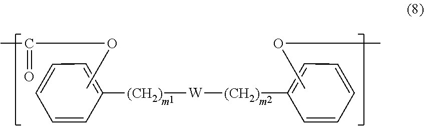

In the formula (8), m¹ and m² each represent the number of repeats of the structure in parentheses. The average value of m¹ and the average value of m² are each independently 1 or larger and 3 or smaller.

In the formula (8), W represents a structure represented by the formula (8-A) given below.

Specific examples of the structural unit represented by the formula (8) are shown below, though this structural unit is not limited thereto. In the formulas (8-1) and (8-2), W represents the formula (8-A).

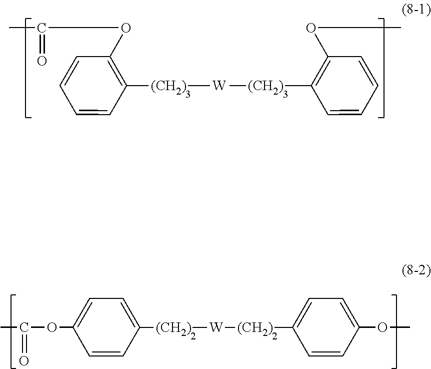

Among these structural units, a structural unit represented by the formula (8-1) is preferred. Only one of these structural units may be used, or two or more thereof may be used in combination.

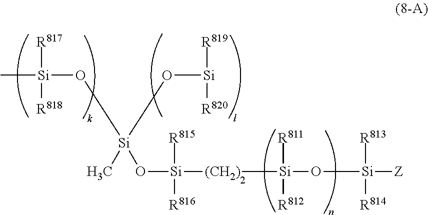

In the formula (8-A), R⁸¹¹ to R⁸²⁰ are each Independently selected from the group consisting of an alkyl group, a fluoroalkyl group and a phenyl group. Among these groups, a methyl group is preferred.

In the formula (8-A), Z is selected from the group consisting of an alkyl group having 1 to 4 carbon atoms and a phenyl group.

In the formula (8-A), n represents the number of repeats of the structure in parentheses. The average value of n is 10 or larger and 200 or smaller from the viewpoint that favorable cleaning properties and electric characteristics con both be established. The average value of n can be 10 or larger and 150 or smaller. Each individual value of n which represents the number of repeats of the structure in parentheses can fall within the range of ±10% of the value indicated by the average value of n, from the viewpoint that the effects of the present invention are stably obtained.

In the formula (8-A), k and l each represent the number of repeats of the structure in parentheses. The average value of k and the average value of 1 are each independently 1 or larger and 10 or smaller. The differences between the largest values and the smallest values of k and l which each represent the number of repeats of the structure in parentheses can each independently be 0 or larger and 3 or smaller.

In the present invention, the polyarylate resin A and the polycarbonate resin B may each have a structural unit other than the structural units represented by the formulas (3) to (8) on the backbone of the principal chain. The structural unit other than the structural units represented by the formulas (3) to (8) can be any of structural units represented by the following formulas (9) to (12):

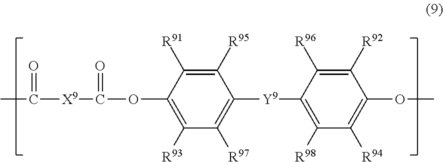

In the formula (9), R⁹¹ to R⁹⁸ are each independently selected from the group consisting of a hydrogen atom, a substituted or unsubstituted alkyl group and a substituted or unsubstituted aryl group. Among these groups, a hydrogen atom and a methyl group are preferred. X⁹ is selected from the group consisting of a m-phenylene group, a p-phenylene group and a divalent group in which two p-phenylene groups are bonded via an oxygen atom. Y⁹ is selected from the group consisting of a single bond, an oxygen atom, a sulfur atom and a divalent organic group. Among these groups, a single bond and a divalent organic group having 1 to 3 carbon atoms are preferred.

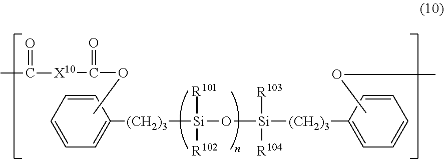

In the formula (10), R¹⁰¹ to R¹⁰⁴ are each independently selected from the group consisting of a methyl group, an ethyl group and a phenyl group. X¹⁰ is selected from the group consisting of a m-phenylene group, a p-phenylene group and a divalent group in which two p-phenylene groups are bonded via an oxygen atom. n represents the number of repeats of the structure in parentheses. The average value of n can be 10 or larger and 150 or smaller.

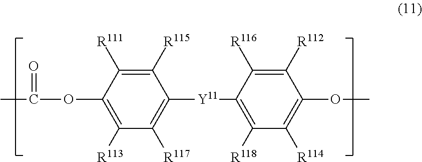

In the formula (11), R¹¹¹ to R¹¹⁸ are each independently selected from the group consisting of a hydrogen atom, a substituted or unsubstituted alkyl group and a substituted or unsubstituted aryl group. Among these groups, a hydrogen atom and a methyl group are preferred. Y¹¹ is selected from the group consisting of a single bond, an oxygen atom, a sulfur atom and a divalent organic group. Among these groups, a single bond, a divalent organic group having 1 to 3 carbon atoms, a phenylethylidene group, a cyclohexylidene group and an oxygen atom are preferred.

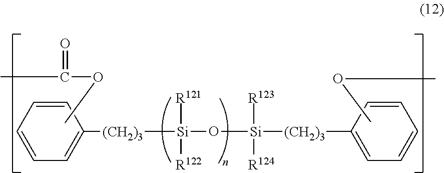

In the formula (12), R¹²¹ to R¹²⁴ are each independently selected from the group consisting of a methyl group, an ethyl group and a phenyl group. n represents the number of repeats of the structure in parentheses. The average value of n can be 10 or larger and 150 or smaller.

Specific examples of the structural units represented by the formulas (9) to (12) are shown below, though these structural units are not limited thereto.

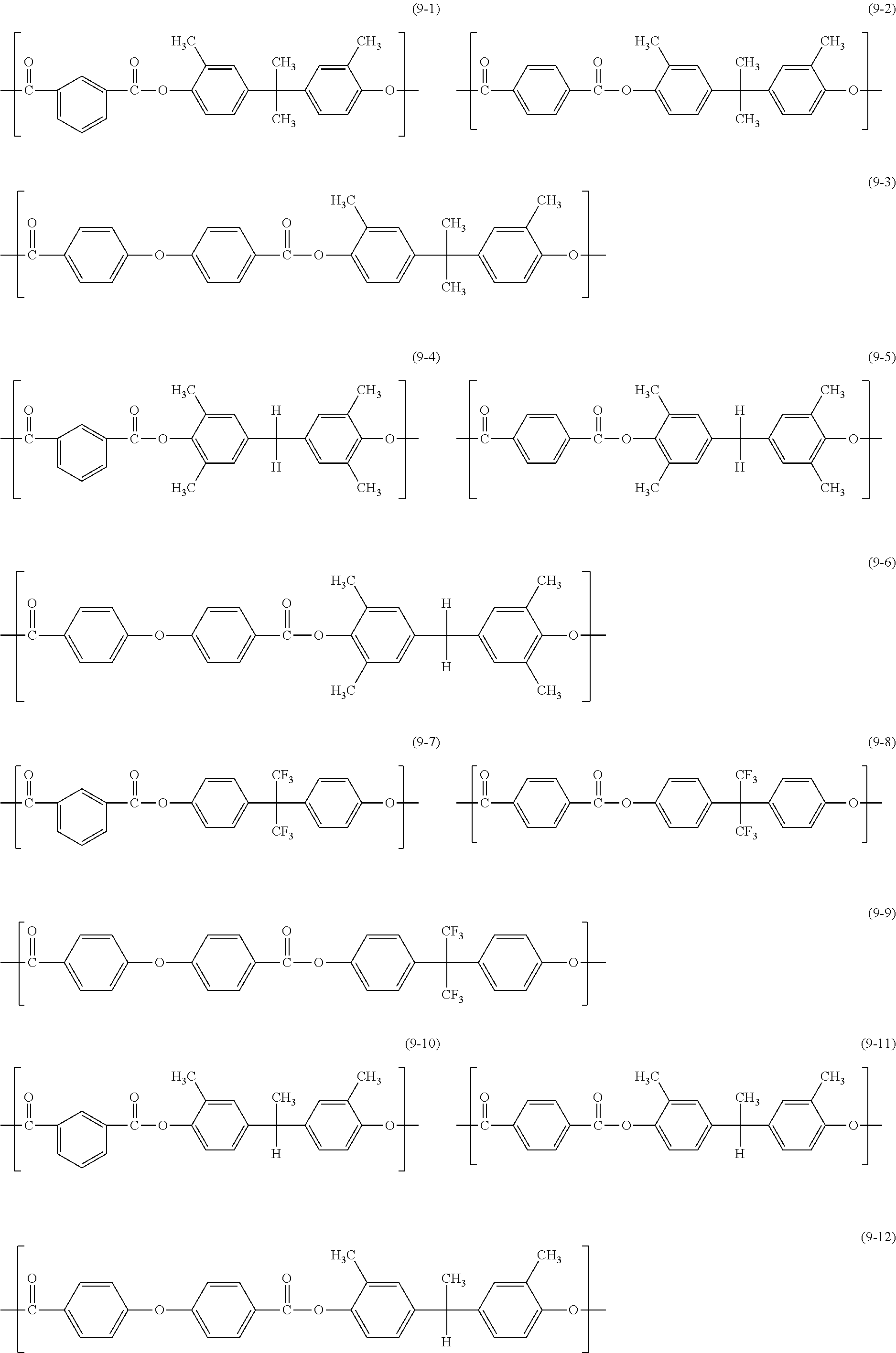

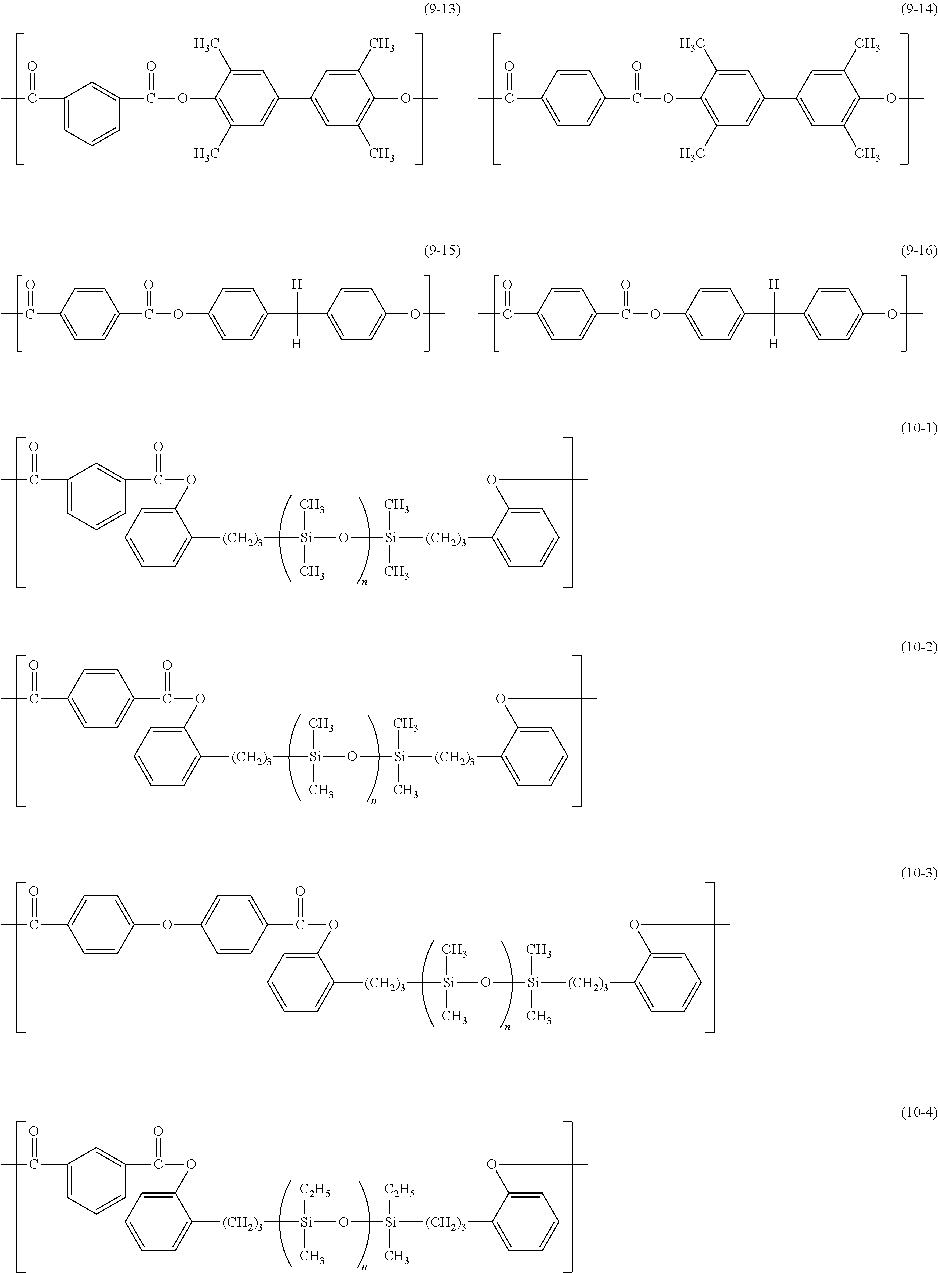

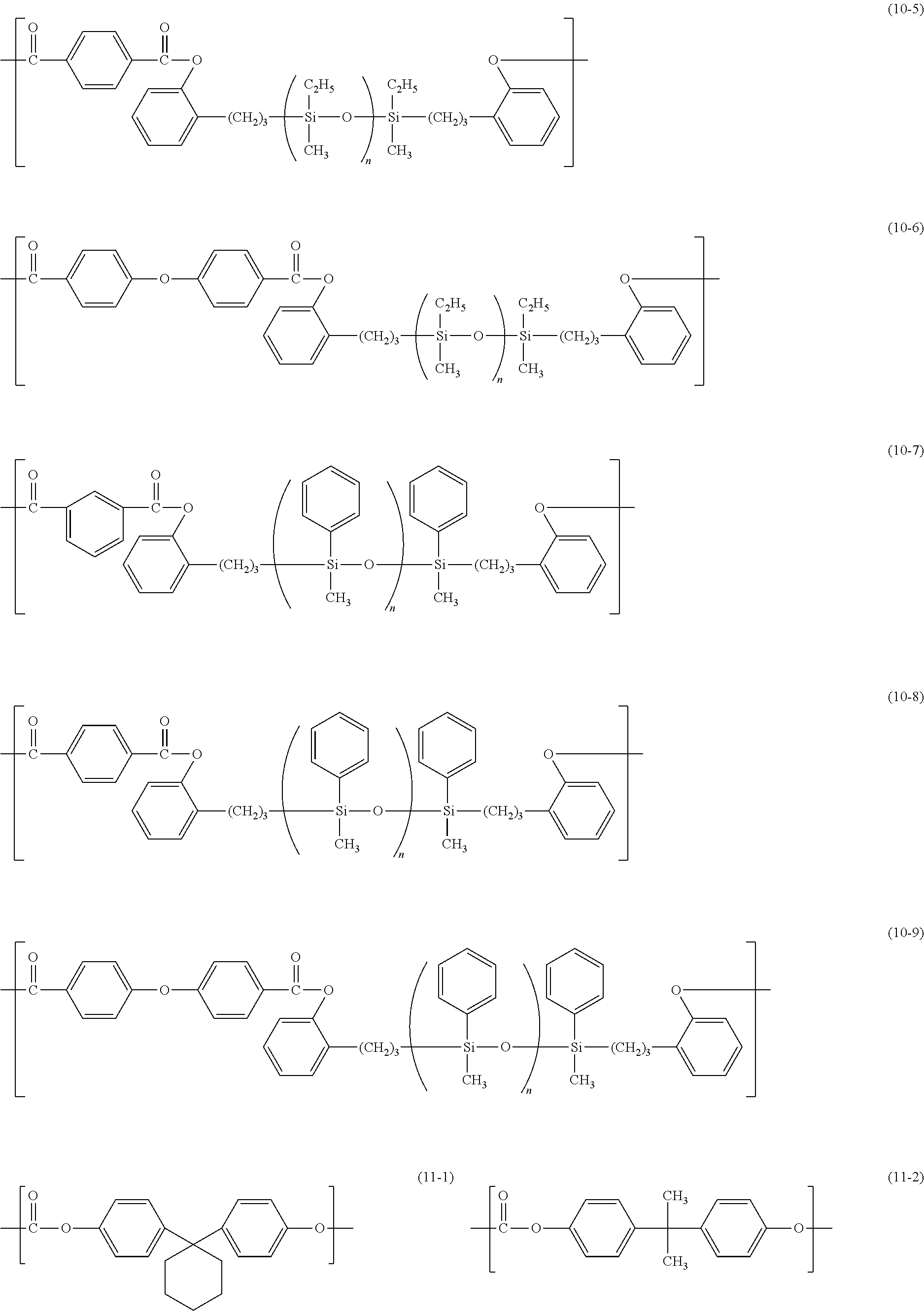

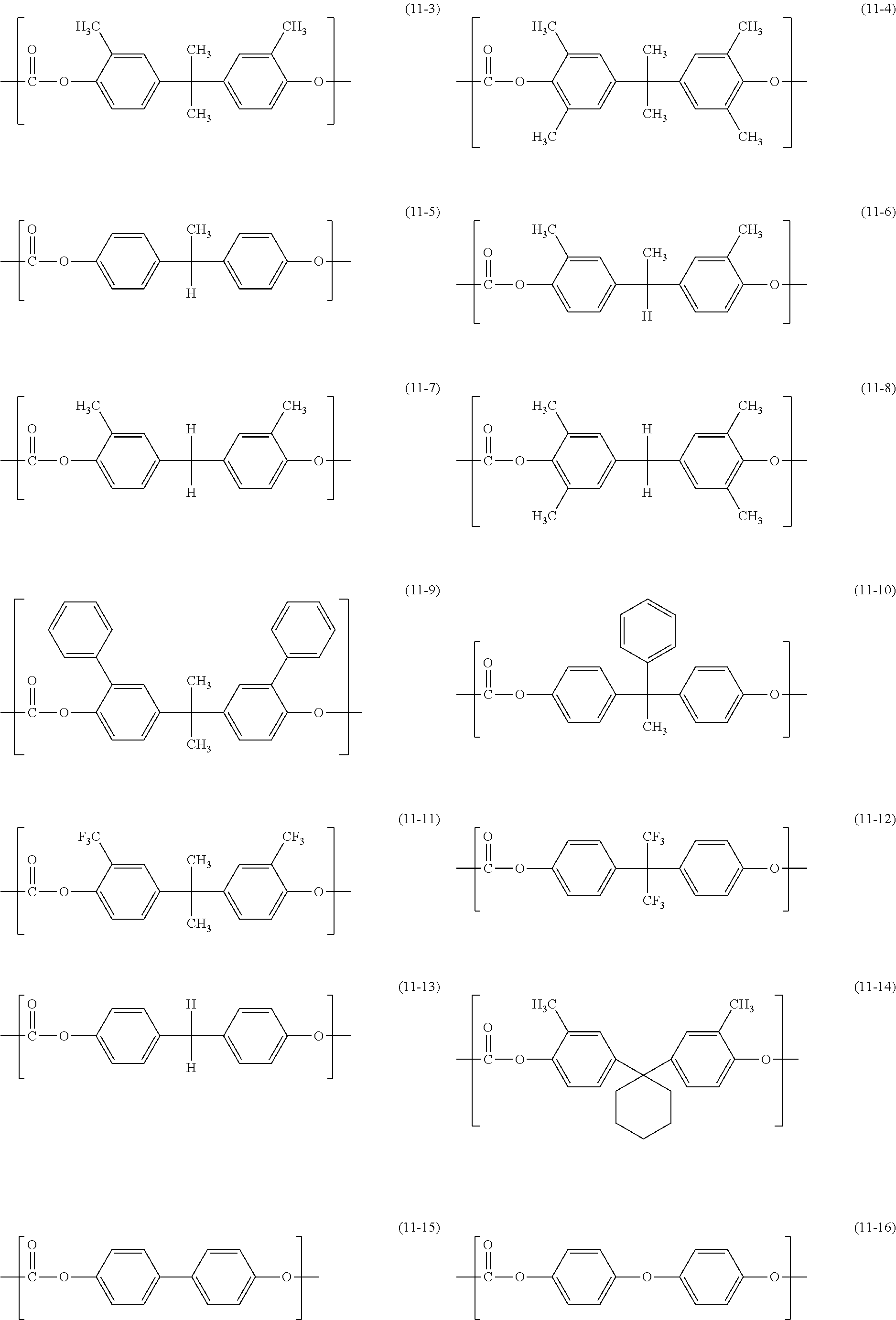

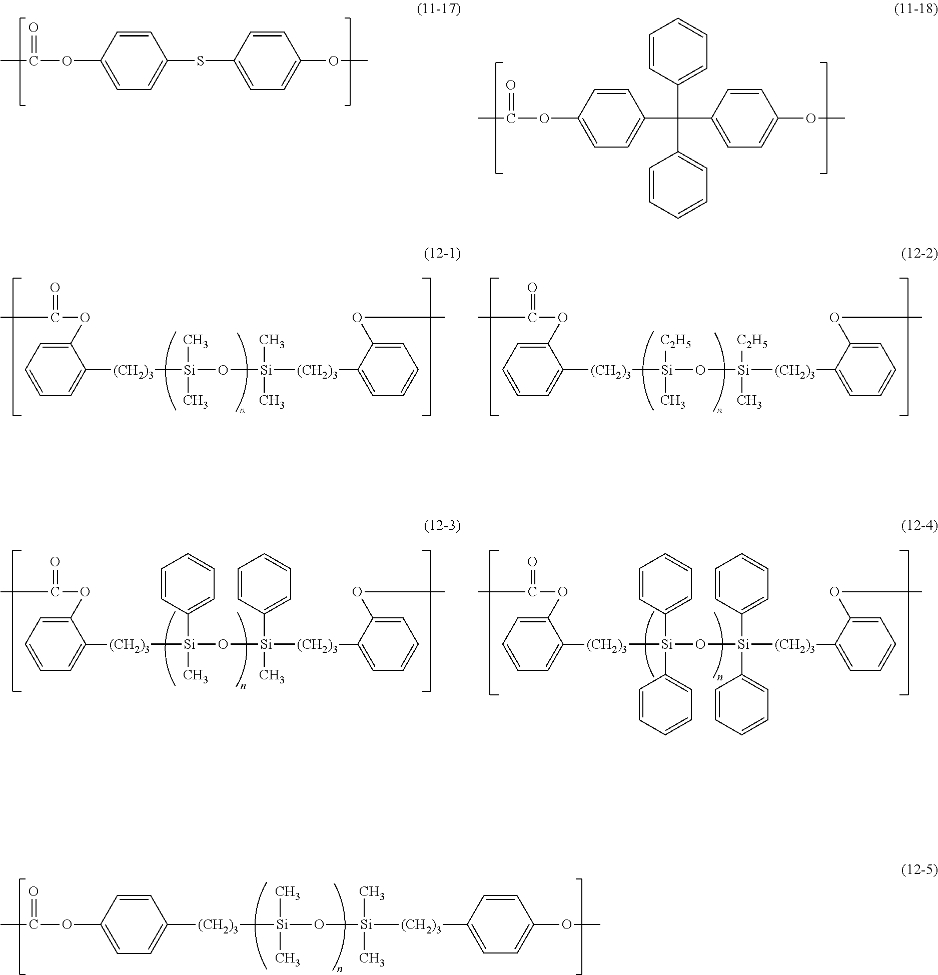

In the case of using the structural unit other than the structural units represented by the formulas (3) to (8) In each of the polyarylate resin A and the polycarbonate resin B, only one of these structural unite may be used, or two or more thereof may be used in combination.

Alternatively, the polyarylate resin A and the polycarbonate resin B may each contain a linear polysiloxane structure in the principal chain, instead of the polysiloxane structure represented by the formula (15). Specific examples of such a resin include a polyarylate resin having a structural unit represented by the formula (10) and a polycarbonate resin having a structural unit represented by the formula (12). Among others, a polyarylate resin having a structural unit represented by any of the formulas (10-1) to (10-3) or a polycarbonate resin having a structural unit represented by the formula (12-1) is preferred. Only one of these structural units may be used, or two or more thereof may be used in combination.

The viscosity-average molecular weight (Mv) of each of the polyarylate resin A and the polycarbonate resin B is preferably 1,000 or larger and 200,000 or smaller. The viscosity-average molecular weight is more preferably 5,000 or larger and 100,000 or smaller from the viewpoint of synthesis and film formability.

The polyarylate resin A and the polycarbonate resin B used in the present invention can be synthesized by an appropriately selected method known in the art, for example, a transesterification method, an interfacial polymerization method or a direct polymerization method.

In the present invention, the surface layer of the electrophotographic photosensitive member contains at least one resin selected from the group consisting of polyarylate resin A having a polysiloxane structure represented by the formula (1) and polycarbonate resin B having a polysiloxane structure represented by the formula (1), which may be used in combination with an additional resin without impairing the effects of the present invention. In this case, the total content of the polyarylate resin A and the polycarbonate resin B in the surface layer is preferably 0.1 mass % or more and 50 mass % or less with respect to the total mass of all solid components contained in the surface layer. When the polyarylate resin A and the polycarbonate resin B each have a polysiloxane structure represented by the formula (2) in at least a portion of the end, the total content of the polyarylate resin A and the polycarbonate resin B in the surface layer is more preferably 0.1 mass % or more and 20 mass % or less with respect to the total mass of all solid components contained in the surface layer, from the viewpoint that the favorable electric characteristics of the photosensitive member are obtained.

Examples of the resin that can be used in combination therewith include acrylic resins, acrylonitrile resins, allyl resins, alkyd resins, epoxy resins, silicone resins, phenol resins, phenoxy resins, butyral resins, polyacrylamide resins, polyacetal resins, polyamide-imide resins, polyamide resins, polyallyl ether resins, polyarylate resins, polyimide resins, polyurethane resins, polyester resins, polyethylene resins, polycarbonate resins, polystyrene resins, polysulfone resins, polyvinyl butyral resins, polyphenylene oxide resins, polybutadiene rosins, polypropylene resins, methacrylic resins, urea resins, vinyl chloride resins and vinyl acetate resins. Particularly, polyester resins, polyarylate resins and polycarbonate resins are preferred. A polyarylate resin having a structural unit represented by the formula (9) or a polycarbonate resin having a structural unit represented by the formula (11) is more preferred. Specific examples of the structural unit represented by the formula (9) and the structural unit represented by the formula (11) are as described above. One or two or more of these resins that can be used in combination with the polyarylate resin A or the polycarbonate resin B can be used alone, as a mixture or as a copolymer.

In the electrophotographic photosensitive member of the present invention, at least one resin selected from the group consisting of the polyarylate resin A and the polycarbonate resin B can be used as a mixture with polydimethylsiloxane represented by the formula (16) given below, because more favorable cleaning properties can be exerted. This is probably because further mixing with the polydimethylsiloxane further increases the abundance ratio of the polysiloxane structure in the outermost surface of the electrophotographic photosensitive member and enhances the effect of reducing adhesive force against the toner or the effect of reducing friction with a cleaning blade.

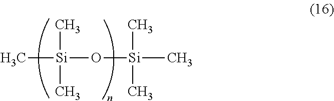

wherein n represents a positive integer of 10 or larger and 200 or smaller.

The mixing ratio of the polydimethylsiloxane represented by the formula (16) can be 3.0 mass % or more and 20.0 mass % or lens with respect to the polyarylate resin A and the polycarbonate resin B contained in the charge transport layer. When the mixing ratio is 3.0 mass % or more, the effect of improving cleaning properties by mixing with the polydimethylsiloxane is easily obtained. When the mixing ratio is 20.0 mass % or less, electrophotographic characteristics can be prevented from being deteriorated due to a rise in residual potential.

In the formula (16), n can particularly be 10 or larger and 100 or smaller.

The addition of the polydimethylsiloxane alone, even in a small amount, tends to remarkably elevate the residual potential and tends to cause reduction in image density resulting from reduced sensitivity or memory images such as ghosts. However, the mixing of at least one resin selected from the group consisting of the polyarylate resin A and the polycarbonate resin B with the polydimethylsiloxane according to the present invention in the range mentioned above rarely elevates the residual potential and offers favorable image quality.

The surface layer may contain a charge-transporting substance. Examples of the charge-transporting substance include triarylamine compounds, hydrazone compounds, styryl compounds, pyrazoline compounds, oxazole compounds, thiazole compounds, stilbene compounds, butadiene compounds and enamine compounds. Only one of these charge-transporting substances may be used, or two or more thereof may be used.

Specific examples of the charge-transporting substance are shown below, though this substance is not limited thereto.

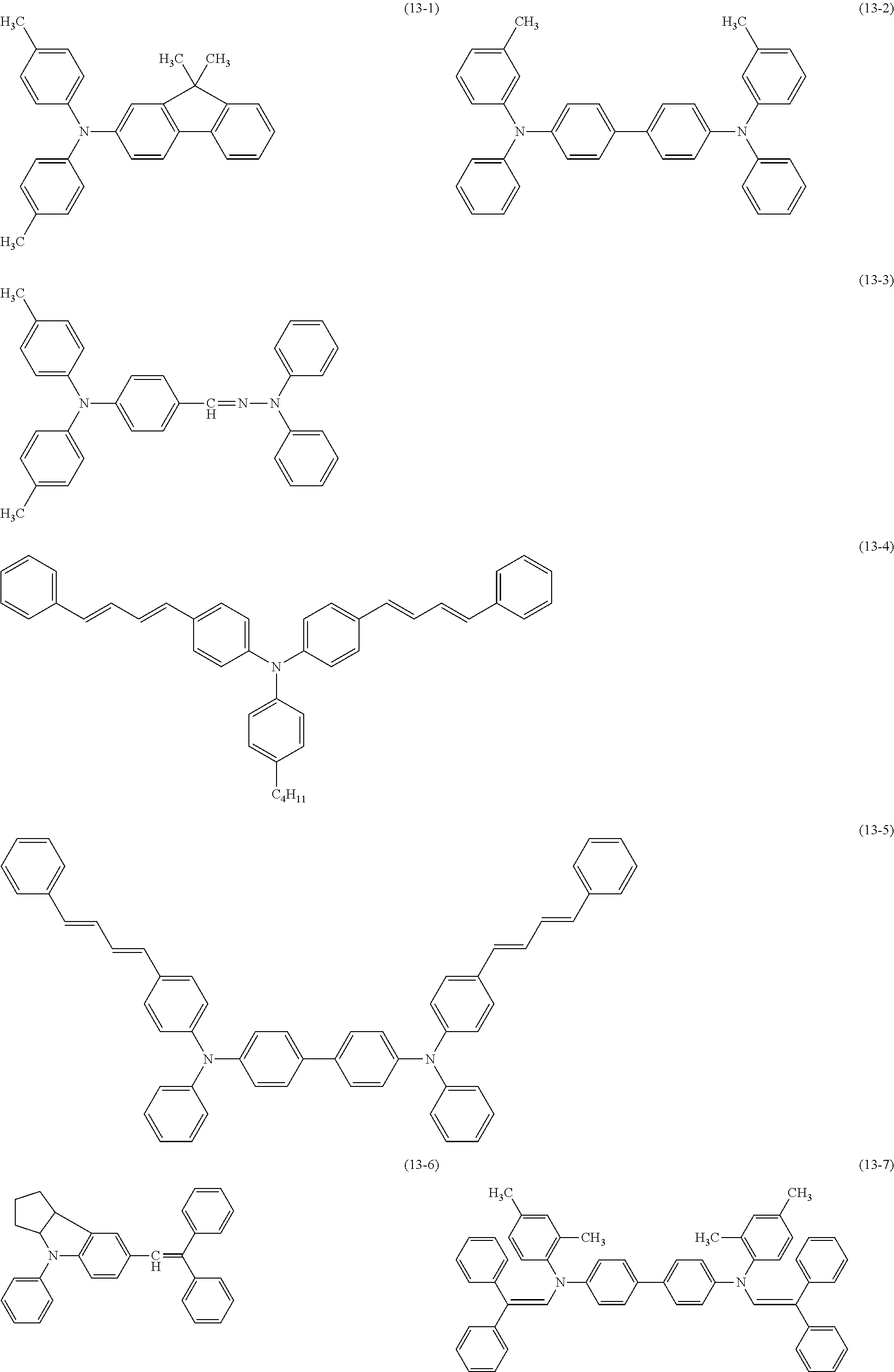

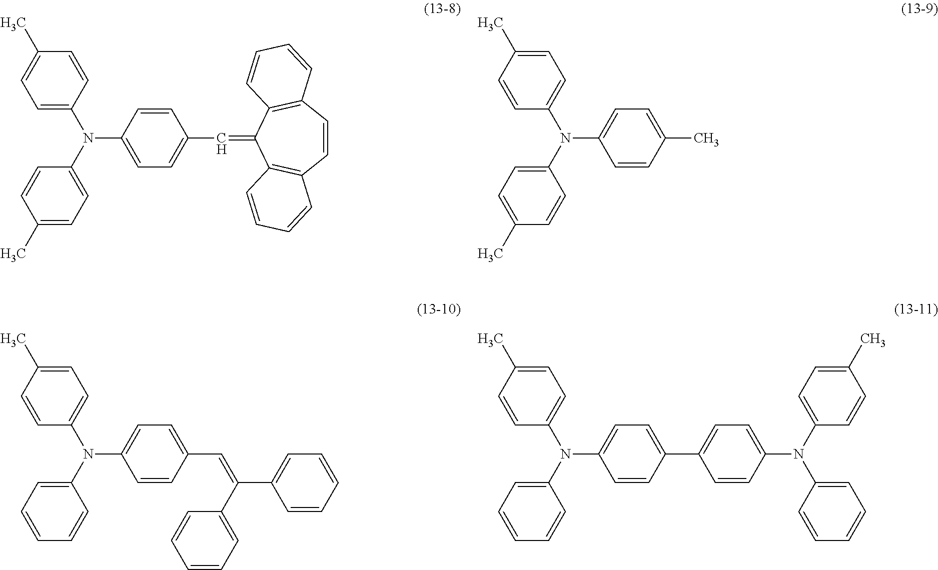 [SMILES: Cc1ccc(N(c2ccc(C)cc2)c2ccc(C=C3c4ccccc4C=Cc4ccccc43)cc2)cc1 ; Cc1ccc(N(c2ccc(C)cc2)c2ccc(C)cc2)cc1 ; Cc1ccc(N(c2ccccc2)c2ccc(C=C(c3ccccc3)c3ccccc3)cc2)cc1 ; Cc1ccc(N(c2ccccc2)c2ccc(-c3ccc(N(c4ccccc4)c4ccc(C)cc4)cc3)cc2)cc1]

When the surface layer is a charge transport layer, this layer can be formed using a coating film of a coating solution obtained by dissolving, in a solvent, at least one resin selected from the group consisting of the polyarylate resin A and the polycarbonate resin B, and the charge-transporting substance. As mentioned above, the resin other than the polyarylate resin A and the polycarbonate resin B may be used in combination therewith.

Alternatively, a laminated structure of charge transport layers may be used. In this case, at least the charge transport layer on the outermost surface side contains at least one resin selected from the group consisting of the polyarylate resin A and the polycarbonate resin B.

The ratio between the charge-transporting substance and all resins in the charge transport layer is preferably in the range of 3:10 to 20:10 (mass ratio), more preferably in the range of 5:10 to 12:10 (mass ratio).

Examples of the solvent for use in the coating solution for a charge transport layer include ketone solvents, ester solvents, ether solvents and aromatic hydrocarbon solvents. These solvents may be used alone or may be used as a mixture of two or more types thereof. Among these solvents, an ether solvent or an aromatic hydrocarbon solvent can be used from the viewpoint of resin solubility.

The film thickness of the surface layer is preferably 5 μm or larger and 50 μm or smaller, more preferably 10 μm or larger and 35 μm or smaller.

Next, the configuration will be described in detail in which the surface layer contains a fluorine resin particle and at least one resin selected from the group consisting of a polyarylate resin and a polycarbonate resin.

In the case of repetitively using the electrophotographic photosensitive member whose surface layer contains a fluorine resin particle and at least one resin selected from the group consisting of a polyarylate resin and a polycarbonate resin, the soft fluorine resin particle present in the outermost surface is elongated (stretched) on the electrophotographic photosensitive member by rubbing with a cleaning blade to elevate the area in which the fluorine resin is present on the electrophotographic photosensitive member. Thin elongating effect facilitates exerting the aforementioned effect of improving cleaning properties, even if the amount of the fluorine resin particle contained in the surface layer is small. Higher dispersibility of the fluorine resin particle present in the surface layer further increases the presence area of the fluorine resin by the elongating effect and further enhances the effect of improving cleaning properties.

The polyarylate resin used in the present invention can be a resin having a structural unit represented by the following formula (9):

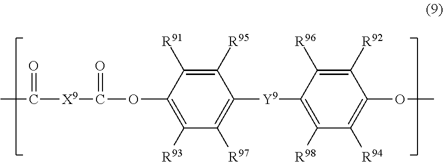

In the formula (9), R⁹¹ to R⁹⁸ are each independently selected from the group consisting of a hydrogen atom, a substituted or unsubstituted alkyl group and a substituted or unsubstituted aryl group. Among these groups, a hydrogen atom and a methyl group are preferred. X⁹ is selected from the group consisting of a m-phenylene group, a p-phenylene group and a divalent group in which two p-phenylene groups are bonded via an oxygen atom. Y⁹ is selected from the group consisting of a single bond, an oxygen atom, a sulfur atom and a divalent organic group. Among these groups, a single bond and a divalent organic group having 1 to 3 carbon atoms are preferred.

Specific examples of the structural unit represented by the formula (9) are as mentioned above.

Next, the polycarbonate resin used in the present invention will be described. The polycarbonate resin used in the present invention can be a resin having a structural unit represented by the following formula (11):

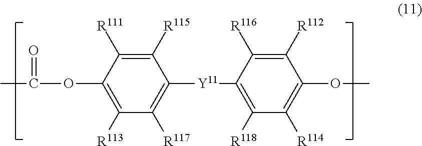

In the formula (11), R¹¹¹ to R¹¹⁸ are each independently selected from the group consisting of a hydrogen atom, a substituted or unsubstituted alkyl group and a substituted or unsubstituted aryl group. Among these groups, a hydrogen atom and a methyl group are preferred. Y¹¹ is selected from the group consisting of a single bond, an oxygen atom, a sulfur atom and a divalent organic group. Among these groups, a single bond, a divalent organic group having 1 to 3 carbon atoms, a phenylethylidene group, a cyclohexylidene group and an oxygen atom are preferred.

Specific examples of the structural unit represented by the formula (11) are as mentioned above.

Next, the fluorine resin particle used in the present invention will be described. The fluorine resin particle used in the present invention is preferably selected from the group consisting of an ethylene tetrafluoride resin particle, an ethylene trifluoride resin particle, an ethylene tetrafluoride-propylene hexafluoride resin particle, a vinyl fluoride resin particle, a vinylidene fluoride resin particle and an ethylene difluoride dichloride resin particle. Also, a copolymer particle thereof is preferred. Among these particles, an ethylene tetrafluoride resin particle is more preferred.

The primary particle size of the fluorine resin particle is preferably 0.05 μm to 1.0 μm, more preferably 0.1 μm to 0.6 μm. Particles that are fine to some extent and are uniformly dispersed in the surface layer easily produce more favorable cleaning performance. As a result, the secondary volume-average particle size of the fluorine resin particle in the surface layer can be 0.2 μm to 1.0 μm from the viewpoint that more favorable cleaning performance is obtained.

A dispersion aid can be used for uniformly dispersing the fluorine resin particle into the surface layer. An existing dispersion aid can be used for the fluorine resin particle. The dispersion aid can be a compound having both of a site having affinity for the fluorine resin particle and a site having affinity for the polyarylate or polycarbonate resin of the surface layer.

Such a fluorine resin particle dispersion aid may be generally purchased. Examples of the resin that can be purchased include Modiper series (manufactured by NOF Corp.) and Surflon series (manufactured by AGC Seimi Chemical Co., Ltd.).

In the present invention, the dispersion aid is more preferably a compound having the following structural unit below for more uniformly dispersing the fluorine resin particle into the surface layer:

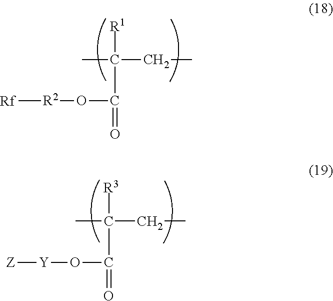

wherein in the formula (18), R¹ is selected from the group consisting of hydrogen and a methyl group, R² is selected from the group consisting of a single bond and a divalent group, and Rf represents a monovalent group having at least one of a fluoroalkyl group and a fluoroalkylene group; and in the formula (19), R³ is selected from the group consisting of hydrogen and a methyl group, Y represents a divalent organic group, and Z represents a polymer unit.

Alternatively, the dispersion did can also be diorganopolysiloxane represented by the following formula (20).

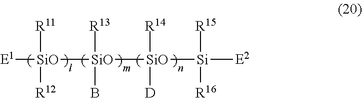

wherein R¹¹ to R¹⁶ each represent a substituted or unsubstituted hydrocarbon group, B represents a substituted or unsubstituted organic group having a perfluoroalkyl group, D represents an end-capped group having a degree of polymerization of 3 or larger and having a substituted or unsubstituted polystyrene chain, E¹ and E² each represent a group selected from the group consisting of R¹¹ to R¹⁶, B and D, 1 represents an integer of 0 to 1000, and m and n each represent an integer of 1 to 1000.

These compounds can be produced according to procedures disclosed in Japanese Patent Application Laid-Open No. S58-164656 and Japanese Patent Application Laid-Open No. 2001-249481. The compound thus produced has both of a site having affinity for the fluorine resin particle and a site having affinity for the polyarylate or polycarbonate resin of the surface layer and can therefore produce more uniform dispersibility of the fluorine resin particle.

Specific examples of the structural units represented by the formulas (16) and (19) and the compound represented by the formula (20) are shown below, though the structural units or the compound is not limited thereto.

Specific examples of the structural unit represented by formula

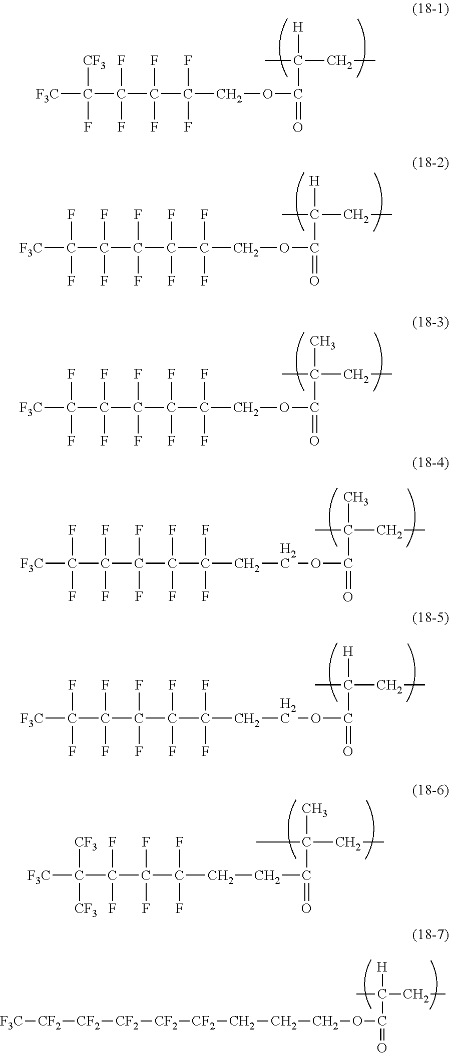

Specific examples of the structural unit represented by formula (19)

In the formula (19), examples of Y include a structure represented by

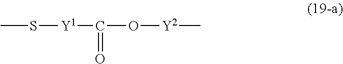

wherein Y¹ and Y² each independently represent an alkylene group and can each be a methyl group or a hydroxy group.

In the formula (19), Z is a polymer unit and has any structure as long as Z is the polymer unit. The polymer unit can have a repeating structural unit represented by the following formula (19-b1) or (1.9-2):

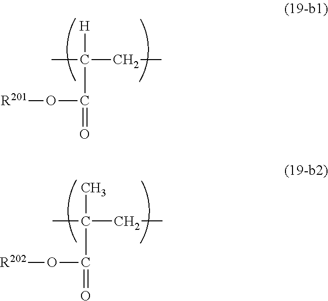

R²⁰¹ and R²⁰² each represent an alkyl group. Examples of the alkyl group include a methyl group, an ethyl group, a propyl group, a butyl group, a pentyl group, a hexyl group, a heptyl group, an octyl group and a nonyl group. The alkyl group can be a methyl group, an ethyl group, a propyl group, a butyl group, a pentyl group or a hexyl group.

The end of the polymer unit represented by Z may employ an end-capping agent or may have a hydrogen atom.

Specific examples of compound represented by formula (20)

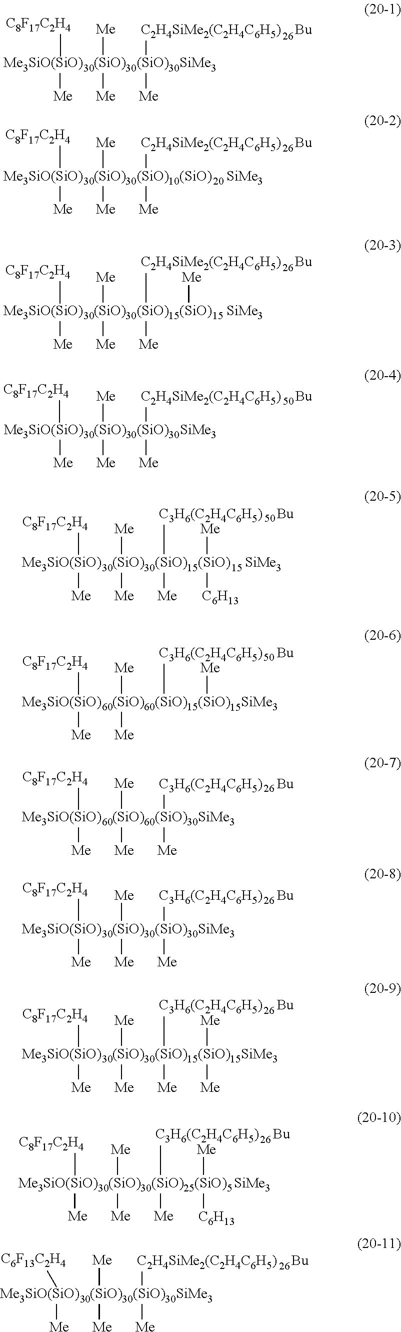

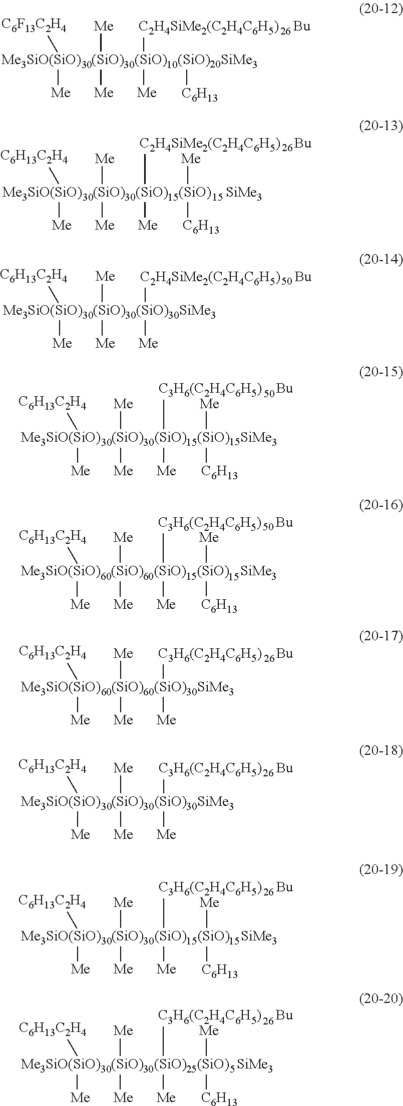

The compound represented by the formula (20), as compared with other dispersant structures, is preferred because in terms of its structure, this compound is easily oriented on the surface of PTPE when having an alkyl fluoride side chain in the siloxane chain, and on the other hand, is more compatible with a rosin or CTM through the styrene side chain so that uniform dispersibility is further enhanced. Among these compounds, compounds represented by the formulas (20-11), (20-14) and (20-16) are more preferred.

These repeating structural units may be of random copolymer type or may be of block copolymer type. The content of a fluorine atom in the polymer having the repeating structural units represented by the formulas (18) and (19) or the polymer represented by the formula (20) is preferably 1.0 mass % to 60.0 mass %, particularly preferably 5.0 mass % to 40.0 mass %, with respect to the total mass of the compound from the viewpoint of the favorable dispersibility of the fluorine resin particle.

The molecular weight (Mw) of the polymer having the repeating structural units represented by the formulas (18) and (19) or the polymer represented by the formula (20) can be 10,000 to 200,000.

The polymer having the repeating structural units represented by the formulas (18) and (19) or the polymer represented by the formula (20) can be used as a constituent for a coating solution for a surface layer, together with the fluorine resin particle, in the production of the electrophotographic photosensitive member. An a result, the fluorine resin particle can be dispersed with a particle size close to the primary particle.

Thus, according to the present invention, the electrophotographic photosensitive member having the surface layer containing an appropriately dispersed fluorine atom-containing resin particle can be obtained. As a result, excellent cleaning performance can be exhibited in the presence of the uniform fluorine resin particle on the photosensitive member surface layer, even after repetitive use.

In the present Invention, the surface layer can contain 3.0 mass % to 10.0 mass % of the fluorine resin particle for exerting a higher effect on cleaning performance after repetitive use. When the content of the fluorine resin particle is 3.0 mass % or more, the aforementioned elongating effect can sufficiently elevate, the area occupied by the fluorine resin on the electrophotographic photosensitive member and produce more favorable cleaning properties when the content of the fluorine resin particle is 10.0 mass % or less, more favorable photosensitive member characteristics can be obtained. The polymer having the repeating structural units represented by the formulas (18) and (19) or the polymer represented by the formula (20) can be contained in the range of 2.0 mass % to 10.0 mass % with respect to the mass of the fluorine resin particle, from the viewpoint that the favorable dispersibility of the fluorine resin particle and the photosensitive member characteristics can both be established.

The fluorine resin particle can be dispersed into the surface layer coating solution by a method such as a homogenizer, ultrasonic dispersion, a ball mill, a vibratory ball mill, a sand mill, an attritor, a roll mill, or a wet collision-type high-speed dispersing machine, according to the need.

The average particle size of the fluorine atom-containing resin particle can be measured using an ultracentrifugal particle size distribution measurement apparatus “CAPA-700” (manufactured by HORIBA, Ltd.) or a laser diffraction/scattering particle size distribution measurement apparatus “LA-750” (manufactured by HORIBA, Ltd.). For example, the method for measuring the average particle size is as follows: a dispersion immediately after addition and dispersion of fluorine at or-containing resin particles is subjected to the measurement of the average particle size by a liquid-phase precipitation method before mixing with the coating solution for a surface layer. In the case of using the ultracentrifugal automatic particle size distribution measurement apparatus (CAPA700) manufactured by HORIBA, Ltd., the average particle size is measured according to the conditions of the instruction manual after dilution with a solvent that serves as a main component of the coating solution for a surface layer.

The surface layer may contain a charge-transporting substance. Examples of the charge-transporting substance include triarylamine compounds, hydrazone compounds, styryl compounds, pyrazolone compounds, oxazole compounds, thiazole compounds, stilbene compounds, butadiene compounds and enamine compounds. Only one of these charge-transporting substances may be used, or two or more thereof may be used.

Specific examples of the charge-transporting substance are as mentioned above.

The surface layer contains the fluorine resin particle and at least one resin selected from the group consisting of a polyarylate resin and a polycarbonate resin. The surface layer can be formed using a coating film of a coating solution obtained by dissolving and dispersing, in a solvent, at least one resin selected from the group consisting of a polyarylate resin and a polycarbonate resin and the fluorine resin particle. As mentioned above, the resin other than the polyarylate resin and the polycarbonate resin may be used in combination therewith.

Alternatively, a laminated structure of charge transport layers may be used. In this case, at least the charge transport layer on the outermost surface side contains at least one resin selected from the group consisting of a polyarylate resin and a polycarbonate resin and further contains the fluorine resin particle.

The ratio between the charge transporting substance and all resins in the charge transport layer is preferably in the range of 3:10 to 20:10 (mass ratio), more preferably in the range of 5:10 to 12:10 (mass ratio).

Examples of the solvent for use in the coating solution for a charge transport layer include ketone solvents, ester solvents, ether solvents and aromatic hydrocarbon solvents. These solvents may be used alone or may be used as a mixture of two or more types thereof. Among these solvents, an ether solvent or an aromatic hydrocarbon solvent can be used from the viewpoint of resin solubility.

The film thickness of the charge transport layer is preferably 5 μm or larger and 50 μm or smaller, more preferably 10 μm or larger and 35 μm or smaller.

Each layer of the electrophotographic photosensitive member can be supplemented with various additives. Examples of the additives include: antidegradants such as antioxidants, ultraviolet absorbers and light stabilizers; and particles such as organic particles and inorganic particles. Examples of the antidegradants include hindered phenol antioxidants, hindered amine light stabilizers, sulfur atom containing antioxidants and phosphor atom containing antioxidants. Examples of the organic particles include polymer resin particles such as polystyrene resin particles and polyethylene resin particles. Examples of the inorganic particles include metal oxide particles such an silica and alumina. Furthermore, a leveling agent such as silicone oil may also be added thereto, if necessary.

A coating method such as a dip coating method, a spray coating method, a spinner coating method, a roller coating method, a Meyer bar coating method or a blade coating method can be used for applying the coating solution for each layer.

<Image Forming Method>

The image forming method of the present invention has:
charging an electrophotographic photosensitive member by contact with the electrophotographic photosensitive member; developing the electrophotographic photosensitive member with toner to form a toner image; transferring the toner image on the electrophotographic photosensitive member to a transfer medium; and cleaning off the toner on the electrophotographic photosensitive member by contact of a blade with the electrophotographic photosensitive member, wherein the aforementioned <Electrophotographic photosensitive member> is used as the electrophotographic photosensitive member, and the aforementioned <Toner> is used as the toner.

The image forming method of the present invention will be further described by taking an electrophotographic apparatus as one example of an image forming apparatus to which the image forming method of the present invention is applicable.

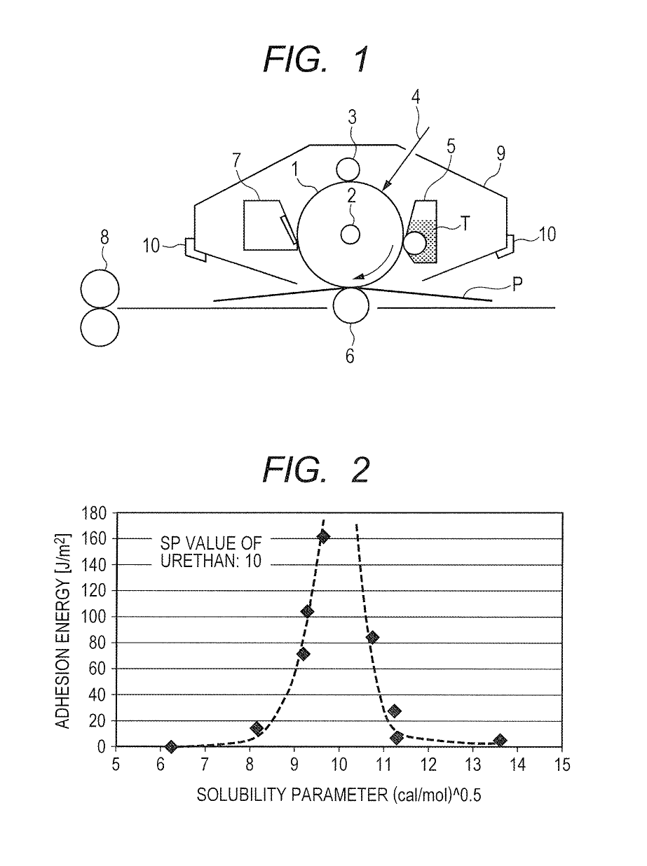

FIG. 1 shows one example of a schematic configuration of the electrophotographic apparatus equipped with a process cartridge having the electrophotographic photosensitive member and the toner.

In FIG. 1, an electrophotographic photosensitive member 1 is in a cylindrical form and is rotationally driven around an axis 2 at a predetermined peripheral speed in a direction indicated by the arrow. The surface of the rotationally driven electrophotographic photosensitive member 1 is uniformly charged at a predetermined positive or negative potential by a charging unit (primary charging unit: charging roller, etc.) 3 contacted with the electrophotographic photosensitive member 1 in the course of rotation (charging step). Subsequently, the surface of the electrophotographic photosensitive member 1 receives an exposing light (image exposing light) 4 output from an exposing unit (not shown) such as slit exposure or laser beam scanning exposure. In this way, electrostatic latent images corresponding to an image of interest are sequentially formed on the surface of the electrophotographic photosensitive member 1 (electrostatic latent image formation step).

The electrostatic latent images formed on the surface of the electrophotographic photosensitive member 1 are developed with toner T contained in a developing unit 5 to form a toner images (development step). Subsequently, the formed toner images carried on the surface of the electrophotographic photosensitive member 1 are sequentially transferred to a transfer medium (paper sheet, etc.) P by transfer bias from a transfer unit (transfer roller, etc.) 6 (transfer step). The transfer medium P is taken out of a transfer medium supply unit (not shown) in synchronization with the rotation of the electrophotographic photosensitive member 1 and sent to between the electrophotographic photosensitive member 1 and the transfer unit 6 (contact part).

The transfer medium P that has received the transferred toner images is separated from the surface of the electrophotographic photosensitive member 1 and introduced to a fixing unit 8. After image fixation, the resulting image-formed article (print or copy) is ejected from the apparatus.

The surface of the electrophotographic photosensitive member 1 after the toner image transfer is rubbed by a cleaning unit (cleaning blade, etc.) 7 for removal of transfer residue developing agents (transfer residue toner) to become clean surface (cleaning step). In the present invention, since the specific electrophotographic photosensitive member and the specific toner are used, poor cleaning can be prevented even at the early stage of application of a brand-new process cartridge or electrophotographic apparatus, and favorable image quality can be obtained.

After subsequent removal of electricity by a pre-exposing light (not shown) from a pre-exposing unit (not-shown), the apparatus is repetitively used in image formation. As illustrated in FIG. 1, when the charging unit 3 is a contact charging unit using a charging roller or the like, the pre-exposure is not necessarily required.

As mentioned above, an integral combination of the electrophotographic photosensitive member 1, the charging unit 3, the developing unit 5 and the cleaning unit 7 and other optional components housed in, for example, a container is the process cartridge of the present invention. This process cartridge is detachably attached to the main body of an electrophotographic apparatus such as a copier or a laser beam printer. In FIG. 1, the charging unit 3, the developing unit 5 and the cleaning unit 7 are integrally supported on the electrophotographic photosensitive member 1 to form a cartridge, which Is prepared into a process cartridge 9 that is detachably attached to the main body of an electrophotographic apparatus using a guide unit 10 such as a rail in the main body of the electrophotographic apparatus.

### EXAMPLES

Hereinafter, the present invention will be described in more detail with reference to specific Examples. However, the present invention is not intended to be limited by these Examples.

Production Examples of the resin C and the toner used in the present invention will be given below. However, the present invention is not intended to be limited by these Production Examples.

### Production Example 1 of Resin C

100 parts by mass of a mixture containing the raw material monomers, except for trimellitic anhydride, added in the amounts shown in Table 1, and 0.52 parts by mass of a catalyst tin di(2-ethylhexanoate) were placed in a 6 L four-neck flask equipped with a nitrogen inlet tube, a de-watering conduit, a stirrer and a thermocouple and reacted at 200° C. over 6 hours in a nitrogen atmosphere. Trimellitic anhydride was further added thereto at 210° C., and reaction was performed under reduced pressure of 40 kPa and continued until the weight-average molecular weight (Mw) became 12000. The obtained resin C was designated as resin C1.

### Production Examples 2 to 4 of Resin C

Each resin C was produced in the same way as in Production Example 1 of resin C except that the amounts of the acid components and the alcohol components added were changed as described in Table 1. The obtained resins C were designated as resins C2 to C4.

TABLE 1

| | | | Resin C1 | Resin C2 | Resin C3 | Resin C4 |
|---|---|---|---|---|---|---|
| Monomer | Acid | TPA | 45.00 | 45.20 | 45.20 | 45.20 |
| composition* | | IPA | 44.20 | 44.00 | 44.10 | 44.10 |
| (molar ratio) | | TMA | 1.30 | 1.30 | 1.30 | 1.30 |
| | Alcohol | BPA(PO) | 64.00 | 22.00 | 68.50 | 79.00 |
| | (total = 100) | BPA(EO) | 16.00 | 23.00 | 31.40 | 20.40 |
| | | Isosorbide | 20.00 | 55.00 | 0.10 | 0.60 |

| | | | | |
|---|---|---|---|---|
| Isosorbide unit mol % | 10.50 | 28.87 | 0.05 | 0.31 |
| Acid value of resin | 7.0 | 6.8 | 6.5 | 7.2 |

*Monomer composition is indicated by molar ratio when the total mole number of the alcohol components is defined as 100.
TPA: terephthalic acid
IPA: isophthalic acid
TMA: trimellitic acid
BPA(PO): adduct of bisphenol A with 3 mol propylene oxide
BPA(EO): adduct of bisphenol A with 2 mol ethylene oxide

### Production Example 1 of Toner

Toner 1 was produced according to the following procedures.

850 parts by mass of a 0.1 mol/L aqueous Na₃PO₄ solution were added into a container equipped with a high-speed stirring apparatus CLEARMIX (manufactured by M Technique Co., Ltd.) and heated to 60° C. after adjustment of the number of rotations to 15000 rpm. 68 parts by mass of a 1.0 mol/L aqueous CaCl₂ solution were added thereto to prepare an aqueous medium containing a very small particle of poorly water-soluble dispersant Ca₃(PO₄)₂.

The following materials were dissolved at 100 r/min using a propeller-driven stirring apparatus to prepare a solution

| | |
|---|---|
| Styrene | 75.0 parts by mass |
| Acrylic monomer (n-butyl acrylate) | 25.0 parts by mass |
| Resin C1 | 3.8 parts by mass |
| Next, the following materials were added to the | |
| solution. | |
| C.I. Pigment Blue 15:3 | 6.5 parts by mass |
| Hydrocarbon wax | 9.0 parts by mass |
| (peak temperature of the largest endothermic peak: | |
| 77° C., HNP-51, manufactured by Nippon Seiro | |
| Co., Ltd.) | |

Then, the mixed solution was heated to a temperature of 60° C. and then stirred, dissolved and dispersed at 9000 r/min using a TK homomixer (manufactured by PRIMIX Corp. (formerly Tokushu Kika Kogyo Co., Ltd.)).

10.0 parts by mass of a polymerization initiator 2,2′-azobis(2,4-dimethylvaleronitrile) were dissolved therein to prepare a polymerizable monomer composition. The polymerizable monomer composition was added into the aqueous medium and granulated at a temperature of 60° C. for 15 minutes while CLEARMIX was rotated at 15000 rpm.

Then, the resulting granules were transferred to a propeller-driven stirring apparatus, reacted at a temperature of 70° C. for 5 hours with stirring at 100 r/min. then heated to a temperature of 80° C., and further reacted for 5 hours to produce a toner particle. After the completion of the polymerization reaction, the slurry containing the particle was cooled and washed with water in 10 times the amount of the slurry. After filtration and drying, the particle size was adjusted by classification to obtain a toner particle.

100 parts by mass of the toner particle were mixed at 3000 r/min for 15 minutes in a Henschel mixer (manufactured by Nippon coke & Engineering. Co., Ltd. (formerly Hitsui Miike Machinery Co., Ltd.)) with 2.0 parts by mass of a hydrophobic fine silica particle (number-average particle size of the primary particle: 10 nm, BET specific surface area: 170 m²/g) which had been treated with a flowability improver dimethylsilicone oil (20 mass %) and fractionally charged to the same polarity (negative polarity) as that of the toner particle, to obtain toner 1.

As a result of analyzing the surface composition of the toner 1 using TOF-SIMS, a fragment derived from the isosorbide unit was confirmed to exist thereon. Accordingly, the toner 1 was found to have a state where the isosorbide unit was exposed on the surface.

### Production Examples 2 and 3 of Toner

Each toner was produced in the same way as in Production Example 1 of toner except that the amount of resin C added and the type thereof were as described in Table 2 in Production Example 1 of toner. The obtained toners were designated as toner 2 and toner 3.

As a result of analyzing the surface composition of the toner 2 and the toner 3 using TOF-SIMS, a fragment derived from the isosorbide unit was confirmed to exist thereon. Accordingly, the toner 2 and the toner 3 were found to have a state where the isosorbide unit was exposed on the surface.

### Production Example 4 of Toner

Toner was produced by the dissolution suspension method according to the following procedures.

First, an aqueous medium and a solution were prepared according to the following procedures to prepare toner.

660 parts by mass of water and 25 parts by mass of an aqueous solution containing 48.5 mass % of sodium dodecyl diphenyl ether disulfonate were mixed and stirred, and stirred at 10000 r/min using a TK homomixer (manufactured by PRIMIX Corp.) to prepare an aqueous medium

The following materials were added to 500 parts by mass of ethyl acetate and dissolved therein at 100 r/min using a propeller-driven stirring apparatus to prepare a solution.

| | |
|---|---|
| Styrene-n-butyl acrylate copolymer | 100.0 parts by mass |
| (copolymerization mass ratio: styrene/n-butyl | |
| acrylate = 75/25, Mp = 17000) | |
| Resin C1 | 3.8 parts by mass |
| C.I. Pigment Blue 15:3 | 6.5 parts by mass |
| Hydrocarbon wax | 9.0 parts by mass |
| (peak temperature of the largest endothermic | |
| peak: 77° C., HNP-51, manufactured by Nippon | |
| Seiro Co., Ltd.) | |

Next, 150 parts by mass of the aqueous medium were placed in a container and stirred at the number of rotations of 12000 rpm using a TK homomixer (manufactured by PRIMIX Corp.). 100 parts by mass of the solution described above were added thereto, and the mixture was mixed for 10 minutes to prepare emulsion slurry.

Then, 100 parts by mass of the emulsion slurry were added to a flask loaded with a tube for deaeration, a stirrer and a thermometer. While the slurry was stirred at a peripheral speed of 20 m/min, the solvent was removed under reduced pressure at 30° C. for 12 hours, and the residue was aged at 45° C. for 4 hours to prepare solvent-free slurry. After filtration of the solvent-free slurry under reduced pressure, 300 parts by mass of ion-exchange water were added to the obtained filtration cake, which was then nixed and redispersed (at the number of rotation of 12000 rpm for 10 minutes) using a TK homomixer and then filtered. The obtained filtration cake was dried at 45° C. for 48 hours in a drier and sieved through a mesh having an opening of 75 μm to obtain a toner particle.

100 parts by mass of the toner particle were mixed at 3000 r/min for 15 minutes in a Henschel mixer (manufactured by Nippon Coke & Engineering. Co., Ltd.) with 2.0 parts by mass of a hydrophobic fine silica particle (number-average particle size of the primary particle: 10 nm, BET specific surface area: 170 m²/g) which had been created with a flowability improver dimethylsilicone oil (20 mass %) and frictionally charged to the same polarity (negative polarity) an that of the toner particle, to obtain toner 4.

As a result of analyzing the surface composition of the toner 4 using TOF-SIMS, a fragment derived from the isosorbide unit was confirmed to exist thereon. Accordingly, the toner 4 was found to have a state where the isosorbide unit was exposed on the surface.

### Production Example 5 of Toner

Toner was produced by the pulverization method according to the following procedures

| | |
|---|---|
| Resin C1 | 100.0 parts by mass |
| C.I. Pigment Blue 15:3 | 5.0 parts by mass |
| Fischer-Tropsch wax | 5.0 parts by mass |
| (peak temperature of the largest endothermic | |
| peak: 105° C.) | |
| Aluminum 3,5-di-t-butylsalicylate compound | 0.5 parts by mass |

These materials were mixed using a Henschel mixer (model FM-75, manufactured by Nippon Coke & Engineering. Co., Ltd.) and then kneaded using a twin screw kneading machine (model PCM 30, manufactured by Ikegai Corp. (formerly Ikegai Iron Works)) under conditions involving the number of rotations of 3.3 s⁻¹ and a kneaded resin temperature of 110° C.

The obtained kneading product was cooled and roughly pulverized into 1 mm or smaller using a hammer mill to obtain a crude powder. The obtained crude powder was finely pulverized using a mechanical pulverizer (T-250, manufactured by Freund-Turbo Corp. (formerly Turbo Kogyo Co., Ltd.)). The obtained fine powder was further classified using a multi-fractional classifier based on the Coanda effect to obtain a toner particle having a weight-average particle size of 7.0 μm and negative frictional charging properties.

1.0 part by mass of a fine titanium oxide particle (primary average particle size: 50 nm) surface-treated with 15 mass % of isobutyltrimethoxysilane and 0.8 parts by mass of a hydrophobic fine silica particle (primary average particle size: 16 nm) surface-treated with 20 mass % of hexamethyldisilazane were added to 100 parts by mass of the obtained toner particle, and these particles were nixed using a Henschel mixer (model FM-75, manufactured by Nippon Coke & Engineering. Co., Ltd.) to obtain toner 5.

As a result of analyzing the surface composition of the toner 5 using TOF-SIMS, a fragment derived from the isosorbide unit was confirmed to exist thereon. Accordingly, the toner 5 was found to have a state where the isosorbide unit was exposed on the surface.

### Production Example 6 of Toner

Toner was produced in the same way as in Production Example 1 of toner except that, in Production Example 1 of toner, the acrylic monomer was not used, and the amount of resin C added and the type thereof were as described in Table 2. The obtained toner wan designated as toner 6.

As a result of analyzing the surface composition of the toner 6 using TOP-SIMS, a fragment derived from the isosorbide unit was confirmed to exist thereon. Accordingly, the toner 6 was found to have a state where the isosorbide unit was exposed on the surface.

### Production Example 7 of Toner

Toner was produced in the same way as in Production Example 1 of toner except that the amount of resin C added and the type thereof were as described in Table 2 in Production Example 1 of toner. The obtained toner was designated as toner 7.

As a result of analyzing the surface composition of the toner 7 using TOF-SIMS, a fragment derived from the isosorbide unit was confirmed to exist thereon. Accordingly, the toner 7 was found to have a state where the isosorbide unit was exposed on the surface.

### Production Example 1 of Comparative Toner

Toner was produced in the same way as in Production Example 1 of toner except that the resin C1 was not added in Production Example of toner 1. The obtained toner was designated as comparative toner 1.

As a result of analyzing the surface composition of the comparative toner a using TOP-SIMS, a fragment derived from the isosorbide unit was absent.

TABLE 2

| | | Acrylic | | Amount |
|---|---|---|---|---|
| | Styrene | monomer | | of resin C |
| | (part by | (part by | Type of | added |
| | mass) | mass) | resin C | (part by mass) |
| Production Example 1 | 75.0 | 25.0 | Resin C1 | 3.8 |
| of toner | | | | |
| Production Example 2 | 50.3 | 16.8 | Resin C2 | 33.0 |
| of toner | | | | |
| Production Example 3 | 75.0 | 25.0 | Resin C3 | 1.5 |
| of toner | | | | |
| Production Example 6 | 100.0 | 0.0 | Resin C1 | 4.0 |
| of toner | | | | |
| Production Example 7 | 75.0 | 25.0 | Resin C4 | 1.6 |
| of toner | | | | |
| Production Example 1 | 75.0 | 25.0 | — | — |
| of comparative toner | | | | |

The resin C (type and content) contained in each toner and the resin (type and content) other than the resin C as well as the toner production method is shown in Table 3 as to the toners 1 to 7 and the comparative toner 1.

TABLE 3

| | | | Resin other than resin C | | |
|---|---|---|---|---|---|
| | | Content | | Content | |
| | Resin C | (part by | | (part by | Toner production |
| Toner | Type | mass) | Type | mass) | method |
| Toner 1 | Resin C1 | 3.7 | Styrene-butyl acrylate resin | 96.3 | Suspension |
| | | | | | polymerization |
| | | | | | method |
| Toner 2 | Resin C2 | 33.0 | Styrene-butyl acrylate resin | 67.0 | Suspension |
| | | | | | polymerization |
| | | | | | method |
| Toner 3 | Resin C3 | 1.5 | Styrene-butyl acrylate resin | 98.5 | Suspension |
| | | | | | polymerization |
| | | | | | method |
| Toner 4 | Resin C1 | 3.7 | Styrene-butyl acrylate resin | 96.3 | Dissolution |
| | | | | | suspension |
| | | | | | method |
| Toner 5 | Resin C1 | 100.0 | — | — | Pulverization |
| | | | | | method |
| Toner 6 | Resin C1 | 3.8 | Polystyrene resin | 96.2 | Suspension |
| | | | | | polymerization |
| | | | | | method |
| Toner 7 | Resin C4 | 1.6 | Styrene-butyl acrylate resin | 98.4 | Suspension |
| | | | | | polymerization |
| | | | | | method |
| Comparative | — | — | Styrene-butyl acrylate resin | 100.0 | Suspension |
| toner 1 | | | | | polymerization |
| | | | | | method |

Next, Synthesis Examples of polyarylate resin A and polycarbonate resin B will be shown below. However, the present invention is not intended to be limited by these Synthesis Examples.

### Synthesis Example A1

3.3 9 of isophthalic acid chloride and 3.3 g of terephthalic acid chloride were dissolved in dichloromethane to prepare an acid halide solution. Aside from the acid halide solution, 4.2 g of a siloxane derivative represented by the formula (a-1) given below, 6.8 g of a diol represented by the formula (a-2) given below and 3.6 g of a diol represented by the formula (a-3) given below were dissolved in a 10% aqueous sodiun hydroxide solution. A polymerization catalyst tributyl benzyl ammonium chloride wan added thereto, and the mixture was stirred to prepare a diol compound solution.

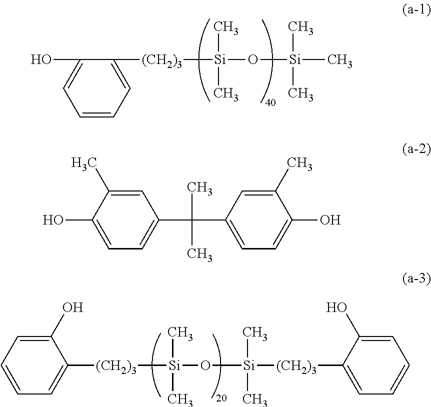

Next, the acid halide solution was added to the diol compound solution with stirring to start polymerization. The polymerization reaction was performed for 3 hours with stirring with the reaction temperature kept at 25° C. or lower. Then, the polymerization reaction was terminated by the addition of acetic acid, and washing with water was repeated until the aqueous phase became neutral. Subsequently, this liquid phase was added dropwise to methanol, and the precipitates were filtered and dried to obtain a white polymer (resin A1).

The obtained resin A1 had a viscosity-average molecular weight of 21,000. The viscosity-average molecular weight was calculated as follows: 0.5 g of the sample was dissolved in 100 ml of dichloromethane, and the specific viscosity of the solution was measured at 25° C. using an Ubbelohde viscometer. The intrinsic viscosity was determined from the specific viscosity. The viscosity-average molecular weight was calculated according to the Mark-Houwink equation of viscosity wherein K (proportional constant moiety) and a (index moiety; also indicated by α) were set to 1.23×10⁻⁴ and 0.83, respectively.

The content of a moiety corresponding to the structure represented by the formula (1) contained in the resin A1 was analyzed by the approach described above and was consequently 20 mass %.

### Synthesis Examples A2 to A8

Resins A2 to A8 were synthesized according to the synthesis method described in Synthesis Example A1 using raw materials appropriate for the structures described in Table A. The viscosity average molecular weights of the resins A2 to A8 were controlled by adjusting the time from the start of polymerization to the completion of the polymerization.

The configurations and viscosity-average molecular weights of the resins A1 to A8 are shown in Table 4.

TABLE 4

| | | | | | | Viscosity- |
|---|---|---|---|---|---|---|
| | | | | | | average |
| | | Content of | | | n in | molecular |
| | Formula (2) | formula (1) | Formula (9) | Formula (10) | formula (10) | weight |
| Resin A1 | (2-1) | 20% | (9-1)/(9-2) = 5/5 | (10-1)/(10-2) = 5/5 | 20 | 21,000 |
| Resin A2 | (2-1) | 30% | (9-1)/(9-2) = 5/5 | (10-1)/(10-2) = 5/5 | 40 | 20,000 |
| Resin A3 | (2-2) | 10% | (9-1)/(9-2) = 5/5 | (10-1)/(10-2) = 5/5 | 80 | 25,000 |
| Resin A4 | (2-1) | 30% | (9-1)/(9-2) = 5/5 | — | — | 18,000 |
| Resin A5 | (2-4) | 20% | (9-3) | (10-3) | 40 | 45,000 |
| Resin A6 | (2-5) | 20% | (9-4)/(9-5) = 5/5 | (10-1)/(10-2) = 5/5 | 40 | 30,000 |
| Resin A7 | (2-7) | 20% | (9-1)/(9-2) = 5/5 | (10-1)/(10-2) = 5/5 | 40 | 25,000 |
| Resin A8 | (2-13) | 50% | (9-7)/(9-8) = 5/5 | (10-1)/(10-2) = 5/5 | 40 | 27,000 |

In Table 4, “Formula (2)” represents a structure represented by the formula (2). In Table 4, “Content of formula (1)” means the content (mass %) of the structure represented by the formula (1) contained in the resin. In Table 4, “Formula (9)” represents a structural unit represented by the formula (9). In the case of using the structural unit represented by the formula (9) as a mixture, the types and mixing ratios (by mass) of structural units are shown. In Table 4, “Formula (10)” represents a structural unit represented by the formula (10). In the case of using the structural unit represented by the formula (10) as a mixture, the types and mixing ratios (by mass) of structural units are shown. In Table 4, “n in formula (10)” means the average value of n which represents the number of repeats of the structure in parentheses in the structural unit represented by the formula (10).

### Synthesis Example B1

12.0 g of a diol represented by the formula (b-1) given below was dissolved in a 2 0% aqueous sodium hydroxide solution. Dichloromethane was added to this solution, and the mixture was stirred. 15 g of phosgene was blown into the reaction solution over 1 hour with the solution temperature kept at 10° C. or higher and 15° C. or lower. When approximately 70% of the phosgene was blown therein, 4.2 g of a siloxane derivative represented by the formula (a-1) and 4.0 g of a diol represented by the formula (a-3) were added to the solution. After the completion of the phosgene introduction, the reaction solution was emulsified by vigorous stirring. Triethylamine was added thereto, and the mixture was stirred for 1 hour. Then, the dichloromethane phase was neutralized with phosphoric acid, and washing with water was further repeated until the pH became approximately 7. Subsequently, this liquid phase was added dropwise to isopropanol, and the precipitates were filtered and dried to obtain a white polymer (resin B1).

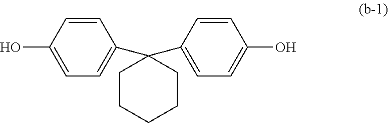 [SMILES: Oc1ccc(C2(c3ccc(O)cc3)CCCCC2)cc1]

The obtained resin B1 had a viscosity-average molecular weight of 18,000. The content of a moiety corresponding to the structure represented by the formula (1) contained in the resin B1 was 10 mass %.

### Synthesis Examples B2 to B9

Resins B2 to B9 were synthesized according to the synthesis method described in Synthesis Example B1 using raw materials appropriate for the structures described in Table 5. The viscosity-average molecular weights of the resins B2 to B9 were controlled by adjusting the time from the start of polymerization to the completion of the polymerization.

The configurations and viscosity-average molecular weights of the resins B1 to B9 are shown in Table 5.

TABLE 5

| | | | | | | Viscosity- |
|---|---|---|---|---|---|---|
| | | | | | | average |
| | | Content of | | | n in | molecular |
| | Formula (2) | formula (1) | Formula (11) | Formula (12) | formula (12) | weight |
| Resin B1 | (2-1) | 10% | (11-1) | (12-1) | 20 | 18,000 |
| Resin B2 | (2-1) | 30% | (11-1) | (12-1) | 40 | 20,000 |
| Resin B3 | (2-1) | 10% | (11-1)/(11-15) = 8/2 | (12-1) | 40 | 30,000 |
| Resin B4 | (2-2) | 20% | (11-1) | (12-4) | 20 | 25,000 |
| Resin B5 | (2-1) | 45% | (11-1) | — | — | 15,000 |
| Resin B6 | (2-4) | 10% | (11-1) | (12-1) | 40 | 30,000 |
| Resin B7 | (2-5) | 30% | (11-1) | (12-1) | 80 | 21,000 |
| Resin B8 | (2-7) | 10% | (11-1) | (12-1) | 40 | 21,000 |
| Resin B9 | (2-13) | 20% | (11-1) | (12-3) | 60 | 20,000 |

In Table 5, “Formula (2)” represents a structure represented by the formula (2). In Table 5, “Content of formula (1)” means the content (mass %) of the structure represented by the formula (1) contained in the resin. In Table 5, “Formula (11)” represents a structural unit represented by the formula (11). In the case of using the structural unit represented by the formula (11) as a mixture, the types and mixing ratios (by mass) of structural units are shown. In Table 5, “Formula (12)” represents a structural unit represented by the formula (12). In Table 5. “n in formula (12)” means the average value of n which represents the number of repeats of the structure in parentheses in the structural unit represented by the formula (12).

### Synthesis Example A9

Resin A9 having the structure shown in Table 6 was synthesized according to the method of Synthesis Example A1 using a siloxane derivative represented by the formula (a-4) given below and a diol represented by the formula (a-2). The obtained resin A9 had a viscosity-average molecular weight of 22,000. The content of a moiety corresponding to the structure represented by the formula (1) contained in the resin A9 was 20 mass %.

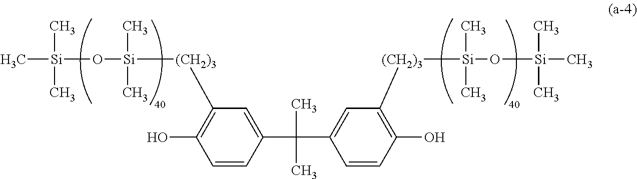

The siloxane derivative represented by the formula (a-4) is a compound that can be obtained, for example, by the hydrosilylation reaction between bisphenol having a carbon-carbon double bond on a side chain and polysiloxane having a Si—H structure at one end.

### Synthesis Examples A10 to A14

Resins A10 to A14 were synthesized according to the synthesis method described in Synthesis Example A1 using raw materials appropriate for the structures described in Table 6. The viscosity-average molecular weights of the resins A10 to A14 were controlled by adjusting the time from the start of polymerization to the completion of the polymerization.

The configurations and viscosity-average molecular weights of the resins A9 to A14 are shown in Table 6.

TABLE 6

| | | | | | | | Viscosity- |
|---|---|---|---|---|---|---|---|
| | | | | | | | average |
| | | | Content of | | | n in | molecular |
| | Formula (3) | Formula (3-A) | formula (1) | Formula (9) | Formula (10) | formula (10) | weight |
| Resin A9 | (3-1)/(3-2) = 5/5 | (3-A-1) | 20% | (9-1)/(9-2) = 5/5 | — | — | 22,000 |
| Resin A10 | (3-1)/(3-2) = 5/5 | (3-A-5) | 10% | (9-1)/(9-2) = 5/5 | — | — | 16,000 |
| Resin A11 | (3-3) | (3-A-1) | 40% | (9-3) | — | — | 25,000 |
| Resin A12 | (3-4)/(3-5) = 5/5 | (3-A-1) | 20% | (9-4)/(9-5) = 5/5 | — | — | 40,000 |
| Resin A13 | (3-11) | (3-A-7) | 5% | (9-3) | — | — | 21,000 |
| Resin A14 | (3-1)/(3-2) = 5/5 | (3-A-1) | 20% | (9-1)/(9-2) = 5/5 | (10-1)/(10-2) = 5/5 | 40 | 18,000 |

In Table 6, “Formula (3)” represents a structural unit represented by the formula (3). In the case of using the structural unit represented by the formula (3) as a mixture, the types and mixing ratios (by mass) of structural units are shown. In Table 6, “Formula (3-A)” represents a structure represented by the formula (3-A). In Table 6. “Content of formula (1)” means the content (mass %) of the structure represented by the formula (1) contained in the resin. In Table 6, “Formula (9)” represents a structural unit represented by the formula (9). In the case of using the structural unit represented by the formula (9) as a mixture, the types and mixing ratios (by mass) of structural units are shown. In Table 6, “Formula (10)” represents a structural unit represented by the formula (10). In the case of using the structural unit represented by the formula (10) as a mixture, the types and mixing ratios (by mass) of structural units are shown. In Table 6, “n in formula (10)” means the average value of n which represents the number of repeats of the structure in parentheses in the structural unit represented by the formula (10).

### Synthesis Example B10

Resin B10 having the structure shown in Table 7 was synthesized according to the method of Synthesis Example B1 using a siloxane derivative represented by the formula (a-4) and a diol represented by the formula (b-1). The obtained resin B10 had a viscosity average molecular weight of 19,000. The content of a moiety corresponding to the structure represented by the formula (1) contained in the resin B10 was 20 mass %.

### Synthesis Examples B11 to B16

Resins B11 to B16 were synthesized according to the synthesis method described in Synthesis Example B1 using raw materials appropriate for the structures described in Table 7. The viscosity-average molecular weights of the resins B11 to B16 were controlled by adjusting the time from the start of polymerization to the completion of the polymerization.

The configurations and viscosity-average molecular weights of the resins B10 to B16 are shown in Table 7.

TABLE 7

| | | | Content of | | | n in | Viscosity-average |
|---|---|---|---|---|---|---|---|
| | Formula (6) | Formula (6-A) | formula (1) | Formula (11) | Formula (12) | formula (12) | molecular weight |
| Resin B10 | (6-1) | (3-A-1) | 20% | (11-1) | — | — | 19,000 |
| Resin B11 | (6-3) | (3-A-1) | 5% | (11-3) | — | — | 23,000 |
| Resin B12 | (6-5) | (3-A-1) | 40% | (11-1) | — | — | 18,000 |
| Resin B13 | (6-8) | (3-A-7) | 15% | (11-1) | — | — | 30,000 |
| Resin B14 | (6-1) | (3-A-5) | 50% | (11-3)/(11-16) = 5/5 | — | — | 20,000 |
| Resin B15 | (6-1) | (3-A-1) | 20% | (11-1)/(11-15) = 8/2 | — | — | 30,000 |
| Resin B16 | (6-1) | (3-A-1) | 20% | (11-1) | (12-1) | 40 | 21,000 |

In Table 7, “Formula (6)” represents a structural unit represented by the formula (6). In Table 7, “Formula (6-A)” represents a structure represented by the formula (6 A). In Table 7, “Content of formula (1)” means the content (mass %) of the structure represented by the formula (1) contained in the resin. In Table 7, “Formula (11)” represents a structural unit represented by the formula (11). In the case of using the structural unit represented by the formula (11) as a mixture, the types and mixing ratios (by mass) of structural units are shown. In Table 7, “Formula (12)” represents a structural unit represented by the formula (12). In Table 7, “n in formula (12)” means the average value of n which represents the number of repeats of the structure in parentheses in the structural unit represented by the formula (12).

### Synthesis Example A15

Resin A15 having the structure shown in Table 8 was synthesized according to the method of Synthesis Example A1 using a siloxane derivative represented by the formula (a-5) given below and a diol represented by the formula (a-2). The obtained resin A15 had a viscosity-average molecular weight of 23,000. The content of a moiety corresponding to the structure represented by the formula (1) contained in the resin A15 was 20 mass %.

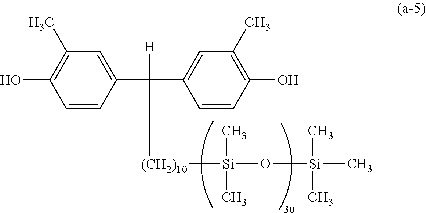

The siloxane derivative represented by the formula (a-5) is a compound that can be obtained, for example, by the hydrosilylation reaction between bisphenol having a carbon-carbon double bond on a substituent of the central skeleton and polysiloxane having a Si—H structure at one end.

### Synthesis Examples A16 to A21

Resins A16 to A21 were synthesized according to the synthesis method described in Synthesis Example A1 using raw materials appropriate for the structures described in Tables 8 and 9. The viscosity-average molecular weights of the resins A16 to A21 were controlled by adjusting the time from the start of polymerization to the completion of the polymerization.

The configurations and viscosity-average molecular weights of the resins A15 to A21 are shown in Tables 8 and 9.

TABLE 8

| | | Formula (4-A) | | | | | Content of | | | n in | Viscosity-average |
|---|---|---|---|---|---|---|---|---|---|---|---|
| | Formula (4) | R⁴¹¹, R⁴¹² | R⁴¹³, R⁴¹⁴ | Z | m | n | formula (1) | Formula (9) | Formula (10) | formula (10) | molecular weight |
| Resin A15 | (4-1)/(4-2) = | Methyl | Methyl | Methyl | 10 | 30 | 20% | (9-1)/(9-2) = | — | — | 23,000 |
| | 5/5 | group | group | group | | | | 5/5 | | | |
| Resin A16 | (4-3) | Methyl | Methyl | t-Butyl | 10 | 30 | 10% | (9-3) | — | — | 20,000 |
| | | group | group | group | | | | | | | |
| Resin A17 | (4-1)/(4-2) = | Methyl | Methyl | Methyl | 3 | 30 | 40% | (9-1)/(9-2) = | — | — | 18,000 |
| | 5/5 | group | group | group | | | | 5/5 | | | |
| Resin A18 | (4-4)/(4-5) = | Methyl | Methyl | Methyl | 10 | 30 | 20% | (9-4)/(9-5) = | — | — | 23,000 |
| | 5/5 | group | group | group | | | | 5/5 | | | |
| Resin A19 | (4-1)/(4-2) = | Methyl | Methyl | Methyl | 10 | 80 | 5% | (9-1)/(9-2) = | — | — | 46,000 |
| | 5/5 | group | group | group | | | | 5/5 | | | |
| Resin A20 | (4-1)/(4-2) = | Methyl | Methyl | Methyl | 10 | 30 | 20% | (9-1)/(9-2) = | (10-1)/(10-2) = | 40 | 20,000 |
| | 5/5 | group | group | group | | | | 5/5 | 5/5 | | |

TABLE 9

| | | Formula (4-B) | | | | | Content of | | Viscosity-average |
|---|---|---|---|---|---|---|---|---|---|
| | Formula (4) | R⁴²¹-R⁴²⁸ | Z¹, Z² | m | n¹ | n² | formula (1) | Formula (9) | molecular weight |
| Resin A21 | (4-1)/(4-2) = | Methyl | Methyl | 10 | 15 | 15 | 20% | (9-1)/(9-2) = | 32,000 |
| | 5/5 | group | group | | | | | 5/5 | |

In Tables 6 and 9. “Formula (4)” represents a structural unit represented by the formula (4). In the case of using the structural unit represented by the formula (4) as a mixture, the types and mixing ratios (by mass) of structural units are shown. In Table 8, “Formula (4-A)” represents a structure represented by the formula (4-A). In Table 9, “Formula (4-B)” represents a structure represented by the formula (4-B). In Tables 8 and 9, “Content of formula (1)” means the content (mass %) of the structure represented by the formula (1) contained in the resin. In Tables 8 and 9, “Formula (9)” represents a structural unit represented by the formula (9). In the case of using the structural unit represented by the formula (9) as a mixture, the types and mixing ratios (by mass) of structural units are shown. In Table 8, “Formula (10)” represents a structural unit represented by the formula (10). In the case of using the structural unit represented by the formula (10) as a mixture, the types and mixing ratios (by mass) of structural units are shown. In Table 8, “n in formula (10)” means the average value of n which represents the number of repeats of the structure in parentheses in the structural unit represented by the formula (10).

### Synthesis Example B17

Resin B17 having the structure shown in Table 10 was synthesized according to the method of Synthesis Example B1 using a siloxane derivative represented by the formula (a-5) and a diol represented by the formula (b-1). The obtained resin B17 had a viscosity-average molecular weight of 18,000. The content of a moiety corresponding to the structure represented by the formula (1) contained In the resin B17 was 20 mass %.

### Synthesis Examples B18 to B22

Resins B18 to B22 were synthesized according to the synthesis method described in Synthesis Example B1 using raw materials appropriate for the structures described in Tables 10 and 11. The viscosity-average molecular weights of the resins B18 to B22 were controlled by adjusting the time from the start of polymerization to the completion of the polymerization.

The configurations and viscosity average molecular weights of the resins B17 to B22 are shown in Tables 10 and 11.

TABLE 10

| | | Formula (7-A) | | | | | Content of | | | n in | Viscosity-average |
|---|---|---|---|---|---|---|---|---|---|---|---|
| | Formula (7) | R⁷¹¹, R⁷¹² | R⁷¹³, R⁷¹⁴ | Z | m | n | formula (1) | Formula (11) | Formula (12) | formula (12) | molecular weight |
| Resin B17 | (7-1) | Methyl | Methyl | Methyl | 10 | 30 | 20% | (11-1) | — | — | 18,000 |
| | | group | group | group | | | | | | | |
| Resin B18 | (7-1) | Methyl | Methyl | t-Butyl | 10 | 30 | 45% | (11-1) | — | — | 15,000 |
| | | group | group | group | | | | | | | |
| Resin B19 | (7-2) | Methyl | Methyl | Methyl | 10 | 30 | 5% | (11-3)/(11-16) = | — | — | 22,000 |
| | | group | group | group | | | | 5/5 | | | |
| Resin B20 | (7-1) | Methyl | Methyl | Methyl | 10 | 30 | 20% | (11-1) | (12-1) | 40 | 27,000 |
| | | group | group | group | | | | | | | |
| Resin B21 | (7-1) | Methyl | Methyl | Methyl | 10 | 30 | 20% | (11-1)/(11-15) = | — | — | 31,000 |
| | | group | group | group | | | | 8/2 | | | |

TABLE 11

| | | Formula (7-B) | | | | | Content of | | Viscosity-average |
|---|---|---|---|---|---|---|---|---|---|
| | Formula (7) | R⁷²¹-R⁷²⁸ | Z¹, Z² | m | n¹ | n² | formula (1) | Formula (11) | molecular weight |
| Resin B22 | (7-1) | Methyl | Methyl | 10 | 15 | 15 | 20% | (11-1) | 20,000 |
| | | group | group | | | | | | |

In Tables 10 and 11, “Formula (7)” represents a structural unit represented by the formula (7). In Table 10, “Formula (7-A)” represents a structure represented by the formula (7-A). In Table 11, “Formula (7-B)” represents a structure represented by the formula (7-B). In Tables 10 and 11, “Content of formula (1)” means the content (mass %) of the structure represented by the formula (1) contained in the resin. In Tables 10 and 11, “Formula (11)” represents a structural unit represented by the formula (11). In the case of using the structural unit represented by the formula (11) as a mixture, the types and mixing ratios (by mass) of structural units are shown. In Table 10, “Formula (12)” represents a structural unit represented by the formula (12). In Table 10, “n in formula (12)” means the average value of n which represents the number of repeats of the structure in parentheses in the structural unit represented by the formula (12).

### Synthesis Example A22

Resin A22 having the structure shown in Table 12 was synthesized according to the method of Synthesis Example A1 using a siloxane derivative represented by the formula (a-6) given below and a diol represented by the formula (a-2). The obtained resin A22 had a viscosity-average molecular weight of 40,000. The content of a moiety corresponding to the structure represented by the formula (1) contained in the resin A22 was 20 mass %.

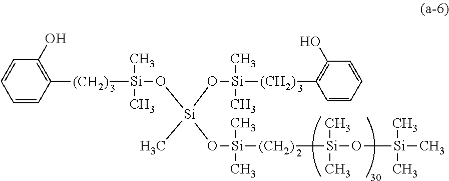

### Synthesis Examples A23 to A26

Resins A23 to A26 were synthesized according to the synthesis method described in Synthesis Example A1 using raw materials appropriate for the structures described in Table 12. The viscosity-average molecular weights of the resins A23 to A26 were controlled by adjusting the time from the start of polymerization to the completion of the polymerization.

The configurations and viscosity-average molecular weights of the resins A22 to A26 are shown in Table 12.

TABLE 12

| | | Formula (5-A) | | | | | Content of | | | n in | Viscosity-average |
|---|---|---|---|---|---|---|---|---|---|---|---|
| | Formula (5) | R⁵¹¹-R⁵²⁰ | Z | n | k | l | formula (1) | Formula (9) | Formula (10) | formula (10) | molecular weight |
| Resin A22 | (5-1)/(5-2) = | Methyl | Methyl | 30 | 1 | 1 | 20% | (9-1)/(9-2) = | — | — | 40,000 |
| | 5/5 | group | group | | | | | 5/5 | | | |
| Resin A23 | (5-3) | Methyl | Methyl | 30 | 1 | 1 | 5% | (9-3) | — | — | 45,000 |
| | | group | group | | | | | | | | |
| Resin A24 | (5-1)/(5-2) = | Methyl | Methyl | 150 | 1 | 1 | 10% | (9-4)/(9-5) = | — | — | 43,000 |
| | 5/5 | group | group | | | | | 5/5 | | | |
| Resin A25 | (5-3) | Methyl | t-Butyl | 30 | 1 | 1 | 1% | (9-9) | — | — | 32,000 |
| | | group | group | | | | | | | | |
| Resin A26 | (5-1)/(5-2) = | Methyl | Methyl | 30 | 1 | 1 | 5% | (9-1)/(9-2) = | (10-1)/(10-2) = | 40 | 23,000 |
| | 5/5 | group | group | | | | | 5/5 | 5/5 | | |

In Table 12, “Formula (5)” represents a structural unit represented by the formula (5). In the case of using the structural unit represented by the formula (5) as a mixture, the types and mixing ratios (by mass) of structural units are shown. In Table 12, “Formula (5-A)” represents a structure represented by the formula (5-A). In Table 12, “Content of formula (1)” means the content (mass %) of the structure represented by the formula (1) contained in the resin. In Table 12, “Formula (9)” represents a structural unit represented by the formula (9) In the case of using the structural unit represented by the formula (9) as a mixture, the types and mixing ratios (by mass) of structural units are shown. In Table 12, “Formula (10)” represents a structural unit represented by the formula (10). In the case of using the structural unit represented by the formula (10) as a mixture, the types and mixing ratios (by mass) of structural units are shown. In Table 12, “n in formula (10)” means the average value of n which represents the number of repeats of the structure in parentheses in the structural unit represented by the formula (10).

### Synthesis Example B23

Resin B23 having the structure shown in Table 13 was synthesized according to the method of Synthesis Example B1 using a siloxane derivative represented by the formula (a-6) and a diol represented by the formula (b-1). The obtained resin B23 had a viscosity-average molecular weight of 31,000. The content of a moiety corresponding to the structure represented by the formula (1) contained in the resin B23 was 20 mass %.

### Synthesis Examples B24 to B31

Resins B24 to B31 were synthesized according to the synthesis method described in Synthesis Example B1 using raw materials appropriate for the structures described in Table 13. The viscosity-average molecular weights of the resins B24 to B31 were controlled by adjusting the time from the start of polymerization to the completion of the polymerization.

The configurations and viscosity-average molecular weights of the resins B23 to B31 are shown in Table 13.

TABLE 13

| | | Formula (8-A) | | | | | Content of | | | n in | Viscosity-average |
|---|---|---|---|---|---|---|---|---|---|---|---|
| | Formula (8) | R⁸¹¹-R⁸²⁰ | Z | n | k | l | formula (1) | Formula (11) | Formula (12) | formula (12) | molecular weight |
| Resin B23 | (8-1) | Methyl | Methyl | 30 | 1 | 1 | 20% | (11-1) | — | — | 31,000 |
| | | group | group | | | | | | | | |
| Resin B24 | (8-1) | Methyl | t-Butyl | 30 | 1 | 1 | 35% | (11-2)/(11-15) = | — | — | 45,000 |
| | | group | group | | | | | 9/1 | | | |
| Resin B25 | (8-1) | Methyl | Methyl | 30 | 1 | 1 | 10% | (11-1) | (12-1) | 40 | 35,000 |
| | | group | group | | | | | | | | |
| Resin B26 | (8-1) | Methyl | t-Butyl | 75 | 1 | 1 | 15% | (11-1)/(11-2) = | — | — | 32,000 |
| | | group | group | | | | | 8/2 | | | |
| Resin B27 | (8-1) | Methyl | Methyl | 30 | 1 | 1 | 5% | (11-2)/(11-15) = | — | — | 50,000 |
| | | group | group | | | | | 9/1 | | | |
| Resin B28 | (8-1) | Methyl | Methyl | 30 | 1 | 1 | 1% | (11-2)/(11-15) = | — | — | 45,000 |
| | | group | group | | | | | 8/2 | | | |
| Resin B29 | (8-1) | Methyl | Methyl | 30 | 1 | 1 | 1% | (11-1) | — | — | 31,000 |
| | | group | group | | | | | | | | |
| Resin B30 | (8-1) | Methyl | Methyl | 30 | 1 | 1 | 10% | (11-1)/(11-15) = | — | — | 33,000 |
| | | group | group | | | | | 8/2 | | | |
| Resin B31 | (8-1) | Methyl | Methyl | 30 | 1 | 1 | 20% | (11-2)/(11-13) = | — | — | 32,000 |
| | | group | group | | | | | 1/9 | | | |

In Table 13, “Formula (8)” represents a structural unit represented by the formula (8). In Table 13, “Formula (8-A)” represents a structure represented by the formula (8-A). In Table 13, “Content of formula (1)” means the content (mass %) of the structure represented by the formula (1) contained in the resin. In Table 13, “Formula (11)” represents a structural unit represented by the formula (11). In the case of using the structural unit represented by the formula (11) as a mixture, the types and mixing ratios (by mass) of structural units are shown. In Table 13, “Formula (12)” represents a structural unit represented by the formula (12). In Table 13, “n in formula (12)” means the average value of n which represents the number of repeats of the structure in parentheses in the structural unit represented by the formula (12).

### Synthesis Example A27

Resin A27 having the structure shown in Table 14 was synthesized according to the method of Synthesis Example A1 except that the siloxane derivative represented by the formula (a-1) was not used, and the siloxane derivative represented by the formula (a-3) was changed to a siloxane derivative represented by the formula (a-7) given below. The obtained resin A27 had a viscosity-average molecular weight of 31,000. The content of a moiety corresponding to the structure represented by the formula (1) contained in the resin A27 was 20 mass %.

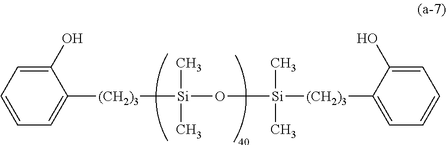

### Synthesis Examples A28 to A32

Resins A28 to A32 were synthesized according to the synthesis method described in Synthesis Example A1 using raw materials appropriate for the structures described in Table 14. The viscosity-average molecular weights of the resins A28 to A32 were controlled by adjusting the time from the start of polymerization to the completion of the polymerization.

The configurations and viscosity-average molecular weights of the resins A27 to A32 are shown in Table 14.

TABLE 14

| | | | | | Viscosity- |
|---|---|---|---|---|---|
| | | n in | Content of | | average |
| | Formula | formula | formula | Formula | molecular |
| | (10) | (10) | (1) | (9) | weight |
| Resin A27 | (10-1)/ | 40 | 20% | (9-1)/ | 31,000 |
| | (10-2) = 5/5 | | | (9-2) = 5/5 | |
| Resin A28 | (10-3) | 40 | 20% | (9-3) | 20,000 |
| Resin A29 | (10-1)/ | 80 | 30% | (9-4)/ | 25,000 |
| | (10-2) = 5/5 | | | (9-5) = 5/5 | |
| Resin A30 | (10-1)/ | 40 | 15% | (9-7)/ | 23,000 |
| | (10-2) = 5/5 | | | (9-8) = 5/5 | |
| Resin A31 | (10-3) | 80 | 20% | (9-9) | 32,000 |
| Resin A32 | (10-3) | 40 | 20% | (9-12) | 40,000 |

In Table 14, “Formula (10)” represents a structure represented by the formula (10). In the case of using the structural unit represented by the formula (10) as a mixture, the types and mixing ratios (by mass) of structural units are shown. In Table 14, “n in formula (10)” means the average value of n which represents the number of repeats of the structure in parentheses in the structural unit represented by the formula (10). In Table 14, “Content of formula (1)” means the content (mass %) of the structure represented by the formula (1) contained in the resin. In Table 14, “Formula (9)” represents a structural unit represented by the formula (9). In the case of using the structural unit represented by the formula (9) as a mixture, the types and mixing ratios (by mass) of structural units are shown.

### Synthesis Example B32

Resin B32 having the structure shown in Table 15 was synthesized according to the method of Synthesis Example B1 except that the siloxane derivative represented by the formula (a-1) was not used, and the siloxane derivative represented by the formula (a-3) was changed to a siloxane derivative represented by the formula (a-7). The obtained resin B32 had a viscosity-average molecular weight of 25,000. The content of a moiety corresponding to the structure represented by the formula (1) contained in the resin B32 was 20 mass %.

### Synthesis Examples B33 to B35

Resins B33 to B35 were synthesized according to the synthesis method described in Synthesis Example B1 using raw materials appropriate for the structures described in Table 15. The viscosity-average molecular weights of the resins B33 to B35 were controlled by adjusting the time from the start of polymerization to the completion of the polymerization.

The configurations and viscosity-average molecular weights of the resins B32 to B35 are shown in Table 15.

TABLE 15

| | | | Content | | Viscosity- |
|---|---|---|---|---|---|
| | | n in | of | | average |
| | Formula | formula | formula | | molecular |
| | (12) | (12) | (1) | Formula (11) | weight |
| Resin B32 | (12-1) | 40 | 20% | (11-1) | 25,000 |
| Resin B33 | (12-1) | 40 | 30% | (11-3)/(11-16) = 5/5 | 23,000 |
| Resin B34 | (12-1) | 80 | 10% | (11-12) | 32,000 |
| Resin B35 | (12-1) | 40 | 20% | (11-1)/(11-15) = 8/2 | 30,000 |

In Table 15, “Formula (12)” represents a structure represented by the formula (12). In Table 15, “n in formula (12)” means the average value of n represent s the number of repeats of the structure in parentheses in the structural unit represented by the formula (12). In Table 15, “Content of formula (1)” means the content (mass %) of the structure represented by the formula (1) contained in the resin. In Table 15, “Formula (11)” represents a structural unit represented by the formula (11). In the case of using the structural unit represented by the formula (11) as a mixture, the types and mixing ratios (by mass) of structural units are shown.

### Synthesis Example A33

Resin A33 having the structure shown in Table 16 was synthesized according to the method of Synthesis Example A1 using a siloxane derivative represented by the formula (a-1), a siloxane derivative represented by the formula (a-6) and a diol represented by the formula (a-2). The obtained resin A33 had a viscosity-average molecular weight of 30,000. The content of the structure represented by the formula (1) contained in the resin A33 was 10 mass %.

TABLE 16

| | | | Formula (5-A) | | | | | Content of | | Viscosity-average |
|---|---|---|---|---|---|---|---|---|---|---|
| | Formula (2) | Formula (5) | R⁵¹¹-R⁵²⁰ | Z | n | k | l | formula (1) | Formula (9) | molecular weight |
| Resin A33 | (2-1) | (5-1)/(5-2) = | Methyl | Methyl | 30 | 1 | 1 | 10% | (9-1)/(9-2) = | 30,000 |
| | | 5/5 | group | group | | | | | 5/5 | |

In Table 16, “Formula (2)” represents a structural unit represented by the formula (2). In Table 16, “Formula (5)” represents the type and mixing ratio (by mass) of a structural unit represented by the formula (5). In Table 16, “Formula (5-A)” represents a structure represented by the formula (5-A). In Table 16, “Content of formula (1)” means the content (mass %) of the structure represented by the formula (1) contained in the resin. In Table 16, “Formula (9)” represents the type and mixing ratio (by mass) of a structural unit represented by the formula (9).

### Synthesis Example B36

Resin B36 having the structure shown in Table 17 was synthesized according to the method of Synthesis Example B1 using a siloxane derivative represented by the formula (a-1), a siloxane derivative represented by the formula (a-6) and a diol represented by the formula (b-1). The obtained resin B36 had a viscosity-average molecular weight of 25,000. The content of the structure represented by the formula (1) contained in the resin B36 was 5 mass %.

TABLE 17

| | | | Formula (8-A) | | | | | Content of | | Viscosity-average |
|---|---|---|---|---|---|---|---|---|---|---|
| | Formula (2) | Formula (8) | R⁸¹¹-R⁸²⁰ | Z | n | k | l | formula (1) | Formula (11) | molecular weight |
| Resin B36 | (2-1) | (8-1) | Methyl | Methyl | 30 | 1 | 1 | 5% | (11-1) | 25,000 |
| | | | group | group | | | | | | |

In Table 17, “Formula (2)” represents a structural unit represented by the formula (2). In Table 17, “Formula (8)” represents a structural unit represented by the formula (8). In Table 17, “Formula (8-A)” represents a structure represented by the formula (8-A). In Table 17, “Content of formula (1)” means the content (mass %) of the structure represented by the formula (1) contained in the resin. In Table 17, “Formula (1)” represents a structural unit represented by the formula (11).

Production Examples of the electrophotographic photosensitive member of the present invention will be shown below. However, the present invention is not intended to be limited by these Production Examples.

### Production Example 1 of Photosensitive Member

An aluminum cylinder having a diameter of 24 mm and a length of 257 mm was used as a support (conductive support).

Next, 214 parts of a titanium oxide (TiO₂) particle coated with oxygen-deficient tin oxide (SnO₂) as a metal oxide particle, 132 parts of a phenol resin (phenol resin monomer/oligomer) (product name: Plyophen J-325, manufactured by DIC Corp. (formerly Dainippon Ink and Chemicals), resin solid component: 60 mass %) as a binding material and 98 parts of 1-methoxy-2-propanol as a solvent were placed in a sand mill containing 450 parts of glass beads having a diameter of 0.8 mm, and dispersed under conditions involving the number of rotations of 2000 rpm, a dispersion treatment time of 4.5 hours and a set temperature of cooling water of 18° C. to obtain a dispersion. The glass beads were removed from this dispersion using a mesh (opening: 150 nm).

A silicone resin particle (product name: Tospearl 120, manufactured by Momentive Performance Materials Inc., average particle size: 2 μm) was added as a surface roughness imparting material to the dispersion at 10 mass % with respect to the total mass of the metal oxide particle and the binding material in the dispersion after the removal of the glass beads. Also, silicone oil (product names SH28PA, manufactured by Dow Corning Toray Co., Ltd.) was added as a leveling agent to the dispersion at 0.01 mass % with respect to the total mass of the metal oxide particle and the binding material in the dispersion. The mixture was stirred to prepare a coating solution for a conductive layer.

This coating solution for a conductive layer was applied onto the support by dipping, and the obtained coating film was dried and thermally cured at 150° C. for 30 minutes to form a conductive layer having a film thickness of 30 μm.

Next, 5 parts of an electron-transporting substance represented by the formula (d-1) given below, 8.6 parts of a blocked isocyanate compound (product name: SBN-70D, manufactured by Asahi Kasei chemicals Corp.), 0.6 parts of a polyvinyl acetal resin (product name: KS-5Z, manufactured by Sekisui Chemical Co., Ltd.) and 0.15 parts of zinc(II) hexanoate (product name: zinc(II) hexanoate, manufactured by Mitsuwa Chemicals Co., Ltd.) were dissolved in a mixed solvent of 45 parts of 1 -methoxy-2-propanol and 45 parts of tetrahydrofuran. 3.3 parts of slurry containing a silica particle dispersed in isopropanol (product name: IPA ST-UP, silica ratio: 15 mass %, manufactured by Nissan Chemicals Industries, Ltd.) were added to the obtained solution, and the mixture was stirred. This coating solution for an undercoat layer was applied onto the conductive layer by dipping, and the obtained coating film was heated and cured (polymerized) at 170° C. for 20 minutes to form an undercoat layer having a film thickness at 0.6 μm.

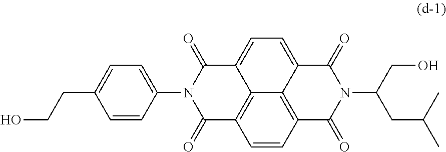 [SMILES: CC(C)CC(CO)N1C(=O)c2ccc3c4c(ccc(c24)C1=O)C(=O)N(c1ccc(CCO)cc1)C3=O]

Next, 10 parts of hydroxygallium phthalocyanine (charge generating substance) were prepared in a crystal form having strong peaks at Bragg angles 2θ±0.2° of 7.5°, 9.9°, 16.3°, 18.6°, 25.1° and 28.3° in CuKα characteristic X-ray diffraction. This substance was mixed with 250 parts of cyclohexanone and 5 parts of a polyvinyl butyral resin (product name: S-LEC BX-1, manufactured by Sekisui Chemical Co., Ltd.) and dispersed in an atmosphere of 23±3° C. for 1 hour using a sand mill apparatus containing glass beads having a diameter of 1 nm. After the dispersion, 250 parts of ethyl acetate were added thereto to prepare a coating solution for a charge generation layer. This coating solution for a charge generation layer was applied onto the undercoat layer by dipping, and the obtained coating film was dried at 100° C. for 10 minuses to form a charge generation layer having a film thickness of 0.26 μm.

Next, a charge-transporting substance consisting of 8 parts of a compound represented by the formula (13-1) and 2 parts of a compound represented by the formula (13-8), and a resin consisting of 0.4 parts of the resin A1 synthesized in Synthesis Example A1 and 9.6 parts of a polyarylate resin (viscosity-average molecular weight: 40,000) containing a structural unit represented by the formula (9-1) and a structural unit represented by the formula (9-2) at a ratio of 5:5 were dissolved in a mixed solvent consisting of 40 parts of dimethoxymethane, 60 parts of o-xylene and 5 parts of methyl benzoate to prepare a coating solution for a charge transport layer. This coating solution for a charge transport layer was applied onto the charge generation layer by dipping, and the obtained coating film was dried at 120° C. for 1 hour to form a charge transport layer having a film thickness of 16 μm.

In this way, photosensitive member 1 was prepared such that the charge transport layer served as a surface layer. The configurations of the charge-transporting substance and the resin contained in the charge transport layer of the photosensitive member 1 are shown in Table 18-1. Also, the abundance ratio of a silicon element to constituent elements in the outermost surface of the surface layer of the photosensitive member 1 is shown in Table 18-1.

### Production Example 2 of Photosensitive Member

Photosensitive member 2 was prepared in the same way as in the photosensitive member 1 except that, in the photosensitive member 1, the resin A1 in the charge transport layer was changed to the resin A2, and 0.04 parts of polydimethylsiloxane represented by the formula (16) (average value of n: 40) were added. The configurations of the charge-transporting substance, the resin and the polydimethylsiloxane contained in the charge transport layer of the photosensitive member 2 are shown in Table 18-1. Also, the abundance ratio of a silicon element to constituent elements in the outermost surface of the photosensitive member 2 is shown in Table 18-1.

### Production Examples 3 to 96, 102 and 103 of Photosensitive Member

Photosensitive members 3 to 96, 102 and 109 were prepared in the same way as in the photosensitive member 2 except that, in the photosensitive member 2, the charge-transporting substance, the resin and the polydimethylsiloxane in the charge transport layer were changed as shown in Tables 18-1 and 18-2. The configurations of the charge-transporting substance, the resin and the polydimethylsiloxane contained in the charge transport layer of each of the photosensitive members 3 to 96, 102 and 103 are shown in Tables 18-1 and 18-2. Also, the abundance ratio of a silicon element to constituent elements in the outermost surface of each of the photosensitive members 3 to 96, 102 and 103 is shown in Tables 18-1 and 18-2.

TABLE 18-1

| | | Resin | | | | | | |
|---|---|---|---|---|---|---|---|---|
| | Charge- | | | Viscosity-average | | | Ratio of | Ratio of |
| | transporting | Resin A | Additional | molecular weight | Polydimethylsiloxane | | resin A or | silicon |
| | substance | or resin B | resin | of additional resin | Mixing ratio | n | resin B | element |
| Photosensitive | (13-1)/(13-8) = 8/2 | Resin A1 | (9-1)/(9-2) = 5/5 | 40,000 | — | — | 2.0% | 8% |
| member 1 | | | | | | | | |
| Photosensitive | (13-1)/(13-8) = 8/2 | Resin A2 | (9-1)/(9-2) = 5/5 | 40,000 | 10% | 40 | 2.0% | 15% |
| member 2 | | | | | | | | |
| Photosensitive | (13-5) = 10 | Resin A2 | (9-12) | 35,000 | — | — | 2.0% | 10% |
| member 3 | | | | | | | | |
| Photosensitive | (13-2) = 10 | Resin A2 | (9-12) | 35,000 | — | — | 1.5% | 8% |
| member 4 | | | | | | | | |
| Photosensitive | (13-1)/(13-8) = 8/2 | Resin A3 | (11-1) | 40,000 | 3% | 80 | 1.5% | 20% |
| member 5 | | | | | | | | |
| Photosensitive | (13-1)/(13-8) = 8/2 | Resin A4 | (9-1)/(9-2) = 5/5 | 40,000 | — | — | 2.5% | 12% |
| member 6 | | | | | | | | |
| Photosensitive | (13-1)/(13-8) = 8/2 | Resin A5 | (9-1)/(9-2) = 5/5 | 40,000 | — | — | 1.0% | 6% |
| member 7 | | | | | | | | |
| Photosensitive | (13-1)/(13-8) = 8/2 | Resin A6 | (9-1)/(9-2) = 5/5 | 40,000 | — | — | 0.3% | 6% |
| member 8 | | | | | | | | |
| Photosensitive | (13-1)/(13-8) = 8/2 | Resin A7 | (9-1)/(9-2) = 5/5 | 40,000 | — | — | 2.5% | 12% |
| member 9 | | | | | | | | |
| Photosensitive | (13-1)/(13-2) = 5/5 | Resin A8 | (9-1)/(9-2) = 5/5 | 40,000 | — | — | 1.5% | 15% |
| member 10 | | | | | | | | |
| Photosensitive | (13-1)/(13-8) = 8/2 | Resin B1 | (9-1)/(9-2) = 5/5 | 40,000 | — | — | 0.5% | 7% |
| member 11 | | | | | | | | |
| Photosensitive | (13-1)/(13-8) = 8/2 | Resin B2 | (9-1)/(9-2) = 5/5 | 40,000 | 10% | 40 | 2.0% | 13% |
| member 12 | | | | | | | | |
| Photosensitive | (13-1)/(13-8) = 8/2 | Resin B2 | (9-1)/(9-2) = 5/5 | 40,000 | — | — | 1.0% | 9% |
| member 13 | | | | | | | | |
| Photosensitive | (13-1)/(13-8) = 8/2 | Resin B2 | (11-1) | 40,000 | 10% | 40 | 1.5% | 15% |
| member 14 | | | | | | | | |
| Photosensitive | (13-1)/(13-2) = 5/5 | Resin B2 | (11-1) | 40,000 | 10% | 40 | 0.5% | 13% |
| member 15 | | | | | | | | |
| Photosensitive | (13-5) = 10 | Resin B2 | (9-12) | 35,000 | — | — | 2.0% | 8% |
| member 16 | | | | | | | | |
| Photosensitive | (13-5) = 10 | Resin B2 | (11-2)/(11-3) = 7/3 | 32,000 | — | — | 2.5% | 10% |
| member 17 | | | | | | | | |
| Photosensitive | (13-4) = 10 | Resin B2 | (11-1)/(11-15) = 8/2 | 30,000 | — | — | 0.3% | 5% |
| member 18 | | | | | | | | |
| Photosensitive | (13-1)/(13-8) = 8/2 | Resin B3 | (9-1)/(9-2) = 5/5 | 40,000 | — | — | 5.0% | 13% |
| member 19 | | | | | | | | |
| Photosensitive | (13-5) = 10 | Resin B3 | (9-12) | 35,000 | 5% | 40 | 3.0% | 18% |
| member 20 | | | | | | | | |
| Photosensitive | (13-5) = 10 | Resin B3 | (11-1)/(11-15) = 8/2 | 30,000 | — | — | 1.0% | 10% |
| member 21 | | | | | | | | |
| Photosensitive | (13-5) = 10 | Resin B3 | (11-2)/(11-3) = 7/3 | 32,000 | — | — | 1.5% | 11% |
| member 22 | | | | | | | | |
| Photosensitive | (13-4) = 10 | Resin B3 | (11-1)/(11-15) = 8/2 | 30,000 | — | — | 0.5% | 5% |
| member 23 | | | | | | | | |
| Photosensitive | (13-1)/(13-8) = 8/2 | Resin B4 | (9-1)/(9-2) = 5/5 | 40,000 | 30% | 20 | 3.0% | 21% |
| member 24 | | | | | | | | |
| Photosensitive | (13-1)/(13-8) = 8/2 | Resin B5 | (11-1) | 40,000 | — | — | 2.5% | 16% |
| member 25 | | | | | | | | |
| Photosensitive | (13-1)/(13-8) = 8/2 | Resin B6 | (9-1)/(9-2) = 5/5 | 40,000 | — | — | 4.0% | 13% |
| member 26 | | | | | | | | |
| Photosensitive | (13-1)/(13-8) = 8/2 | Resin B7 | (9-1)/(9-2) = 5/5 | 40,000 | — | — | 1.0% | 12% |
| member 27 | | | | | | | | |
| Photosensitive | (13-1)/(13-8) = 8/2 | Resin B8 | (11-1) | 40,000 | — | — | 2.5% | 10% |
| member 28 | | | | | | | | |
| Photosensitive | (13-1)/(13-8) = 8/2 | Resin B9 | (9-1)/(9-2) = 5/5 | 40,000 | 1% | 60 | 0.1% | 13% |
| member 29 | | | | | | | | |
| Photosensitive | (13-5) = 10 | Resin A9 | (9-12) | 35,000 | — | — | 2.5% | 10% |
| member 30 | | | | | | | | |
| Photosensitive | (13-1)/(13-8) = 8/2 | Resin A9 | (9-1)/(9-2) = 5/5 | 40,000 | 10% | 40 | 5.0% | 15% |
| member 31 | | | | | | | | |
| Photosensitive | (13-5) = 10 | Resin A10 | (9-12) | 35,000 | — | — | 1.0% | 8% |
| member 32 | | | | | | | | |
| Photosensitive | (13-5) = 10 | Resin A11 | (9-12) | 35,000 | — | — | 0.3% | 7% |
| member 33 | | | | | | | | |
| Photosensitive | (13-1)/(13-8) = 8/2 | Resin A12 | (11-2)/(11-3) = 7/3 | 32,000 | — | — | 2.5% | 8% |
| member 34 | | | | | | | | |
| Photosensitive | (13-5) = 10 | Resin A13 | (11-1) | 40,000 | — | — | 10.0% | 8% |
| member 35 | | | | | | | | |
| Photosensitive | (13-5) = 10 | Resin A14 | (11-2)/(11-3) = 7/3 | 32,000 | — | — | 1.0% | 6% |
| member 36 | | | | | | | | |
| Photosensitive | (13-5) = 10 | Resin B10 | (9-12) | 35,000 | 10% | 40 | 1.5% | 13% |
| member 37 | | | | | | | | |
| Photosensitive | (13-1)/(13-8) = 8/2 | Resin B10 | (9-1)/(9-2) = 5/5 | 40,000 | — | — | 5.0% | 10% |
| member 38 | | | | | | | | |
| Photosensitive | (13-5) = 10 | Resin B10 | (11-2)/(11-3) = 7/3 | 32,000 | — | — | 2.5% | 8% |
| member 39 | | | | | | | | |
| Photosensitive | (13-4) = 10 | Resin B10 | (11-1)/(11-15) = 8/2 | 30,000 | — | — | 1.0% | 5% |
| member 40 | | | | | | | | |
| Photosensitive | (13-5) = 10 | Resin B11 | (9-12) | 35,000 | — | — | 10.0% | 10% |
| member 41 | | | | | | | | |
| Photosensitive | (13-1)/(13-8) = 8/2 | Resin B12 | (11-2)/(11-3) = 7/3 | 32,000 | — | — | 2.5% | 10% |
| member 42 | | | | | | | | |
| Photosensitive | (13-5) = 10 | Resin B13 | (11-1) | 40,000 | — | — | 2.5% | 7% |
| member 43 | | | | | | | | |
| Photosensitive | (13-5) = 10 | Resin B14 | (11-2)/(11-3) = 7/3 | 32,000 | — | — | 2.5% | 12% |
| member 44 | | | | | | | | |
| Photosensitive | (13-5) = 10 | Resin B15 | (9-12) | 35,000 | 5% | 40 | 2.5% | 15% |
| member 45 | | | | | | | | |
| Photosensitive | (13-5) = 10 | Resin B15 | (11-2)/(11-3) = 7/3 | 32,000 | — | — | 2.5% | 8% |
| member 46 | | | | | | | | |
| Photosensitive | (13-4) = 10 | Resin B15 | (11-1)/(11-15) = 8/2 | 30,000 | — | — | 1.5% | 5% |
| member 47 | | | | | | | | |
| Photosensitive | (13-5) = 10 | Resin B16 | (11-2)/(11-3) = 7/3 | 32,000 | — | — | 0.3% | 3% |
| member 48 | | | | | | | | |

TABLE 18-2

| | | Resin | | | | | | |
|---|---|---|---|---|---|---|---|---|
| | Charge- | | | Viscosity-average | | | Ratio of | Ratio of |
| | transporting | Resin A | Additional | molecular weight | Polydimethylsiloxane | | resin A or | silicon |
| | substance | or resin B | resin | of additional resin | Mixing ratio | n | resin B | element |
| Photosensitive | (13-1)/(13-8) = 8/2 | Resin A15 | (11-1) | 40,000 | — | — | 5.0% | 12% |
| member 49 | | | | | | | | |
| Photosensitive | (13-5) = 10 | Resin A16 | (9-12) | 35,000 | — | — | 7.5% | 12% |
| member 50 | | | | | | | | |
| Photosensitive | (13-1)/(13-8) = 8/2 | Resin A17 | (11-1) | 40,000 | — | — | 2.5% | 13% |
| member 51 | | | | | | | | |
| Photosensitive | (13-1)/(13-8) = 8/2 | Resin A18 | (11-1) | 40,000 | 10% | 40 | 10.0% | 15% |
| member 52 | | | | | | | | |
| Photosensitive | (13-1)/(13-8) = 8/2 | Resin A19 | (11-1) | 40,000 | — | — | 5.0% | 7% |
| member 53 | | | | | | | | |
| Photosensitive | (13-1)/(13-8) = 8/2 | Resin A20 | (11-1) | 40,000 | — | — | 1.0% | 5% |
| member 54 | | | | | | | | |
| Photosensitive | (13-1)/(13-8) = 8/2 | Resin A21 | (11-1) | 40,000 | — | — | 2.5% | 8% |
| member 55 | | | | | | | | |
| Photosensitive | (13-1)/(13-8) = 8/2 | Resin B17 | (11-1) | 40,000 | — | — | 2.5% | 8% |
| member 56 | | | | | | | | |
| Photosensitive | (13-4) = 10 | Resin B17 | (11-1)/(11-15) = 8/2 | 30,000 | 20% | 40 | 5.0% | 17% |
| member 57 | | | | | | | | |
| Photosensitive | (13-5) = 10 | Resin B18 | (9-12) | 35,000 | — | — | 2.5% | 13% |
| member 58 | | | | | | | | |
| Photosensitive | (13-1)/(13-8) = 8/2 | Resin B19 | (11-1) | 40,000 | — | — | 10.0% | 10% |
| member 59 | | | | | | | | |
| Photosensitive | (13-1)/(13-8) = 8/2 | Resin B20 | (11-1) | 40,000 | — | — | 0.2% | 2% |
| member 60 | | | | | | | | |
| Photosensitive | (13-5) = 10 | Resin B21 | (9-12) | 35,000 | 5% | 80 | 2.5% | 19% |
| member 61 | | | | | | | | |
| Photosensitive | (13-5) = 10 | Resin B21 | (11-2)/(11-3) = 7/3 | 32,000 | — | — | 1.0% | 5% |
| member 62 | | | | | | | | |
| Photosensitive | (13-4) = 10 | Resin B21 | (11-1)/(11-15) = 8/2 | 30,000 | — | — | 5.0% | 8% |
| member 63 | | | | | | | | |
| Photosensitive | (13-5) = 10 | Resin B22 | (9-12) | 35,000 | — | — | 2.5% | 7% |
| member 64 | | | | | | | | |
| Photosensitive | (13-10) = 10 | Resin A22 | (11-2)/(11-13) = 1/9 | 28,000 | — | — | 5.0% | 12% |
| member 65 | | | | | | | | |
| Photosensitive | (13-1)/(13-8) = 8/2 | Resin A22 | (9-1)/(9-2) = 5/5 | 40,000 | — | — | 0.3% | 1% |
| member 66 | | | | | | | | |
| Photosensitive | (13-10) = 10 | Resin A23 | (11-2)/(11-13) = 1/9 | 28,000 | — | — | 30.0% | 15% |
| member 67 | | | | | | | | |
| Photosensitive | (13-1)/(13-8) = 8/2 | Resin A24 | (11-1) | 40,000 | — | — | 5.0% | 12% |
| member 68 | | | | | | | | |
| Photosensitive | (13-11) = 10 | Resin A25 | (11-2)/(11-13) = 1/9 | 28,000 | 5% | 40 | 10.0% | 15% |
| member 69 | | | | | | | | |
| Photosensitive | (13-5) = 10 | Resin A25 | (9-12) | 36,000 | — | — | 5.0% | 10% |
| member 70 | | | | | | | | |
| Photosensitive | (13-10) = 10 | Resin B23 | (11-2)/(11-13) = 1/9 | 28,000 | — | — | 2.5% | 15% |
| member 71 | | | | | | | | |
| Photosensitive | (13-1)/(13-8) = 8/2 | Resin B23 | (11-1) | 40,000 | 5% | 40 | 5.0% | 20% |
| member 72 | | | | | | | | |
| Photosensitive | (13-5) = 10 | Resin B23 | (9-12) | 35,000 | — | — | 2.5% | 16% |
| member 73 | | | | | | | | |
| Photosensitive | (13-5) = 10 | Resin B23 | (11-2)/(11-3) = 7/3 | 32,000 | — | — | 2.5% | 14% |
| member 74 | | | | | | | | |
| Photosensitive | (13-4) = 10 | Resin B23 | (11-1)/(11-15) = 8/2 | 30,000 | — | — | 2.5% | 14% |
| member 75 | | | | | | | | |
| Photosensitive | (13-10) = 10 | Resin B24 | (11-2)/(11-13) = 1/9 | 28,000 | — | — | 10.0% | 20% |
| member 76 | | | | | | | | |
| Photosensitive | (13-10) = 10 | Resin B25 | (11-2)/(11-13) = 1/9 | 28,000 | — | — | 2.5% | 11% |
| member 77 | | | | | | | | |
| Photosensitive | (13-11) = 10 | Resin B26 | (11-2)/(11-13) = 1/9 | 28,000 | — | — | 0.1% | 0.4% |
| member 78 | | | | | | | | |
| Photosensitive | (13-10) = 10 | Resin B27 | (11-2)/(11-13) = 1/9 | 28,000 | — | — | 30.0% | 15% |
| member 79 | | | | | | | | |
| Photosensitive | (13-11) = 10 | Resin B28 | (11-1) | 40,000 | — | — | 20.0% | 9% |
| member 80 | | | | | | | | |
| Photosensitive | (13-11) = 10 | Resin B28 | (11-2)/(11-13) = 1/9 | 28,000 | — | — | 30.0% | 12% |
| member 81 | | | | | | | | |
| Photosensitive | (13-11) = 10 | Resin B28 | (11-2)/(11-13) = 1/9 | 28,000 | 10% | 40 | 30.0% | 22% |
| member 82 | | | | | | | | |
| Photosensitive | (13-10) = 10 | Resin B29 | (11-2)/(11-13) = 1/9 | 28,000 | — | — | 2.5% | 4% |
| member 83 | | | | | | | | |
| Photosensitive | (13-5) = 10 | Resin B29 | (9-12) | 35,000 | — | — | 2.5% | 6% |
| member 84 | | | | | | | | |
| Photosensitive | (13-10) = 10 | Resin B30 | (11-2)/(11-13) = 1/9 | 28,000 | — | — | 2.6% | 12% |
| member 85 | | | | | | | | |
| Photosensitive | (13-10) = 10 | Resin B31 | (11-2)/(11-13) = 1/9 | 28,000 | — | — | 2.5% | 17% |
| member 86 | | | | | | | | |
| Photosensitive | (13-1)/(13-8) = 8/2 | Resin A27 | (9-1)/(9-2) = 5/5 | 40,000 | 5% | 40 | 10.0% | 17% |
| member 87 | | | | | | | | |
| Photosensitive | (13-5) = 10 | Resin A28 | (9-12) | 35,000 | — | — | 30.0% | 18% |
| member 88 | | | | | | | | |
| Photosensitive | (13-1)/(13-2) = 5/5 | Resin A29 | (9-1)/(9-2) = 5/5 | 40,000 | — | — | 5.0% | 3% |
| member 89 | | | | | | | | |
| Photosensitive | (13-1)/(13-8) = 8/2 | Resin A30 | (9-1)/(9-2) = 5/5 | 40,000 | — | — | 15.0% | 9% |
| member 90 | | | | | | | | |
| Photosensitive | (13-1)/(13-8) = 8/2 | Resin A31 | (9-1)/(9-2) = 5/5 | 40,000 | — | — | 15.0% | 11% |
| member 91 | | | | | | | | |
| Photosensitive | (13-5) = 10 | Resin A32 | (11-2)/(11-3) = 7/3 | 32,000 | — | — | 15.0% | 10% |
| member 92 | | | | | | | | |
| Photosensitive | (13-1)/(13-8) = 8/2 | Resin B32 | (11-1) | 40,000 | 5% | 40 | 10.0% | 16% |
| member 93 | | | | | | | | |
| Photosensitive | (13-1)/(13-8) = 8/2 | Resin B33 | (11-1) | 40,000 | — | — | 10.0% | 10% |
| member 94 | | | | | | | | |
| Photosensitive | (13-1)/(13-8) = 8/2 | Resin B34 | (11-1) | 40,000 | — | — | 10.0% | 6% |
| member 95 | | | | | | | | |
| Photosensitive | (13-5) = 10 | Resin B35 | (9-12) | 35,000 | — | — | 10.0% | 8% |
| member 96 | | | | | | | | |
| Photosensitive | (13-1)/(13-8) = 8/2 | Resin A33 | (9-1)/(9-2) = 5/5 | 40,000 | — | — | 3.5% | 10% |
| member 102 | | | | | | | | |
| Photosensitive | (13-11) = 10 | Resin B36 | (11-2)/(11-13) = 1/9 | 28,000 | — | — | 10.0% | 12% |
| member 103 | | | | | | | | |

In Tables 18-1 and 18-2, “Charge-transporting substance” represents the type and the number of parts of the charge-transporting substance. In Tables 18-1 and 18-2, “Resin A or resin B” represents the resin described in any of Tables 4 to 17. In Tables 18-1 and 18-2, “Additional resin” represents the structural unit of a resin other than the resin A or the resin B contained in the charge transport layer. In the case of using a mixture of structural units, the types and mixing ratios (by mass) of the structural units are shown. In Tables 18-1 and 18-2, “Polydimethylsiloxane Mixing ratio” represents the mixing ratio (mass %) of polydimethylsiloxane to the total amount of the resin A and the resin B contained in the charge transport layer. In Tables 18-1 and 18-2, “Polydimethylsiloxane n” means the average value of n which represents the number of repeats of the structure in parentheses in polydimethylsiloxane contained in the charge transport layer. In Tables 18-1 and 18-2, “Ratio of resin A or resin 3” means the content (mass %) of the resin A or the resin B with respect to all solid components in the charge transport layer. In Tables 18-1 and 18-2, “Ratio of silicon element” means the abundance ratio (atom %) of a silicon element to constituent elements in the outermost surface of the charge transport layer measured using ESCA.

### Production Example 97 of Photosensitive Member

Photosensitive member 97 was prepared in the name way as in the photosensitive member 2 except that, in the photosensitive member 2, the method for preparing the undercoat layer was changed as described below.

Specifically, for the undercoat layer, 3 parts of N-methoxymethylated nylon and 3 parts of copolymerized nylon were dissolved in a mixed solvent of 65 parts of methanol and 30 parts of n-butanol to prepare a coating solution for an undercoat layer. This coating solution for an undercoat layer was applied onto the conductive layer by dipping, and this coating film was dried at 100° C. for 10 minutes to form an undercoat layer having a film thickness of 0.7 μm.

The configurations of the charge-transporting substance, the resin and the polydimethylsiloxane contained in the charge transport layer of the photosensitive member 97 are shown in Table 19. Also, the abundance ratio of a silicon element to constituent elements in the outermost surface of the photosensitive member 97 is shown in Table 19.

### Production Examples 98 and 99 of Photosensitive Member

Photosensitive members 98 and 99 were prepared in the name way as in the photosensitive member 97 except that, in the photosensitive member 97, the charge-transporting substance, the resin and the polydimethylsiloxane in the charge transport layer were changed as shown in Table 19. The configurations of the charge-transporting substance, the resin and the polydimethylsiloxane contained in the charge transport layer of each of the photosensitive members 98 and 99 are shown in Table 19. Also, the abundance ratio of a silicon element to constituent elements in the outermost surface of each of the photosensitive members 98 and 99 is shown in Table 19.

### Production Example 100 of Photosensitive Member

Photosensitive member 100 was prepared in the sane way as in the photosensitive member 98 except that, in the photosensitive member 98, the method for preparing the conductive layer was changed as described below, and no undercoat layer was formed.

Specifically, 100 parts of a zinc oxide particle (specific surface area: 19 m²/g, powder resistance: 4.7×10⁶ Ω·cm) were stirred and mixed as a metal oxide with 500 parts of toluene. 0.8 parts of a silane coupling agent (compound name: N-2-(aminoethyl)-3-aminopropylmethyldimethoxysilane, product name: KBM602, manufactured by Shin-Etsu Chemical Co., Ltd.) were added thereto, and the mixture was stirred for 6 hours. Then, toluene was distilled off under reduced pressure, and the residue was dried by heating at 130° C. for 6 hours to obtain a surface-treated zinc oxide particle.

Next, a polyol resin consisting of 15 parts of a butyrol resin (product name: BM-1, manufactured by Sekisui Chemical Co., Ltd.) and 15 parts of a blocked isocyanate (product name: Sumidur 3175, manufactured by Sumika Bayer Urethane Co., Ltd. (formerly Sumitomo Bayer Urethane Co., Ltd.)) was dissolved in a mixed solution of 73.5 parts of methyl ethyl ketone and 73.5 parts of 1-butanol. 80.64 parts of the surface-treated zinc oxide particle and 0.8 parts of 2,3,4-trihydroxybenzophenone (manufactured by Tokyo Chemical Industry Co., Ltd.) were added to this solution and dispersed in an atmosphere of 23±3° C. for 3 hours using a sand mill apparatus containing glass beads having a diameter of 0.8 mm. After the dispersion, 0.01 parts of silicone oil (product name: SH28PA, manufactured by Dow Corning Toray Co., Ltd.) and 5.6 parts of a cross-linked polymethyl methacrylate (PMMA) particle (product name: TECHPOLYMER SSX-102, manufactured by Sekisui Plastics Co., Ltd., average primary particle size: 2.5 μm) were added thereto, and the mixture was starred to prepare a coating solution for a conductive layer.

This coating solution for a conductive layer was applied onto the support by dipping to form a coating film. This coating film was dried by heating at 160° C. for 40 minutes to form a conductive layer having a film thickness of 18 μm.

The configurations of the charge-transporting substance, the resin and the polydimethylsiloxane contained in the charge transport layer of the photosensitive member 100 are shown in Table 19. Also, the abundance ratio of a silicon element to constituent elements in the outermost surface of the photosensitive member 100 is shown in Table 19.

### Production Example 101 of Photosensitive Member

Photosensitive member 101 was prepared in the same way as In the photosensitive member 100 except that, in the photosensitive member 100, the charge-transporting substance, the resin and the polydimethylsiloxane in the charge transport layer were changed as shown in Table 19. The configurations of the charge-transporting substance, the resin and the polydimethylsiloxane contained in the charge transport layer of the photosensitive member 101 are shown in Table 19. Also, the abundance ratio of a silicon element to constituent elements in the outermost surface of the photosensitive member 101 is shown in Table 19.

TABLE 19

| | | Resin | | | | | | |
|---|---|---|---|---|---|---|---|---|
| | Charge- | | | Viscosity-average | | | Ratio of | Ratio of |
| | transporting | Resin A | Additional | molecular weight | Polydimethylsiloxane | | resin A or | silicon |
| | substance | or resin B | resin | of additional resin | Mixing ratio | n | resin B | element |
| Photosensitive | (13-1)/(13-8) = 8/2 | Resin A2 | (9-1)/(9-2) = 5/5 | 40,000 | 10% | 40 | 2.0% | 15% |
| member 97 | | | | | | | | |
| Photosensitive | (13-1)/(13-8) = 8/2 | Resin B2 | (9-1)/(9-2) = 5/5 | 40,000 | 10% | 40 | 2.0% | 13% |
| member 98 | | | | | | | | |
| Photosensitive | (13-1)/(13-2) = 5/5 | Resin B2 | (11-1) | 40,000 | 10% | 40 | 2.0% | 15% |
| member 99 | | | | | | | | |
| Photosensitive | (13-1)/(13-8) = 8/2 | Resin B2 | (9-1)/(9-2) = 5/5 | 40,000 | 10% | 40 | 2.0% | 13% |
| member 100 | | | | | | | | |
| Photosensitive | (13-1)/(13-2) = 5/5 | Resin B2 | (11-1) | 40,000 | 10% | 40 | 2.0% | 15% |
| member 101 | | | | | | | | |

In Table 19, “Charge-transporting substance” represents the type and the number of parts of the charge-transporting substance. In Table 19, “Resin A or resin B” represents the resin described in any of Tables 4 to 17. In Table 19, “Additional resin” represents the structural unit of a resin other than the resin A or the resin B contained in the charge transport layer. In the case of using a mixture of structural units, the types and mixing ratios (by mass) of the structural units are shown. In Table 19, “Polydimethylsiloxane Mixing ratio” represents the mixing ratio (mass %) of polydimethylailoxane to the total amount of the resin A and the resin B contained in the charge transport layer. In Table 19, “Polydimethylsiloxane n” means the average value of n which represents the number of repeats of the structure in parentheses in polydimethylsiloxane contained in the charge transport layer. In Table 19, “Ratio of resin A or resin B” means the content (mass %) of the resin A or the resin B with respect to all solid components in the charge transport layer. In Table 19, “Ratio of silicon element” means the abundance ratio (atom %) of a silicon element to constituent elements in the outermost surface of the charge transport layer measured using ESCA.

### Production Example 1 of Comparative Photosensitive Member

Comparative photosensitive member 1 was prepared in the same way as in the photosensitive member 4 except that the resin A2 in the charge transport layer was not used in the photosensitive member 4. The configurations of the charge-transporting substance and the resin contained in the charge transport layer of the comparative photosensitive member 1 are shown in Table 20. Also, the abundance ratio of a silicon element to constituent elements in the outermost surface of the comparative photosensitive member 1 was 0.0 atom %.

TABLE 20

| | | Resin | | | | | | |
|---|---|---|---|---|---|---|---|---|
| | Charge- | | | Viscosity-average | | | Ratio of | Ratio of |
| | transporting | Resin A | Additional | molecular weight | Polydimethylsiloxane | | resin A or | silicon |
| | substance | or resin B | resin | of additional resin | Mixing ratio | n | resin B | element |
| Comparative | (13-2) = 10 | — | (9-12) | 35,000 | — | — | — | 0.0% |
| photosensitive | | | | | | | | |
| member 1 | | | | | | | | |

In Table 20, “Charge-transporting substance” represents the type and the number of parts of the charge-transporting substance. In Table 20, “Resin A or resin B” represents the resin described in any of Tables) 4 to 17. In Table 20, “Additional resin” represents the structural unit of a resin other than the resin A or the resin B contained In the charge transport layer. In Table 20, “Polydimethylsiloxane n” means the average value of n which represents the number of repeats of the structure in parentheses in polydimethylsiloxane contained in the charge transport layer. In Table 20, “Ratio of resin A or resin B” means the content (mass %) of the resin A or the resin B with respect to all solid components in the charge transport layer. In Table 20, “Ratio of silicon element” means the abundance ratio (atom %) of a silicon element to constituent elements in the outermost surface of the charge transport layer measured using ESCA.

### Production Example 104 of Photosensitive Member

Photosensitive member 104 was prepared in the same way as in the photosensitive member 1 except that, in the photosensitive member 1, the method for producing the charge transport layer was changed as described below.

Specifically, a charge-transporting substance consisting of 9 parts of a compound represented by the formula (13-1) and 1 part of a compound represented by the formula (33-8) and a resin consisting of 10 parts of a polycarbonate resin (product name: Iupilon Z400, manufactured by Mitsubishi Engineering-Plastics Corp., formula (11-1), viscosity-average molecular weight Mv=40,000) were dissolved in a mixed solvent of 60 parts of o-xylene and 50 parts of dimethoxymethane.

Subsequently, 5 parts of an ethylene tetrafluoride resin particle (product name: Ruburon L2. manufactured by Daikin Industries, Ltd.) were mixed with 5 parts of a polycarbonate resin constituted by a repeating structural unit of the formula (11-1) and 70 parts of o-xylene. 0.2S parts of a polymer (E-A, Mw=22,000) produced in Production Example (E-1) described in Japanese Patent No. 4436456 were further added thereto as a dispersion aid to prepare a solution. This solution was applied twice to a high-speed liquid collision dispersing machine (product name: Microfluidizer M-110EH, manufactured by Microfluidics, USA) at a pressure of 49 MPa (500 kg/cm²) so that the solution containing the ethylene tetrafluoride resin particle was dispersed at high pressure. The ethylene tetrafluoride resin particle after the dispersion had an average particle size of 0-32 μm. The ethylene tetrafluoride resin particle dispersion thus prepared was mixed with a coating solution containing the charge-transporting substance to prepare a coating solution for a surface layer. The amount of the ethylene tetrafluoride resin particle dispersion added was set such that the mass ratio of the ethylene tetrafluoride resin particle was 5.0 mass % to all solid components (charge-transporting substance, binding resin and ethylene tetrafluoride resin particle) in the coating solution. The coating solution for a surface layer thus prepared was applied onto the charge generation layer by dipping, and the coating layer was dried at a temperature of 125° C. for 20 minutes to form a surface layer having an average film thickness of 17 μm at a position 130 mm from the upper end of the support.

In this way, the photosensitive member 104 was prepared.

### Production Examples 105, 107 and 113 to 117 of Photosensitive Member

Photosensitive members 105, 107 and 113 to 117 were prepared according to the material configurations and ratios shown in Table 21 in the same way as in Production Example 104 except that, in Production Example 104 of photosensitive member, the dispersion aid was changed to a polymer (Mw=100.000) represented by the formula (20-8) synthesized by a method described in Japanese Patent Application Laid-Open No. 2001-249481.

### Production Examples 106 and 108 to 112 of Photosensitive Member

Photosensitive members 106 and 108 to 112 were prepared in the same way as in Production Example 104 except that, in Production Example 104 of photosensitive member, the type of the dispersion aid was not changed, and the material configurations and ratios were changed as shown in Table 21.

### Production Examples 118 to 120 of Photosensitive Member

Photosensitive members 118 to 120 were prepared in the same way as in Production Example 104 except that, in Production Example 104 of photosensitive member, fluorine oil (product name: Modiper F210, manufactured by NOF Corp.) was used as the dispersion aid, and the material configurations and ratios were changed as shown in Table 21.

### Production Example 121 of Photosensitive Member

Photosensitive member 121 was prepared in the same way as in Production Example 104 except that, in Production Example 104 of photosensitive member, 0.25 parts of a polymer (E-B, Mw=20,000) produced in Production Example (E-2) described in Japanese Patent No. 4436456 were used as the dispersion aid, and the material configurations and ratios shown in Table 21 were used.

### Production Example 122 of Photosensitive Member

Photosensitive member 122 was prepared in the same way as in Production Example 104 except that, in Production Example 104 of photosensitive member, 0.25 parts of a polymer (E-C, Mw=23,000) produced in Production Example (E-3) described in Japanese Patent No. 4436456 were used as the dispersion aid, and the material configurations and ratios shown in Table 21 were used.

### Production Example 123 of Photosensitive Member

Photosensitive member 123 was prepared in the same way as in Production Example 104 except that, in Production Example 104 of photosensitive member, 0.25 parts of a polymer (E-D, Mw=22,600) produced in Production Example (E-4) described in Japanese Patent No. 4436456 were used as the dispersion aid, and the material configurations and ratios shown in Table 21 were used.

### Production Example 124 of Photosensitive Member

Photosensitive member 124 was prepared according to the material configurations and ratios shown in Table 21 in the same way as in Production Example 104 except that, in Production Example 104 of photosensitive member, the dispersion aid was changed to a polymer (Mw=85,000) represented by the formula (20-3) synthesized by a method described in Japanese Patent Application Laid-Open No. 2001-249481.

### Production Example 125 of Photosensitive Member

Photosensitive member 125 was prepared according to the material configurations and ratios shown in Table 21 in the same way as in Production Example 104 except that, in Production Example 104 of photosensitive member, the dispersion aid was changed to a polymer (Mw=105,000) represented by the formula (20-6) synthesized by a method described in Japanese Patent Application Laid-Open No. 2001-249481.

### Production Example 126 of Photosensitive Member

Photosensitive member 126 was prepared according to the material configurations and ratios shown in Table 21 in the same way as in Production Example 104 except that, in Production Example 104 of photosensitive member, the dispersion aid was changed to a polymer (Mw=90,000) represented by the formula (20-7) synthesized by a method described in Japanese Patent Application Laid-Open No. 2001-249481.

### Production Example 127 of Photosensitive Member

Photosensitive member 127 was prepared according to the material configurations and ratios shown in Table 21 in the same way as in Production Example 104 except that, in Production Example 104 of photosensitive member, the dispersion aid was changed to a polymer (Mw=80,000) represented by the formula (20-11) synthesized by a method described in Japanese Patent Application Laid-Open No. 2001-249481.

### Production Example 128 of Photosensitive Member

Photosensitive member 128 was prepared according to the material configurations and ratios shown in Table 21 in the same way as in Production Example 104 except that. In Production Example 104 of photosensitive member, the dispersion aid was changed to a polymer (Mw=40,000) represented by the formula (20-18) synthesized by a method described in Japanese Patent Application Laid-Open No. 2001-249461.

### Production Example 129 of Photosensitive Member

Photosensitive member 129 was prepared according to the material configurations and ratios shown in Table 21 in the same way as in Production Example 104 except that, in Production Example 104 of photosensitive member, the dispersion aid was changed to a polymer (Mw=50,000) represented by the formula (20-19) synthesized by a method described in Japanese Patent Application Laid-Open No. 2001-249461.

### Production Example 2 of Comparative Photosensitive Member

Comparative photosensitive member 2 was prepared in the same way an in Production Example 104 except that, in Production Example 104 of photosensitive member, a surface layer consisting of the charge-transporting substance and the resin was formed without the use of the ethylene tetrafluoride resin particle.

TABLE 21

| | Charge- | | Viscosity-average | Amount of | Amount of | Particle size |
|---|---|---|---|---|---|---|
| | transporting | | molecular weight | fluorine resin | dispersion aid | of fluorine |
| | substance | Resin | of resin | particle (%) | (%) | resin particle (μm) |
| Photosensitive | (13-1)/(13-8) = 9/1 | (11-1) | 40,000 | 5.0% | 5.0% | 0.32 |
| member 104 | | | | | | |
| Photosensitive | (13-1)/(13-8) = 9/1 | (11-1) | 40,000 | 5.0% | 5.0% | 0.28 |
| member 105 | | | | | | |
| Photosensitive | (13-1)/(13-8) = 9/1 | (9-1)/(9-2) = 5/5 | 60,000 | 5.0% | 5.0% | 0.21 |
| member 106 | | | | | | |
| Photosensitive | (13-1)/(13-2) = 7/3 | (9-1)/(9-2) = 5/5 | 60,000 | 5.0% | 5.0% | 0.22 |
| member 107 | | | | | | |
| Photosensitive | (13-1)/(13-8) = 8/2 | (9-12) | 35,000 | 3.0% | 4.2% | 0.30 |
| member 108 | | | | | | |
| Photosensitive | (13-1)/(13-8) = 8/2 | (9-1)/(9-2) = 5/5 | 60,000 | 10.0% | 7.5% | 0.25 |
| member 109 | | | | | | |
| Photosensitive | (13-1)/(13-8) = 8/2 | (9-1)/(9-2) = 5/5 | 60,000 | 1.5% | 1.5% | 0.55 |
| member 110 | | | | | | |
| Photosensitive | (13-1)/(13-8) = 8/2 | (9-1)/(9-2) = 5/5 | 60,000 | 5.0% | 1.5% | 0.71 |
| member 111 | | | | | | |
| Photosensitive | (13-1)/(13-8) = 8/2 | (9-1)/(9-2) = 5/5 | 60,000 | 15.0% | 1.5% | 1.11 |
| member 112 | | | | | | |
| Photosensitive | (13-1)/(13-2) = 5/5 | (9-1)/(9-2) = 5/5 | 60,000 | 3.0% | 4.2% | 0.28 |
| member 113 | | | | | | |
| Photosensitive | (13-1)/(13-8) = 8/2 | (9-1)/(9-2) = 5/5 | 60,000 | 10.0% | 7.5% | 0.22 |
| member 114 | | | | | | |
| Photosensitive | (13-1)/(13-8) = 8/2 | (9-1)/(9-2) = 5/5 | 60,000 | 1.5% | 1.5% | 0.51 |
| member 115 | | | | | | |
| Photosensitive | (13-1)/(13-8) = 8/2 | (9-1)/(9-2) = 5/5 | 60,000 | 5.0% | 1.5% | 0.75 |
| member 116 | | | | | | |
| Photosensitive | (13-1)/(13-8) = 8/2 | (11-1) | 40,000 | 15.0% | 1.5% | 1.08 |
| member 117 | | | | | | |
| Photosensitive | (13-1)/(13-2) = 5/5 | (11-1) | 40,000 | 5.0% | 5.0% | 1.18 |
| member 118 | | | | | | |
| Photosensitive | (13-5) = 10 | (9-12) | 35,000 | 5.0% | 10.0% | 1.08 |
| member 119 | | | | | | |
| Photosensitive | (13-5) = 10 | (11-2)/(11-3) = 7/3 | 32,000 | 5.0% | 3.0% | 1.35 |
| member 120 | | | | | | |
| Photosensitive | (13-4) = 10 | (11-1)/(11-15) = 8/2 | 30,000 | 5.0% | 5.0% | 0.35 |
| member 121 | | | | | | |
| Photosensitive | (13-1)/(13-8) = 8/2 | (9-1)/(9-2) = 5/5 | 40,000 | 5.0% | 5.0% | 0.28 |
| member 122 | | | | | | |
| Photosensitive | (13-5) = 10 | (9-12) | 35,000 | 5.0% | 5.0% | 0.31 |
| member 123 | | | | | | |
| Photosensitive | (13-5) = 10 | (11-1)/(11-15) = 8/2 | 30,000 | 5.0% | 5.0% | 0.21 |
| member 124 | | | | | | |
| Photosensitive | (13-5) = 10 | (11-2)/(11-3) = 7/3 | 32,000 | 5.0% | 5.0% | 0.31 |
| member 125 | | | | | | |
| Photosensitive | (13-4) = 10 | (11-1)/(11-15) = 8/2 | 30,000 | 5.0% | 5.0% | 0.28 |
| member 126 | | | | | | |
| Photosensitive | (13-5) = 10 | (11-1)/(11-15) = 8/2 | 30,000 | 5.0% | 5.0% | 0.18 |
| member 127 | | | | | | |
| Photosensitive | (13-1)/(13-8) = 8/2 | (9-1)/(9-2) = 5/5 | 60,000 | 5.0% | 5.0% | 0.16 |
| member 128 | | | | | | |
| Photosensitive | (13-5) = 10 | (11-2)/(11-3) = 7/3 | 32,000 | 5.0% | 5.0% | 0.20 |
| member 129 | | | | | | |

In Table 21, “Charge-transporting substance” represents the type and the number of parts of the charge-transporting substance. “Resin” represents a resin having a repeating unit represented by a formula. “Viscosity-average molecular weight of resin” represents the viscosity-average molecular weight (Mv) of the resin. “Amount of fluorine resin particle” represents the ratio (mass %) of the fluorine resin particle to the total mass of the surface layer. “Amount of dispersion aid” represents the ratio (mass %) of the dispersion aid to the mass of the fluorine resin particle. “Particle size of fluorine resin particle” represents the average particle size (μm) of the fluorine resin particle immediately after dispersion.

### Example 1

<Preparation of Process Cartridge>

A toner cartridge (Cartridge 311 Cyan; manufactured by Canon Inc.) was used. In order to eliminate the chance that matter adhering on a cleaning blade would influence evaluation, the cleaning blade was thoroughly wiped with cloth impregnated with ethanol, and naturally dried over 1 day. Also, in order to evaluate whether or not to achieve cleaning without elevating a linear pressure at which the edge part of the cleaning blade was pressed against the surface of the photosensitive member, the intrusion level of the cleaning blade on the surface of the photosensitive member was changed to 0.8 mm (the state where the cleaning blade was in contact with the surface of the photosensitive member with a linear pressure of zero was defined as an “intrusion level of 0.0 mm”, and the intrusion level of 0.8 mm means that the cleaning blade was pushed 0.8 mm from this state in a perpendicular direction into the surface of the photosensitive member). The photosensitive member used was the photosensitive member 1, and a development container was filled with the toner 1. In this way, a process cartridge having the photosensitive member 1 and the toner 1 was obtained.

<Evaluation>

The evaluation apparatus used was a development apparatus based on a single-component contact development system (Satera LBP5300) manufactured by Canon Inc.). In consideration of future evolution in electrophotographic system, this development apparatus was used after-adaptation such that the prerotation time from the insertion of a brand-new cartridge to the development apparatus to a stand-by state that permits printing was 5 seconds. The evaluation was conducted in a low-temperature and low-humid environment (10° C./14% RH), which is more stringent for cleaning. The low-temperature and low-humid condition is stringent for cleaning, probably because the increased hardness of the cleaning blade reduces its following properties for the photosensitive member.

(1) Image Evaluation

In a low-temperature and low-humid environment (10° C./14% RH), 20 charts each having a solid image part formed in a cyan monochrome mode on the whole area of a printing sheet were continuously output and evaluated according to criteria given below. The evaluation results are shown in Table 22.
A: No white vertical streak was seen in any of the 20 images.
B: Among the 20 images, there was an image lightly exhibiting approximately one or two white vertical streak.
C: Among the 20 images, there was an image clearly exhibiting a white vertical streak or exhibiting three or more light vertical lines.

(2) Contamination of Charging Member

After the completion of the image evaluation, the charging member in the cartridge was recovered, and the presence or absence of a smear derived from toner adhesion was visually confirmed and evaluated according to criteria given below. The evaluation results are shown in Table 22.
A: No smear was seen.
B: A smear was slightly seen.
C: A conspicuous smear was seen.

### Examples 2 to 103

Each process cartridge was prepared and evaluated for the image and the contamination of a charging member in the same way as in Example 1 except that, in Example 1, the photosensitive member 1 and the toner 1 were changed to the photosensitive member and the toner shown in Table 22. The results are shown in Table 22.

### Examples 104 and 105

Each process cartridge was prepared and evaluated for the image and the contamination of a charging member in the same way as in Examples 12 and 78 except that, in Examples 12 and 78, the prerotation time from the insertion of a brand-new cartridge to the development apparatus to a stand-by state that permits printing was changed to 20 seconds. Tho results are shown in Table 22.

TABLE 22

| | | | | Contamination |
|---|---|---|---|---|
| | Photosensitive | | Image | of charging |
| | member | Toner | evaluation | member |
| Example 1 | Photosensitive | Toner 1 | A | A |
| | member 1 | | | |
| Example 2 | Photosensitive | Toner 1 | A | A |
| | member 2 | | | |
| Example 3 | Photosensitive | Toner 2 | A | A |
| | member 3 | | | |
| Example 4 | Photosensitive | Toner 3 | A | A |
| | member 4 | | | |
| Example 5 | Photosensitive | Toner 4 | A | A |
| | member 5 | | | |
| Example 6 | Photosensitive | Toner 5 | A | A |
| | member 6 | | | |
| Example 7 | Photosensitive | Toner 6 | A | A |
| | member 7 | | | |
| Example 8 | Photosensitive | Toner 1 | A | A |
| | member 8 | | | |
| Example 9 | Photosensitive | Toner 2 | A | A |
| | member 9 | | | |
| Example 10 | Photosensitive | Toner 3 | A | A |
| | member 10 | | | |
| Example 11 | Photosensitive | Toner 1 | A | A |
| | member 11 | | | |
| Example 12 | Photosensitive | Toner 1 | A | A |
| | member 12 | | | |
| Example 13 | Photosensitive | Toner 1 | A | A |
| | member 13 | | | |
| Example 14 | Photosensitive | Toner 1 | A | A |
| | member 14 | | | |
| Example 15 | Photosensitive | Toner 1 | A | A |
| | member 15 | | | |
| Example 16 | Photosensitive | Toner 2 | A | A |
| | member 16 | | | |
| Example 17 | Photosensitive | Toner 3 | A | A |
| | member 17 | | | |
| Example 18 | Photosensitive | Toner 1 | A | A |
| | member 18 | | | |
| Example 19 | Photosensitive | Toner 1 | A | A |
| | member 19 | | | |
| Example 20 | Photosensitive | Toner 1 | A | A |
| | member 20 | | | |
| Example 21 | Photosensitive | Toner 1 | A | A |
| | member 21 | | | |
| Example 22 | Photosensitive | Toner 7 | A | A |
| | member 22 | | | |
| Example 23 | Photosensitive | Toner 1 | A | A |
| | member 23 | | | |
| Example 24 | Photosensitive | Toner 1 | A | A |
| | member 24 | | | |
| Example 25 | Photosensitive | Toner 1 | A | A |
| | member 25 | | | |
| Example 26 | Photosensitive | Toner 1 | A | A |
| | member 26 | | | |
| Example 27 | Photosensitive | Toner 1 | A | A |
| | member 27 | | | |
| Example 28 | Photosensitive | Toner 1 | A | A |
| | member 28 | | | |
| Example 29 | Photosensitive | Toner 1 | A | A |
| | member 29 | | | |
| Example 30 | Photosensitive | Toner 1 | A | A |
| | member 30 | | | |
| Example 31 | Photosensitive | Toner 1 | A | A |
| | member 31 | | | |
| Example 32 | Photosensitive | Toner 7 | A | B |
| | member 32 | | | |
| Example 33 | Photosensitive | Toner 1 | A | A |
| | member 33 | | | |
| Example 34 | Photosensitive | Toner 2 | A | A |
| | member 34 | | | |
| Example 35 | Photosensitive | Toner 3 | B | B |
| | member 35 | | | |
| Example 36 | Photosensitive | Toner 6 | A | A |
| | member 36 | | | |
| Example 37 | Photosensitive | Toner 1 | A | A |
| | member 37 | | | |
| Example 38 | Photosensitive | Toner 1 | A | A |
| | member 38 | | | |
| Example 39 | Photosensitive | Toner 1 | A | A |
| | member 39 | | | |
| Example 40 | Photosensitive | Toner 2 | A | A |
| | member 40 | | | |
| Example 41 | Photosensitive | Toner 2 | A | A |
| | member 41 | | | |
| Example 42 | Photosensitive | Toner 2 | A | A |
| | member 42 | | | |
| Example 43 | Photosensitive | Toner 1 | A | A |
| | member 43 | | | |
| Example 44 | Photosensitive | Toner 1 | A | A |
| | member 44 | | | |
| Example 45 | Photosensitive | Toner 3 | A | B |
| | member 45 | | | |
| Example 46 | Photosensitive | Toner 1 | A | A |
| | member 46 | | | |
| Example 47 | Photosensitive | Toner 4 | A | A |
| | member 47 | | | |
| Example 48 | Photosensitive | Toner 5 | A | B |
| | member 48 | | | |
| Example 49 | Photosensitive | Toner 1 | A | A |
| | member 49 | | | |
| Example 50 | Photosensitive | Toner 1 | A | A |
| | member 50 | | | |
| Example 51 | Photosensitive | Toner 1 | A | A |
| | member 51 | | | |
| Example 52 | Photosensitive | Toner 2 | A | A |
| | member 52 | | | |
| Example 53 | Photosensitive | Toner 3 | B | B |
| | member 53 | | | |
| Example 54 | Photosensitive | Toner 7 | A | B |
| | member 54 | | | |
| Example 55 | Photosensitive | Toner 6 | A | A |
| | member 55 | | | |
| Example 56 | Photosensitive | Toner 1 | A | A |
| | member 56 | | | |
| Example 57 | Photosensitive | Toner 1 | A | A |
| | member 57 | | | |
| Example 58 | Photosensitive | Toner 1 | A | A |
| | member 58 | | | |
| Example 59 | Photosensitive | Toner 1 | A | A |
| | member 59 | | | |
| Example 60 | Photosensitive | Toner 2 | B | B |
| | member 60 | | | |
| Example 61 | Photosensitive | Toner 2 | A | A |
| | member 61 | | | |
| Example 62 | Photosensitive | Toner 4 | A | A |
| | member 62 | | | |
| Example 63 | Photosensitive | Toner 5 | A | A |
| | member 63 | | | |
| Example 64 | Photosensitive | Toner 6 | A | A |
| | member 64 | | | |
| Example 65 | Photosensitive | Toner 1 | A | A |
| | member 65 | | | |
| Example 66 | Photosensitive | Toner 1 | A | B |
| | member 66 | | | |
| Example 67 | Photosensitive | Toner 1 | A | A |
| | member 67 | | | |
| Example 68 | Photosensitive | Toner 2 | A | A |
| | member 68 | | | |
| Example 69 | Photosensitive | Toner 2 | A | A |
| | member 69 | | | |
| Example 70 | Photosensitive | Toner 3 | A | B |
| | member 70 | | | |
| Example 71 | Photosensitive | Toner 1 | A | A |
| | member 71 | | | |
| Example 72 | Photosensitive | Toner 1 | A | A |
| | member 72 | | | |
| Example 73 | Photosensitive | Toner 1 | A | A |
| | member 73 | | | |
| Example 74 | Photosensitive | Toner 1 | A | A |
| | member 74 | | | |
| Example 75 | Photosensitive | Toner 2 | A | A |
| | member 75 | | | |
| Example 76 | Photosensitive | Toner 2 | A | A |
| | member 76 | | | |
| Example 77 | Photosensitive | Toner 2 | A | A |
| | member 77 | | | |
| Example 78 | Photosensitive | Toner 3 | B | B |
| | member 78 | | | |
| Example 79 | Photosensitive | Toner 3 | A | B |
| | member 79 | | | |
| Example 80 | Photosensitive | Toner 1 | A | A |
| | member 80 | | | |
| Example 81 | Photosensitive | Toner 1 | A | A |
| | member 81 | | | |
| Example 82 | Photosensitive | Toner 1 | A | A |
| | member 82 | | | |
| Example 83 | Photosensitive | Toner 1 | A | A |
| | member 83 | | | |
| Example 84 | Photosensitive | Toner 7 | A | A |
| | member 84 | | | |
| Example 85 | Photosensitive | Toner 1 | A | A |
| | member 85 | | | |
| Example 86 | Photosensitive | Toner 1 | A | A |
| | member 86 | | | |
| Example 87 | Photosensitive | Toner 1 | A | A |
| | member 87 | | | |
| Example 88 | Photosensitive | Toner 1 | A | A |
| | member 88 | | | |
| Example 89 | Photosensitive | Toner 1 | A | B |
| | member 89 | | | |
| Example 90 | Photosensitive | Toner 7 | A | A |
| | member 90 | | | |
| Example 91 | Photosensitive | Toner 1 | A | A |
| | member 91 | | | |
| Example 92 | Photosensitive | Toner 1 | A | A |
| | member 92 | | | |
| Example 93 | Photosensitive | Toner 1 | A | A |
| | member 93 | | | |
| Example 94 | Photosensitive | Toner 1 | A | A |
| | member 94 | | | |
| Example 95 | Photosensitive | Toner 1 | A | A |
| | member 95 | | | |
| Example 96 | Photosensitive | Toner 1 | A | A |
| | member 96 | | | |
| Example 97 | Photosensitive | Toner 1 | A | A |
| | member 97 | | | |
| Example 98 | Photosensitive | Toner 1 | A | A |
| | member 98 | | | |
| Example 99 | Photosensitive | Toner 1 | A | A |
| | member 99 | | | |
| Example 100 | Photosensitive | Toner 1 | A | A |
| | member 100 | | | |
| Example 101 | Photosensitive | Toner 1 | A | A |
| | member 101 | | | |
| Example 102 | Photosensitive | Toner 1 | A | A |
| | member 102 | | | |
| Example 103 | Photosensitive | Toner 1 | A | A |
| | member 103 | | | |
| Example 104 | Photosensitive | Toner 1 | A | A |
| | member 12 | | | |
| Example 105 | Photosensitive | Toner 3 | B | A |
| | member 78 | | | |

### Comparative Examples 1 to 5

Each process cartridge was prepared and evaluated for the image and the contamination of a charging member in the same way as in Example 1 except chat, in Example 1, the photosensitive member 1 and the toner 1 were changed to the photosensitive member and the toner shown in Table 23. The results are shown in Table 23.

TABLE 23

| | | | | Contamination |
|---|---|---|---|---|
| | Photosensitive | | Image | of charging |
| | member | Toner | evaluation | member |
| Comparative | Comparative | Comparative | C | C |
| Example 1 | photosensitive | toner 1 | | |
| | member 1 | | | |
| Comparative | Comparative | Toner 3 | C | C |
| Example 2 | photosensitive | | | |
| | member 1 | | | |
| Comparative | Comparative | Toner 6 | C | C |
| Example 3 | photosensitive | | | |
| | member 1 | | | |
| Comparative | Photosensitive | Comparative | B | C |
| Example 4 | member 38 | toner 1 | | |
| Comparative | Photosensitive | Comparative | B | C |
| Example 5 | member 92 | toner 1 | | |

### Example 106

<Process Cartridge>

The evaluation apparatus used was a development apparatus based on a single-component contact development system (Satera LBPS300; manufactured by Canon Inc.), which was adjusted such that toner discharge was not performed during a non-image-forming period. The evaluation was conducted in a low-temperature and low-humid environment (10° C./14% RH), which is more stringent for cleaning. The low-temperature and low-humid condition is stringent for cleaning, probably because the increased hardness of the cleaning blade reduces its following properties for the photosensitive member due to a decreased modulus of elasticity.

The photosensitive member used was the photosensitive member 104, and a development container was filled with the toner 1. In this way, a process cartridge having the photosensitive member 104 and the toner 1 was used to evaluate the image and the contamination of a charging member.

(3) Image Evaluation

In a low-temperature and low-humid environment (10° C./14% RH), after endurance of 10,000 sheets using test charts having a coverage rate of 1%, 20 charts each having a solid black image part formed in a cyan monochrome mode on the whole area of a paper sheet were continuously output and evaluated according to criteria given below. The evaluation results are shown in Table 24.
A: No white vertical streak was seen in any of the 20 images.
B: Among the 20 images, there was an image lightly exhibiting approximately one or two white vertical streak.
C: Among the 20 images, there was an image clearly exhibiting a white vertical streak or exhibiting three or more light vertical lines.

(4) Contamination of Charging Member

After the completion of the image evaluation, the charging member in the cartridge was recovered, and the presence or absence of a smear derived from external additive adhesion was visually confirmed and evaluated according to criteria given below. The evaluation results are shown in Table 24.
A: No white smear was seen.
B: A white smear was slightly seen.
C: A conspicuous white smear was seen.

### Examples 107 to 157

Each process cartridge wan prepared and evaluated for the image and the contamination of a charging member in the same way as in Example 106 except that, in Example 106, the photosensitive member 104 and the toner 1 were changed to the photosensitive member and the toner shown in Table 24. The results are shown in Table 24.

### Comparative Examples 6 to 11

Each process cartridge was prepared and evaluated for the image and the contamination of a charging member in the same way as in Example 106 except that, in Example 106, the photosensitive member 104 and the toner 1 were changed to the photosensitive member and the toner shown in Table 25. The results are shown in Table 25.

TABLE 24

| | Photosensitive | | Image | Contamination of |
|---|---|---|---|---|
| | member | Toner | evaluation | charging member |
| Example 106 | Photosensitive | Toner 1 | A | A |
| | member 104 | | | |
| Example 107 | Photosensitive | Toner 1 | A | A |
| | member 105 | | | |
| Example 108 | Photosensitive | Toner 1 | A | A |
| | member 106 | | | |
| Example 109 | Photosensitive | Toner 1 | A | A |
| | member 107 | | | |
| Example 110 | Photosensitive | Toner 1 | A | A |
| | member 108 | | | |
| Example 111 | Photosensitive | Toner 1 | A | A |
| | member 109 | | | |
| Example 112 | Photosensitive | Toner 1 | A | B |
| | member 110 | | | |
| Example 113 | Photosensitive | Toner 1 | A | B |
| | member 111 | | | |
| Example 114 | Photosensitive | Toner 1 | A | B |
| | member 112 | | | |
| Example 115 | Photosensitive | Toner 1 | A | A |
| | member 113 | | | |
| Example 116 | Photosensitive | Toner 1 | A | A |
| | member 114 | | | |
| Example 117 | Photosensitive | Toner 1 | A | B |
| | member 115 | | | |
| Example 118 | Photosensitive | Toner 1 | A | B |
| | member 116 | | | |
| Example 119 | Photosensitive | Toner 1 | A | B |
| | member 117 | | | |
| Example 120 | Photosensitive | Toner 1 | B | B |
| | member 118 | | | |
| Example 121 | Photosensitive | Toner 1 | B | B |
| | member 119 | | | |
| Example 122 | Photosensitive | Toner 1 | B | B |
| | member 120 | | | |
| Example 123 | Photosensitive | Toner 1 | A | A |
| | member 121 | | | |
| Example 124 | Photosensitive | Toner 1 | A | A |
| | member 122 | | | |
| Example 125 | Photosensitive | Toner 1 | A | A |
| | member 123 | | | |
| Example 126 | Photosensitive | Toner 1 | A | A |
| | member 124 | | | |
| Example 127 | Photosensitive | Toner 1 | A | A |
| | member 125 | | | |
| Example 128 | Photosensitive | Toner 1 | A | A |
| | member 126 | | | |
| Example 129 | Photosensitive | Toner 2 | A | A |
| | member 104 | | | |
| Example 130 | Photosensitive | Toner 2 | A | A |
| | member 105 | | | |
| Example 131 | Photosensitive | Toner 2 | A | A |
| | member 106 | | | |
| Example 132 | Photosensitive | Toner 3 | A | B |
| | member 108 | | | |
| Example 133 | Photosensitive | Toner 3 | A | B |
| | member 108 | | | |
| Example 134 | Photosensitive | Toner 3 | B | B |
| | member 110 | | | |
| Example 135 | Photosensitive | Toner 4 | A | A |
| | member 107 | | | |
| Example 136 | Photosensitive | Toner 5 | A | A |
| | member 108 | | | |
| Example 137 | Photosensitive | Toner 6 | A | B |
| | member 115 | | | |
| Example 138 | Photosensitive | Toner 6 | A | A |
| | member 106 | | | |
| Example 139 | Photosensitive | Toner 6 | A | A |
| | member 104 | | | |
| Example 140 | Photosensitive | Toner 6 | A | A |
| | member 113 | | | |
| Example 141 | Photosensitive | Toner 6 | A | B |
| | member 117 | | | |
| Example 142 | Photosensitive | Toner 4 | A | A |
| | member 106 | | | |
| Example 143 | Photosensitive | Toner 5 | A | A |
| | member 108 | | | |
| Example 144 | Photosensitive | Toner 6 | A | A |
| | member 121 | | | |
| Example 145 | Photosensitive | Toner 6 | A | A |
| | member 122 | | | |
| Example 146 | Photosensitive | Toner 5 | A | A |
| | member 123 | | | |
| Example 147 | Photosensitive | Toner 6 | A | A |
| | member 124 | | | |
| Example 148 | Photosensitive | Toner 6 | A | A |
| | member 125 | | | |
| Example 149 | Photosensitive | Toner 7 | A | A |
| | member 126 | | | |
| Example 150 | Photosensitive | Toner 7 | B | B |
| | member 118 | | | |
| Example 151 | Photosensitive | Toner 4 | B | B |
| | member 119 | | | |
| Example 152 | Photosensitive | Toner 7 | B | B |
| | member 120 | | | |
| Example 153 | Photosensitive | Toner 7 | A | A |
| | member 106 | | | |
| Example 154 | Photosensitive | Toner 7 | A | A |
| | member 107 | | | |
| Example 155 | Photosensitive | Toner 1 | A | A |
| | member 127 | | | |
| Example 156 | Photosensitive | Toner 1 | A | A |
| | member 128 | | | |
| Example 157 | Photosensitive | Toner 1 | A | A |
| | member 129 | | | |

TABLE 25

| | | | | Contamination |
|---|---|---|---|---|
| | Photosensitive | | Image | of charging |
| | member | Toner | evaluation | member |
| Comparative | Comparative | Comparative | C | C |
| Example 6 | photosensitive | toner 1 | | |
| | member 2 | | | |
| Comparative | Comparative | Toner 3 | B | C |
| Example 7 | photosensitive | | | |
| | member 2 | | | |
| Comparative | Comparative | Toner 6 | B | C |
| Example 8 | photosensitive | | | |
| | member 2 | | | |
| Comparative | Photosensitive | Comparative | B | C |
| Example 9 | member 122 | toner 1 | | |
| Comparative | Photosensitive | Comparative | B | C |
| Example 10 | member 118 | toner 1 | | |
| Comparative | Photosensitive | Comparative | B | C |
| Example 11 | member 123 | toner 1 | | |

When Examples are compared with Comparative Examples, the effect of suppressing the contamination of a charging member was insufficiently obtained in Comparative Examples. Thus, reduction in image quality derived from the contamination of a charging member was found. In addition, each electrophotographic photosensitive member after the evaluation was taken out of the cartridge, and the part contacted with the cleaning blade and its neighborhood were observed. As a result, a uniform line of a stagnant layer in a longitudinal direction of the photosensitive member was formed on the photosensitive member used in each Example, whereas a line of a stagnant layer on the photosensitive member used in each Comparative Example was broken (non-uniform).

These results of the evaluation demonstrated that the image forming method, the process cartridge and the electrophotographic apparatus of the present invention can form a uniform stagnant layer. These results further demonstrated that the image forming method, the process cartridge and the electrophotographic apparatus of the present invention are superior because favorable cleaning properties can be exerted, and reduction in image quality caused by the contamination of a charging member can be suppressed.

While the present invention has been described with reference to exemplary embodiments, it is to be understood that the invention In not limited to the disclosed exemplary embodiments. The scope of the following claims is to be accorded the broadest interpretation so as to encompass all such modifications and equivalent structures and functions.

This application claims the benefit of Japanese Patent Application No. 2015-168367, filed Aug. 27, 2015, 2015-168263, filed Aug. 27, 2015, and 2016-155061, filed Aug. 5, 2016, which are hereby incorporated by reference herein in their entirety.

1. An image forming method comprising: charging an electrophotographic photosensitive member by contact with the electrophotographic photosensitive member; developing the electrophotographic photosensitive member with toner to form a toner image; transferring the toner image on the electrophotographic photosensitive member to a transfer medium; and cleaning off the toner on the electrophotographic photosensitive member by contact of a blade with the electrophotographic photosensitive member, wherein
a surface layer of the electrophotographic photosensitive member satisfies the following condition (i) or (ii):
(i) containing a fluorine resin particle and at least one resin selected from the group consisting of a polyarylate resin and a polycarbonate resin, and
(ii) containing at least one resin selected from the group consisting of polyarylate resin A and polycarbonate resin B each having a polysiloxane structure represented by the formula (1): 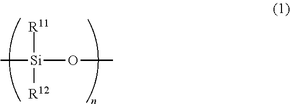
wherein R¹¹ and R¹² are each independently selected from the group consisting of an alkyl group, a fluoroalkyl group and a phenyl group, and n represents an integer of 10 or larger and 200 or smaller, and
the toner has a toner particle containing, on the surface, resin C having an isosorbide unit, represented by the formula (14):

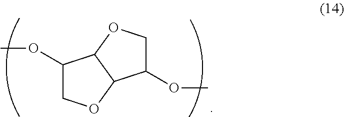

2. The image forming method according to claim 1, wherein
an abundance ratio of a silicon element to constituent elements in the outermost surface of the surface layer obtained using electron spectroscopy for chemical analysis (ESCA) is 3.0 atom % or more, and
the resin C contains 0.10 mol % or more of the isosorbide unit represented by the formula (14) as a constituent.

3. The image forming method according to claim 1, wherein
a content of the structure represented by the formula (1) in each of the polyarylate resin A and the polycarbonate resin B is 5.0 mass % or more and 60 mass % or less, and
the resin C contains 0.10 mol % or more of the isosorbide unit represented by the formula (14) as a constituent.

4. The image forming method according to claim 1, wherein the polyarylate resin A and the polycarbonate resin B each have a polysiloxane structure represented by the following formula (15): 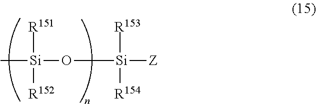
wherein R¹⁵¹ to R¹⁵⁴ are each independently selected from the group consisting of an alkyl group, a fluoroalkyl group and a phenyl group, Z is selected from the group consisting of a hydrogen atom, a halogen atom, a substituted or unsubstituted alkyl group and a substituted or unsubstituted aryl group, and n represents an integer of 10 or larger and 200 or smaller.

5. The image forming method according to claim 1, wherein at least a portion of the ends of the polyarylate resin A and the polycarbonate resin B has a polysiloxane structure represented by the following formula (2): 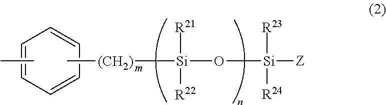
wherein R²¹ to R²⁴ are each independently selected from the group consisting of an alkyl group, a fluoroalkyl group and a phenyl group, Z is selected from the group consisting of an alkyl group having 1 to 4 carbon atoms and a phenyl group, n represents an integer of 10 or larger and 200 or smaller, and m represents an integer of 1 or larger and 3 or smaller.

6. The image forming method according to claim 1, wherein the polyarylate resin A has at least one of structural units represented by the following formulas (3) to (5): 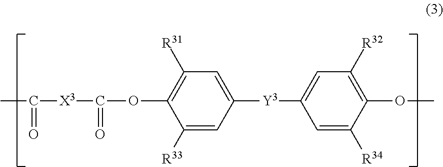
wherein R³¹ to R³⁴ are each independently selected from the group consisting of a hydrogen atom, an alkyl group, a fluoroalkyl group and a substituent represented by the following formula (3-A), at least one of R³¹ to R³⁴ is a substituent represented by the formula (3-A), X³ is selected from the group consisting of a m-phenylene group, a p-phenylene group and a divalent group in which two p-phenylene groups are bonded via an oxygen atom, and Y³ is selected from the group consisting of a single bond, a methylene group, an ethylidene group, a propylidene group and a phenylethylidene group: 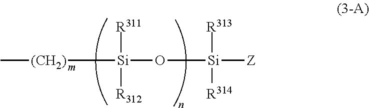
wherein R³¹¹ to R³¹⁴ are each independently selected from the groups consisting of an alkyl group, a fluoroalkyl group and a phenyl group, Z is selected from the group consisting of an alkyl group having 1 to 4 carbon atoms and a phenyl group, n represents the number of repeats of the structure in parentheses, the average value of n is 10 or larger and 200 or smaller, m represents the number of repeats of the structure in parentheses, and the average value of m is 0 or larger and 5 or smaller; 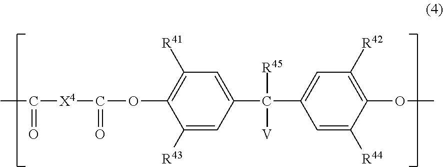
wherein R⁴¹ to R⁴⁴ are each independently selected from the group consisting of a hydrogen atom, an alkyl group and a fluoroalkyl group, R⁴⁵ is selected from the group consisting of a hydrogen atom, an alkyl group, a fluoroalkyl group and a phenyl group, X⁴ is selected from the group consisting of a m-phenylene group, a p-phenylene group and a divalent group in which two p-phenylene groups are bonded via an oxygen atom, and V represents at least one of structures represented, by the following formulas (4-A) and (4-B): 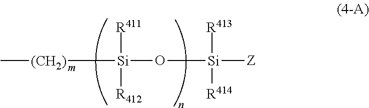
wherein R⁴¹¹ to R⁴¹⁴ are each independently selected from the group consisting of an alkyl group, a fluoroalkyl group and a phenyl group, Z is selected from the group consisting of an alkyl group having 1 to 4 carbon atoms and a phenyl group, n represents the number of repeats of the structure in parentheses, the average value of n is 10 or larger and 200 or smaller, m represents the number of repeats of the structure in parentheses, and the average value of m is 3 or larger and 20 or smaller, and 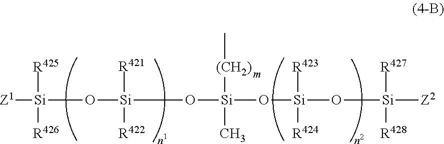
wherein R⁴²¹ to R⁴²⁸ are each independently selected from the group consisting of an alkyl group, a fluoroalkyl group and a phenyl group, Z¹ and Z² are each independently selected from the group consisting of an alkyl group having 1 to 4 carbon atoms and a phenyl group, n¹ and n² each represent the number of repeats of the structure in parentheses, the average value of n¹ and the average value of n² are each independently 10 or larger and 200 or smaller, the total value of the average value of n¹ and the average value of n² is 20 or larger and 250 or smaller, m represents the number of repeats of the structure in parentheses, and the average value of m is 3 or larger and 20 or smaller; and 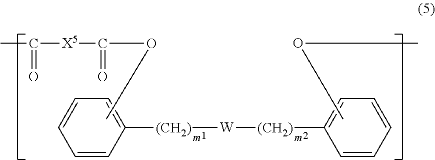
wherein X⁵ is selected from the group consisting of a m-phenylene group, a p-phenylene group and a divalent group in which two p-phenylene groups are bonded via an oxygen atom, m¹ and m² each represent the number of repeats of the structure in parentheses, the average value of m¹ and the average value of m² are each independently 1 or larger and 3 or smaller, and W represents a structure represented by the following formula (5-A): 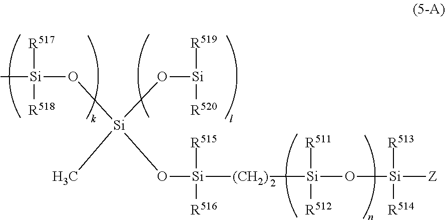
wherein R⁵¹¹ to R⁵²⁰ are each independently selected from the group consisting of an alkyl group, a fluoroalkyl group and a phenyl group, Z is selected from the group consisting of an alkyl group having 1 to 4 carbon atoms and a phenyl group, n represents the number of repeats of the structure in parentheses, the average value of n is 10 or larger and 200 or smaller, k and l each represent the number of repeats of the structure in parentheses, and the average value of k and the average value of l are each independently 1 or larger and 10 or smaller.

7. The image forming method according to claim 6, wherein the polyarylate resin A has the structural unit represented by the formula (5).

8. The image forming method according to claim 1, wherein the polycarbonate resin B has at least, one of structural units represented by the following formulas (6) to (8): 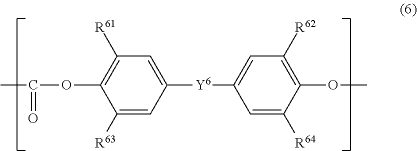
wherein R⁶¹ to R⁶⁴ are each independently selected from the group consisting of a hydrogen atom, an alkyl group, a fluoroalkyl group, a phenyl group and a substituent represented by the following formula (6-A), at least one of R⁶¹ to R⁶⁴ is a substituent represented by the formula (6-A), and Y⁶ is selected from the group consisting of a single bond, a methylene group, an ethylidene group, a propylidene group, a phenylethylidene group, a cyclohexylidene group and an oxygen atom: 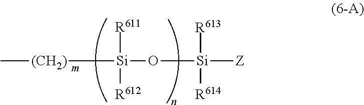
wherein R⁶¹¹ to R⁶¹⁴ are each independently selected from the group consisting of an alkyl group, a fluoroalkyl group and a phenyl group, Z is selected from the group consisting of an alkyl group having 1 to 4 carbon atoms and a phenyl group, n represents the number of repeats of the structure in parentheses, the average value of n is 10 or larger and 200 or smaller, m represents the number of repeats of the structure in parentheses, and the average value of m is 0 or larger and 5 or smaller; 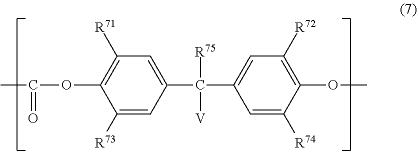
wherein R⁷¹ to R⁷⁴ are each independently selected from the group consisting of a hydrogen atom, an alkyl group, a fluoroalkyl group and a phenyl group, R⁷⁵ is selected from the group consisting of a hydrogen atom, an alkyl group, a fluoroalkyl group and a phenyl group, and V represents at least one of structures represented by the following formulas (7-A) and (7-B): 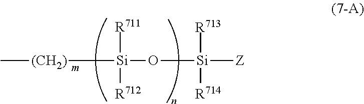
wherein R⁷¹¹ to R⁷¹⁴ are each independently selected from the group consisting of an alkyl group, a fluoroalkyl group and a phenyl group, z is selected from the group consisting of an alkyl group having 1 to 4 carbon atoms and a phenyl, group, n represents the number of repeats of the structure in parentheses, the average value of n is 10 or larger and 200 or smaller, m represents the number of repeats of the structure in parentheses, and the average value of m is 3 or larger and 20 or smaller, and 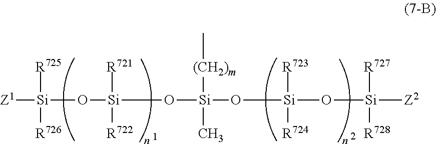
wherein R⁷²¹ to R⁷²⁸ are each independently selected from the group consisting of an alkyl group, a fluoroalkyl group and a phenyl group, Z¹ and Z² are each independently selected from the group consisting of an alkyl group having 1 to 4 carbon, atoms and a phenyl group, n¹ and n² each represent the number of repeats of the structure in parentheses, the average value of n¹ and the average value of n² are each independently 10 or larger and 200 or smaller, the total value of the average value of n¹ and the average value of n² is 20 or larger and 250 or smaller, m represents the number of repeats of the structure in parentheses, and the average value of m is 3 or larger and 20 or smaller; and 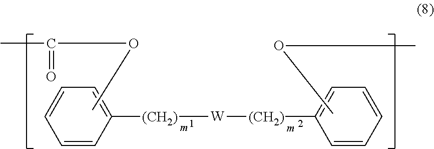
wherein m¹ and m² each represent the number of repeats of the structure in parentheses, the average value of m¹ and the average value of m² are each independently 1 or larger and 3 or smaller, and W represents a structure represented by the following formula (8-A): 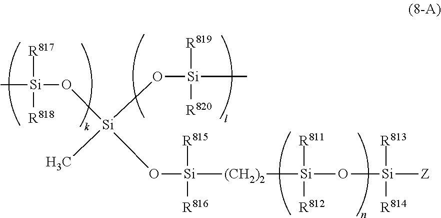
wherein R⁸¹¹ to R⁸²⁰ are each independently selected from the group consisting of an alkyl group, a fluoroalkyl group and a phenyl group, Z is selected from the group consisting of an alkyl group having 1 to 4 carbon atoms and a phenyl group, n represents the number of repeats of the structure in parentheses, the average value of n is 10 or larger and 200 or smaller, k and l each represent the number of repeats of the structure in parentheses, and the average value of k and the average value of l are each independently 1 or larger and 10 or smaller.

9. The image forming method according to claim 8, wherein the polycarbonate resin B has the structural unit represented by the formula (8).

10. The image forming method according to claim 1, wherein the surface layer contains polydimethylsiloxane represented by the following formula (16); 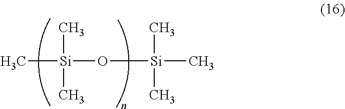
wherein n represents an integer of 10 or larger and 200 or smaller.

11. The image forming method according to claim 10, wherein
a content of the polydimethylsiloxane represented by the formula (16) contained in the surface layer is 3.0 mass % or more and 20.0 mass % or less with respect to the polyarylate resin A and the polycarbonate resin B contained in the surface layer, and
the resin C contains 0.10 mol % or more of the isosorbide unit represented by the formula (14) as a constituent.

12. The image forming method according to claim 1, wherein the fluorine resin particle is present at a volume-average particle size of 0.2 μm to 1.0 μm in the surface layer.

13. The image forming method according to claim 1, wherein the surface layer contains a polymer having a repeating structural unit represented by the following formula (18) and a repeating structural unit represented by the following formula (19), or diorganopolysiloxane represented by the following formula (20): 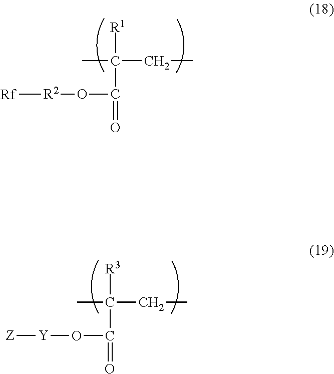
wherein in the formula (18), R¹ is selected from the group consisting of hydrogen and a methyl group, R² is selected from the group consisting of a single bond and a divalent group, and Rf represents a monovalent group having at least one of a fluoroalkyl group and a fluoroalkylene group; and in the formula (19), R³ is selected from the group consisting of hydrogen and a methyl group, Y represents a divalent organic group, and Z represents a polymer unit; and 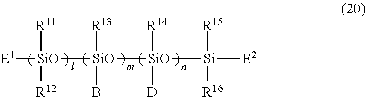
wherein R¹¹ to R¹⁶ each represent a substituted or unsubstituted hydrocarbon group, B represents a substituted or unsubstituted organic group having a perfluoroalkyl group, D represents an end-capped group having a degree of polymerization of 3 or larger and having a substituted or unsubstituted polystyrene chain, E¹ and E² each represent a group selected front the group consisting of R¹¹ to R¹⁶, B and D, l represents an integer of 0 to 1000, and m and n each represent an integer of 1 to 1000.

14. The image forming method according to claim 1, wherein a content of the fluorine resin particle in the surface layer is 3.0 mass % to 10.0 mass %, and the surface layer contains a polymer having a repeating structural unit represented by the formula (18) and a repeating structural unit represented by the formula (19) or a diorganopolysiloxane represented by the formula (20) in the range of 2.0 mass % to 10.0 mass % with respect to the mass of the fluorine resin particle.

15. The image forming method according to claim 1, wherein
the toner contains a polyester resin, wherein the polyester resin contains 0.10 mol % or more and 30.00 mol % or less of the isosorbide unit represented by the formula (14), and
a content of the fluorine resin particle in the surface layer of the electrophotographic photosensitive member is 3.0 mass % to 10.0 mass %, and the surface layer contains a polymer having a repeating structural unit represented by the formula (18) and a repeating structural unit represented by the formula (19) or a diorganopolysiloxane represented by the formula (20) in the range of 2.0 mass % to 10.0 mass % with respect to the mass of the fluorine resin particle.

16. The image forming method according to claim 1, wherein the toner has a toner particle containing a resin, wherein
the resin contains the resin C and a styrene acrylic resin, wherein
a content of the styrene acrylic resin is 50.0 mass % or more and 99.0 mass % or less with respect to all resins having a number-average molecular weight of 1500 or larger in the toner,
the resin C contains 0.10 mol % or more and 30.00 mol % or less of the isosorbide unit represented by the formula (14) as a constituent, and
a content of the resin C is 1.0 mass % or more and 35.0 mass % or less with respect to all resins having a number-average molecular weight of 1500 or larger in the toner.

17. A process cartridge which is detachably attached to the main body of an electrophotographic apparatus,
the process cartridge having: an electrophotographic photosensitive member; a charging unit for charging the electrophotographic photosensitive member by contact with the electrophotographic photosensitive member; a developing unit for developing the electrophotographic photosensitive member with toner to form a toner image; and a cleaning unit for cleaning off the toner on the electrophotographic photosensitive member by contact of a blade with the electrophotographic photosensitive member, wherein
a surface layer of the electrophotographic photosensitive member satisfies the following condition (i) or (ii);
(i) containing a fluorine resin particle and at least one resin selected from the group consisting of a polyarylate resin and a polycarbonate resin, and
(ii) containing at least one resin selected from the group consisting of polyarylate resin A and polycarbonate resin B each having a polysiloxane structure represented by the formula (1): 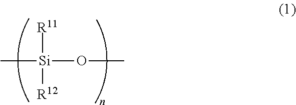
wherein R¹¹ and R¹² are each independently selected from the group consisting of an alkyl group, a fluoroalkyl group and a phenyl group, and n represents an integer of 10 or larger and 200 or smaller, and
the toner has a toner particle containing, on the surface, resin C having an isosorbide unit represented by the formula (14):

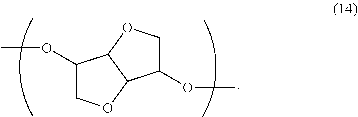

18. An electrophotographic apparatus having: an electrophotographic photosensitive member; a charging unit for charging the electrophotographic photosensitive member by contact with the electrophotographic photosensitive member; a developing unit for developing the electrophotographic photosensitive member with toner to form a toner image; a transfer unit for transferring the toner image on the electrophotographic photosensitive member to a transfer medium; and a cleaning unit for cleaning off the toner on the electrophotographic photosensitive member by contact of a blade with the electrophotographic photosensitive member, wherein
a surface layer of the electrophotographic photosensitive member satisfies the following condition (i) or (ii):
(i) containing a fluorine resin particle and at least one resin selected from the group consisting of a polyarylate resin and a polycarbonate resin, and
(ii) containing at least one resin selected from the group consisting of polyarylate resin A and polycarbonate resin B each having a polysiloxane structure represented by the formula (1): 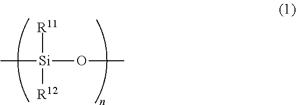
wherein R¹¹ and R¹² are each independently selected from the group consisting of an alkyl group, a fluoroalkyl group and a phenyl group, and n represents an integer of 10 or larger and 200 or smaller, and
the toner has a toner particle containing, on the surface, resin C having an isosorbide unit represented by the formula (14): [chemical structure]
